(19) United States
(12) Patent Application Publication
(10) Pub. No.: US 2014/0134316 A1
(43) Pub. Date: May 15, 2014

(54) DESSERT COMPOSITIONS COMPRISING SOY WHEY PROTEINS THAT HAVE BEEN ISOLATED FROM PROCESSING STREAMS

(71) Applicants: Michael A. Jincks, Pevely, MO (US); William C. Smith, Cahokia, IL (US); John A. Brown, Festus, MO (US)

(72) Inventors: Michael A. Jincks, Pevely, MO (US); William C. Smith, Cahokia, IL (US); John A. Brown, Festus, MO (US)

(73) Assignee: SOLAE LLC, St. Louis, MO (US)

(21) Appl. No.: 14/128,009

(22) PCT Filed: Jun. 29, 2011
(86) PCT No.: PCT/US11/42425

§ 371 Date: Dec. 20, 2013

(51) Int. Cl. A23J 1/14; A23L 1/305

(52) U.S. Cl. CPC A23J 1/14; A23L 1/3055
USPC 426/573; 426/656

(57) ABSTRACT

A dessert composition comprising soy whey proteins that have been isolated from processing streams, wherein the dessert composition is used to form a dessert food product. A process for recovering and isolating soy whey proteins and other components from soy processing streams is also disclosed.

### FIELD OF THE INVENTION

The present disclosure provides compositions which comprise soy whey proteins recovered or isolated in accordance with the processes disclosed herein to form a dessert product. Specifically, the present disclosure provides a composition comprising soy whey proteins that have been recovered from soy processing streams, along with other ingredients to form a dessert food product. Specifically, the present soy recovery process utilizes one or more membrane or chromatographic separation operations for isolating and removing soy proteins, including novel soy whey proteins and purified target proteins, as well as sugars, minerals, and other constituents to form a purified waste water stream. Methods for making the dessert products are also disclosed.

### BACKGROUND OF THE INVENTION

Food scientists in the industry continually work to develop novel processes and the resulting products that deliver improved nutritional characteristics that consumers desire. The inclusion of soy protein is a cost-effective way to reduce fat, increase protein content and improve overall sensory characteristics of desserts, such as puddings, whipped toppings, gelatins, and frozen confections such as ice cream, water ice, sherbet, and the like.

Dairy-based desserts are typically made with whole milk, butterfat, and/or heavy cream, and sugar, while non-dairy based desserts can contain high levels of sugar and calories at the expense of being nutritionally sound, for example, not containing any fiber or protein. While many may enjoy desserts, these treats tend to be avoided for a variety of reasons. First, desserts have not historically been nutritious products due to the high levels of fat and calories they typically contain. Second, a large portion of the population is not able to consume dairy-based frozen confections since they cannot metabolize lactose, a sugar found in dairy products. Third, some people choose not to eat dairy-based frozen confections due to religious or personal beliefs surrounding the consumption of dairy products. In light of all these factors, there is a need for low-dairy or non-dairy dessert products that are also nutritious. Soy protein is also a cost-effective way to enhance the nutritional profile of desserts.

Soy proteins are typically in one of three forms when consumed by humans. These include soy protein flour (grits), soy protein concentrates, and soy protein isolates. All three types are made from defatted soybean flakes. Flours and grits contain at least 50% protein and are prepared by milling the flakes.

Soy protein concentrates contain 65 wt. % to 90 wt. % protein on a dry weight basis, with the major non-protein component being fiber. Soy protein concentrates are made by repeatedly washing the soy flakes with water, which may optionally contain low levels of food grade alcohols or buffers. The effluent from the repeated washings is discarded and the solid residue is dried, thereby producing the desired concentrate. The yield of concentrates from the starting material is approximately 60-70%.

The preparation of soy protein concentrate generally results in two streams: soy isolate and a soy molasses stream, which may contain up to 55 wt. % soy protein. On a commercial scale, significant volumes of this molasses are generated that must be discarded. The total protein content may contain up to 15 wt. % of the total protein content of the soybeans from which they are derived. Thus, a significant fraction of soy protein is discarded during processes typically used for soy protein concentrate preparation.

Soy protein isolates are the most highly refined soy protein products commercially available, as well as the most expensive to obtain. However, as with soy protein concentrates, current processing known in the industry results in many of the valuable minerals, vitamins, isoflavones, and phytoestrogens being drawn off to form a waste stream along with the low-molecular weight sugars in making the isolates.

Soy protein isolates contain a minimum of 90 wt. % protein on a dry weight basis and little or no soluble carbohydrates or fiber. Isolates are typically made by extracting defatted soy flakes or soy flour with a dilute alkali (pH<9) and centrifuging. The extract is adjusted to pH 4.5 with a food grade acid such as sulfuric, hydrochloric, phosphoric or acetic acid. At a pH of 4.5, the solubility of the proteins is at a minimum so they will precipitate out. The protein precipitate is then dried after being adjusted to a neutral pH or is dried without any pH adjustment to produce the soy protein isolate. The yield of the isolate is 30% to 50% of the original soy flour and 60% of the protein in the flour. This extremely low yield along with the many required processing steps contributes to the high costs involved in producing soy protein isolates.

Due at least in part to their relatively high protein content, soy protein isolates are desired for a variety of applications. In conventional soy protein isolate manufacture, the aqueous stream (i.e., soy whey stream) remaining after precipitation of the soy protein isolate fraction is typically discarded. On a commercial scale, considerable costs are incurred with the handling and disposing of this aqueous waste stream. For example, the soy whey stream is relatively dilute (e.g., less than about 5 wt. % solids, typically about 2 wt. % solids). Thus, on a commercial scale, significant volumes of the soy whey stream are generated that must be treated and/or discarded. In addition, it has been observed that the soy whey stream may contain a substantial proportion of the total protein content of the soybeans used in preparation of soy protein isolates. In fact, the soy whey stream may contain up to 45 wt. % of the total protein content of the soybeans from which soy protein isolates are derived. Thus, a significant fraction of soy protein is typically discarded during conventional soy protein isolate production.

Despite the high proportion of the soy whey protein that is typically lost in the processing stream, recovery of the proteins has not generally been considered to be economically feasible. At least in part, the loss of these potentially valuable proteins has been heretofore deemed acceptable because of the relatively low concentrations of total protein in the whey, and the consequently large volumes of aqueous waste that must be processed for each unit of mass of protein recovered, which generates a large amount of pollution. Recovery attempts have also been deterred by the complex mixture of proteins and other components present in the soy whey, and the absence of commercial applications for crude mixtures of the protein solids. While soy whey has been known to contain certain bioactive proteins, the commercial value of these has been limited for lack of processes to recover them in high purity form.

Methods for recovering products from soy whey are known in the art. For example, a process for separating specific isoflavone fractions from soy whey and soy molasses feed streams is described in U.S. Pat. Nos. 6,033,714; 5,792,503; and 5,702,752. In another method, soy molasses (also referred to as soy solubles) is obtained when vacuum distillation removes the ethanol from an aqueous ethanol extract of defatted soy meal. The feed stream is heated to a temperature chosen according to the specific solubility of the desired isoflavone fraction. The stream is then passed through an ultrafiltration membrane, which allows isoflavone molecules below a maximum molecular weight to permeate. The permeate may then be concentrated using a reverse osmosis membrane. The concentrated stream is then put through a resin adsorption process using at least one liquid chromatography column to further separate the fractions.

Methods for the removal of oligosaccharides from soybean wastes are also known in the art. For example, Matsubara et al [Biosci. Biotech. Biochem. 60:421 (1996)] describe a method for recovering soybean oligosaccharides from steamed soybean wastewater using reverse osmosis and nanofiltration membranes. JP 07-082,287 teaches the recovery of oligosaccharides from soybean oligosaccharide syrup using solvent extraction. That method comprises adding an organic solvent to the aqueous solution containing the oligosaccharides, heating the mixture to give a homogeneous solution, cooling the solution to form two liquid layers, and separating and recovering the bottom layer.

Canadian Patent Applications 2,006,957 and 2,013,190 describe ion-exchange processes carried out in aqueous ethanol to recover small quantities of high value by-products from cereal grain processing waste. According to CA 2,013,190, an alcoholic extract from a cereal grain is processed through either an anionic and/or cationic ion-exchange column to obtain minor but economically valuable products.

Soy whey and soy molasses also contain a significant amount of protease inhibitors. Protease inhibitors are known to at least inhibit trypsin, chymotrypsin and potentially a variety of other key transmembrane proteases that regulate a range of key metabolic functions. Topical administration of protease inhibitors finds use in such conditions as atopic dermatitis, a common form of inflammation of the skin, which may be localized to a few patches or involve large portions of the body. The depigmenting activity of protease inhibitors and their capability to prevent ultraviolet-induced pigmentation have been demonstrated both in vitro and in vivo (See e.g., Paine et al., J. Invest. Dermatol., 116: 587-595 [2001]). Protease inhibitors have also been reported to facilitate wound healing. For example, secretory leukocyte protease inhibitor was demonstrated to reverse the tissue destruction and speed the wound healing process when topically applied. In addition, serine protease inhibitors can also help to reduce pain in lupus erythematosus patients (See e.g., U.S. Pat. No. 6,537,968). Naturally occurring protease inhibitors can be found in a variety of foods such as cereal grains (oats, barley, and maize), Brussels sprouts, onion, beetroot, wheat, finger millet, and peanuts. One source of interest is the soybean.

Two broad classes of protease inhibitor superfamilies have been identified from soybean and other legumes with each class having several isoinhibitors. Kunitz-trypsin inhibitor (KTI) is major member of the first class whose members have approximately 170-200 amino acids, molecular weights between 20-25 kDa, and act principally against trypsin. Kunitz-trypsin proteinase inhibitors are mostly single chain polypeptides with 4 cysteines linked in two disulfide bridges, and with one reactive site located in a loop defined by disulfide bridge. The second class of inhibitors contains 60-85 amino acids, has a range in molecular weight of 6-10 kDa, has a higher number of disulfide bonds, is relatively heat-stable, and inhibits both trypsin and chymotrypsin at independent binding sites. Bowman-Birk inhibitor (BBI) is an example of this class. The average level of protease inhibitors present in soybeans is around 1.4 percent and 0.6 percent for KTI and BBI, respectively. Notably, these low levels make it impractical to isolate the natural protease inhibitor for clinical applications.

Preparing pure BBI, however, involves costly techniques. Moreover, because the average level of BBI present in soybeans is only around 0.6 wt. %, this low level makes it impractical and cost prohibitive to isolate the natural protease inhibitor for clinical applications. Purification methods currently used in the art vary. Some methods use affinity purification with immobilized trypsin or chymotrypsin. Immobilized trypsin will bind both BBI and Kunitz trypsin inhibitor (KTI) so a particularly pure BBI product is not isolated. Alternatively, a process involving use of immobilized chymotrypsin, while it does not bind KTI, has several problems, such as not being cost effective for scale-up and the possibility of chymotrypsin leaching from the resin following numerous uses and cleaning steps. Many older BBI purification methods use anion exchange chromatography, which technique can result in subfractionation of BBI isomers, In addition, it has been difficult with anion exchange chromatography to obtain a KTI-free BBI fraction without significant loss of BBI yield. Accordingly, all of the methods currently known for isolating BBI are problematic due to slow processing, low yield, low purity, and/or the need for a number of different steps which results in an increase of time and cost requirements.

Methods of purification which only utilize filtration are not effective as sole methods due to membrane fouling, incomplete and/or imperfect separation of non-protein components from BBI proteins, and ineffective separation of BBI proteins from other proteins. Methods of purification which only utilize chromatography are also not effective as sole methods due to binding capacity and overloading issues, incomplete and/or imperfect separation issues (e.g. separation of BBI from KTI), irreversible binding of protein to resin issues, resin lifetime issues, and it is relatively expensive compared to other techniques. Methods of purification which involve only ammonium sulfate precipitation are not effective as sole methods due to the possibility of irreversible precipitation of BBI proteins, potential loss of activity of BBI proteins, incomplete precipitation of BBI proteins (i.e. loss of yield), and the need to remove the ammonium sulfate from the final product, which adds an additional step and cost.

Current methods known in the art for obtaining purified BBI proteins suffer from lower purity levels due to the contamination of the BBI with Kunitz Trypsin Inhibitor (KTI) proteins. Depending on the isolation method used, endotoxin levels can also be an issue. Current methods use whole soybean as the starting material, which is then defatted by various means. In contrast, the processes of the present invention use defatted soy white flake as the starting material. As a result, the prior art has not described a BBI product having high purity levels that is obtained from a soy protein source, without acid or alcohol extraction, or acetone precipitation. Thus, there is a need for methods and compositions suitable for the production of high purity BBI and variants.

Thus, there is a need in the art for food products which incorporate as an ingredient the soy whey proteins recovered from soy processing streams pursuant to the methods disclosed herein. Accordingly, the present invention describes compositions which comprise soy whey proteins that have been recovered in accordance with the methods described herein. Along with the recovered soy whey proteins, the compositions may additionally comprise at least one other ingredient and are formed into a dessert product. The dessert products that contain recovered soy whey protein as an ingredient have been found to have an increased amount of protein and overall nutritional profile that a consumer desires, while retaining the same taste, structure, aroma and mouthfeel of typical dessert products currently on the market.

### SUMMARY OF THE INVENTION

The present disclosure relates to compositions which comprise soy whey proteins that have been recovered in accordance with the novel methods for purifying soy processing streams disclosed herein. The compositions disclosed herein are then used to form dessert products such as, for example, puddings, whipped toppings, gelatins, and frozen confections such as ice cream, water ice, sherbet, and the like. Specifically, the present disclosure provides dessert products that contain recovered soy whey protein, which products have been found to have an improved nutritional profile including increased amount of protein, while retaining the same structure, aroma and appearance of typical dessert products currently on the market and desired by consumers. The compositions which comprise the soy whey proteins of the present disclosure may be combined with at least one other ingredient to form the dessert product.

In one embodiment, the addition of soy whey protein resulted in darker color and increased amount of foam in the end application. In another embodiment, increased amounts of SWP decreased foaming capacity, while lower amounts increased foaming capacity. In yet another embodiment, increasing the amount of SWP caused the dessert to melt faster. In additional embodiment addition of SWP caused lower viscosity compared to in-kind MLA (Most likely Alternatives)

The dessert products of the present disclosure incorporate soy whey protein that has been recovered from processing streams in accordance with novel processing methods. To recover the soy whey protein, a sequence of membrane or chromatographic separation operations steps, which are described below in further detail, are combined in varying order to comprise the overall process for recovering soy whey protein and other constituents from a processing stream. The present processing method results in the isolation and removal of one or more soy whey proteins, sugars, and minerals from a soy processing stream, the soy processing stream comprising the soy whey proteins, one or more soy storage proteins, one or more sugars, and one or more minerals. The removal of the soy whey proteins from the processing streams in accordance with the novel processing methods allows the soy whey protein to be used in compositions to produce dessert products.

### BRIEF DESCRIPTION OF THE DRAWINGS

FIG. 1 is a chart setting forth the proteins found in whey streams and their characteristics.

FIG. 2 graphically depicts the solubility of the soy whey proteins over a pH range of 3-7 as compared to that of soy protein isolates.

FIG. 3 graphically depicts the rheological properties of the soy whey proteins compared to soy protein isolate.

FIG. 4A is a schematic flow sheet depicting Steps 0 through 4 in a process for recovery of a purified soy whey protein from processing stream.

FIG. 4B is a schematic flow sheet depicting Steps 5, 6, 14, 15, 16, and 17 in a process for recovery of a purified soy whey protein from processing stream.

FIG. 4C is a schematic flow sheet depicting Steps 7 through 13 in a process for recovery of a purified soy whey protein from processing stream.

FIG. 5 graphically illustrates the breakthrough curve when loading soy whey at 10, 15, 20 and 30 mL/min (5.7, 8.5, 11.3, 17.0 cm/min linear flow rate, respectively) through a SP Gibco cation exchange resin bed plotted against empty column volumes loaded.

FIG. 6 graphically illustrates protein adsorption on SP Gibco cation exchange resin when passing soy whey at 10, 15, 20 and 30 mL/min (5.7, 8.5, 11.3, 17.0 cm/min linear flow rate, respectively) plotted against empty column volumes loaded.

FIG. 7 graphically illustrates the breakthrough curve when loading soy whey at 15 mL/min and soy whey concentrated by a factor of 3 and 5 through SP Gibco cation exchange resin bed plotted against empty column volumes loaded.

FIG. 8 graphically illustrates protein adsorption on SP Gibco cation exchange resin when passing soy whey and soy whey concentrated by a factor of 3 and 5 at 15 mL/min through SP Gibco cation exchange resin bed plotted against empty column volumes loaded.

FIG. 9 graphically depicts equilibrium protein adsorption on SP Gibco cation exchange resin when passing soy whey and soy whey concentrated by a factor of 3 and 5 at 15 mL/min through SP Gibco cation exchange resin bed plotted against equilibrium protein concentration in the flow through.

FIG. 10 graphically illustrates the elution profiles of soy whey proteins desorbed with varying linear velocities over time.

FIG. 11 graphically illustrates the elution profiles of soy whey proteins desorbed with varying linear velocities with column volumes.

FIG. 12 depicts a sodium dodecyl sulfate polyacrylamide gel electrophoresis (SDS-PAGE) analysis of Mimo6ME fractions.

FIG. 13 depicts a SDS-PAGE analysis of Mimo4SE fractions.

FIG. 14 depicts a SDS-PAGE analysis of Mimo6HE fractions.

FIG. 15 depicts a SDS-PAGE analysis of Mimo6ZE fractions.

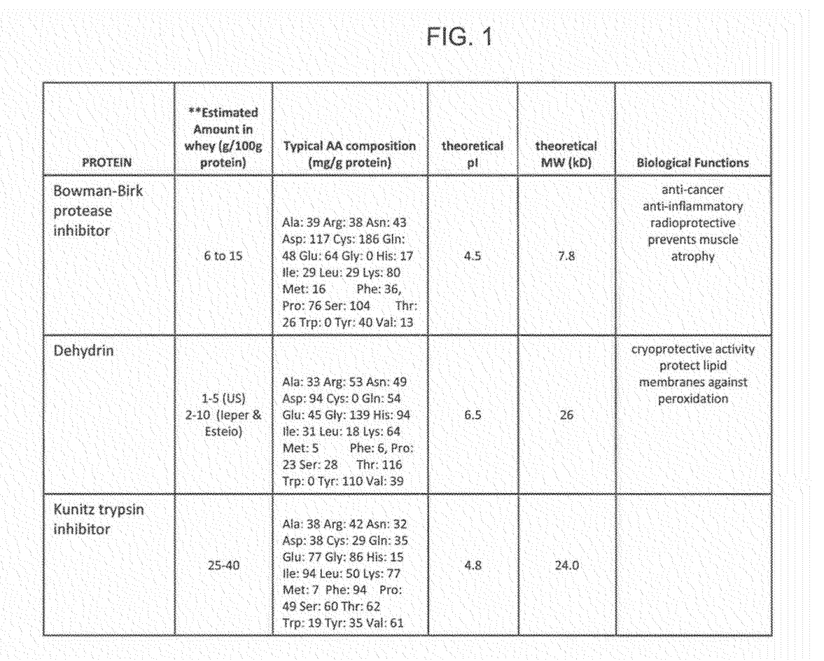

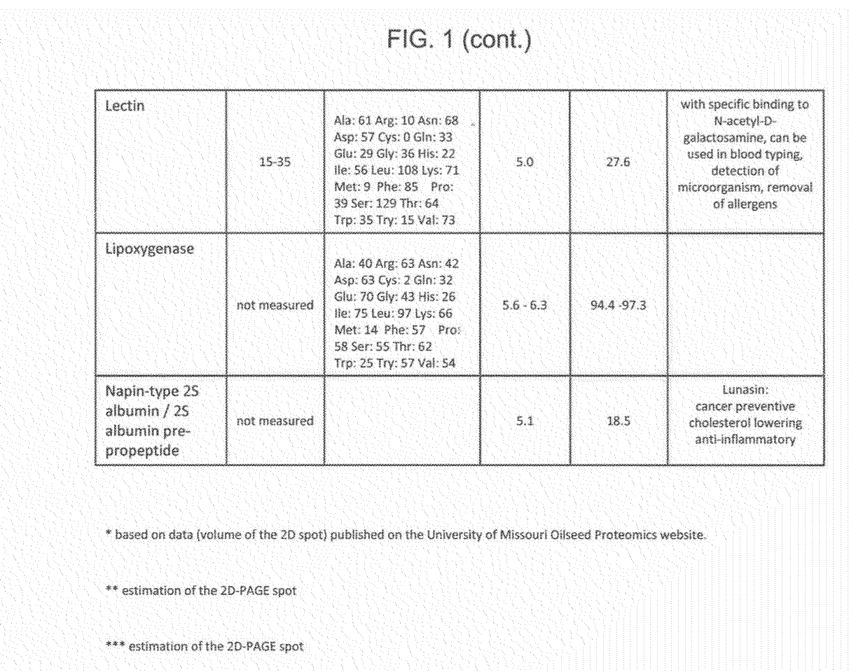

### DETAILED DESCRIPTION OF THE PREFERRED ASPECTS

The present invention provides compositions comprising soy whey proteins recovered from a variety of leguminous plant processing streams (including soy whey streams and soy molasses streams) generated in the manufacture of soy protein isolates. The recovered soy whey proteins are useful as an ingredient in compositions which are may then be used to form dessert products. The resultant dessert products have been shown to exhibit improved nutritional characteristics, including an increased amount of protein, while retaining the same taste, structure, aroma, and mouthfeel of typical dessert products currently on the market.

Generally, the purification of the soy processing stream comprises one or more operations (e.g. membrane separation operations) selected and designed to provide recovery of the desired proteins or other products, or separation of various components of the soy whey stream, or both. Recovery of soy whey proteins (e.g. Bowman-Birk inhibitor (BBI) and Kunitz trypsin inhibitor (KTI) proteins) and one or more other components of the soy whey stream (e.g. various sugars, including oligosaccharides) may utilize a plurality of separation techniques, (e.g. membrane, chromatographic, centrifugation, or filtration). The specific separation technique will depend upon the desired component to be recovered by separating it from other components of the processing stream.

For example, a purified fraction is typically prepared by removal of one or more impurities (e.g. microorganisms or minerals), followed by removal of additional impurities including one or more soy storage proteins (i.e. glycinin and β-conglycinin), followed by removal of one or more soy whey proteins (including, for example, KTI and other non-BBI proteins or peptides), and/or followed by removal of one or more additional impurities including sugars from the soy whey. Recovery of various target components in high purity form is improved by removal of other major components of the whey stream (e.g. storage proteins, minerals, and sugars) that detract from purity by diluents, while likewise improving purity by purifying the protein fraction through removal of components that are antagonists to the proteins and/or have deleterious effects (e.g. endotoxins). Removal of the various components of the soy whey typically comprises concentration of the soy whey prior to and/or during removal of the components of the soy whey. The methods of the present invention also will reduce pollution generated from processing large quantities of aqueous waste.

Removal of storage proteins, sugars, minerals, and impurities yields fractions that are enriched in the individual, targeted proteins and free of impurities that may be antagonists or toxins, or may otherwise have a deleterious effect. For example, typically a soy storage protein-enriched fraction may be recovered, along with a fraction enriched in one or more soy whey proteins. A fraction enriched in one more sugars (e.g. oligosaccharides and/or polysaccharides) is also typically prepared. Thus, the present methods provide a fraction that is suitable as a substrate for recovery of individual, targeted proteins, and also provide other fractions that can be used as substrates for economical recovery of other useful products from aqueous soy whey. For example, removal of sugars and/or minerals from the soy whey stream produces a useful fraction from which the sugars can be further separated, thus yielding additional useful fractions: a concentrated sugar and a mineral fraction (that may include citric acid), and a relatively pure aqueous fraction that may be disposed of with minimal, if any, treatment or recycled as process water. Process water thus produced may be especially useful in practicing the present methods. Thus, a further advantage of the present methods may be reduced process water requirements as compared to conventional isolate preparation processes.

Methods of the present disclosure provide advantages over conventional methods for manufacture of soy protein isolates and concentrates in at least two ways. As noted, conventional methods for manufacturing soy protein materials typically dispose of the soy whey stream (e.g. aqueous soy whey or soy molasses). Thus, the products recovered by the methods of the present disclosure represent an additional product, and a revenue source not currently realized in connection with conventional soy protein isolate and soy protein concentrate manufacture. Furthermore, treatment of the soy whey stream or soy molasses to recover saleable products preferably reduces the costs associated with treatment and disposal of the soy whey stream or soy molasses. For example, as detailed elsewhere herein, various methods of the present invention provide a relatively pure soy processing stream that may be readily utilized in various other processes or disposed of with minimal, if any, treatment, thereby reducing the environmental impact of the process. Certain costs exist in association with the methods of the present disclosure, but the benefits of the additional product(s) isolated and minimization of waste disposal are believed to compensate for any added costs.

### A. Soy Whey Proteins

The soy whey proteins recovered in accordance with the processes of the present disclosure represent a significant advance in the art over other soy proteins and isolates. As noted herein, the soy whey proteins of the present disclosure, which are recovered from a processing stream, possess unique characteristics as compared to other soy proteins found in the art.

Soy protein isolates are typically precipitated from an aqueous extract of defatted soy flakes or soy flour at the isoelectric point of soy storage proteins (e.g. a pH of about 4.1). Thus, soy protein isolates generally include proteins that are not soluble in acidic liquid media. Similarly, the proteins of soy protein concentrates, the second-most refined soy protein material, are likewise generally not soluble in acidic liquid media. However, soy whey proteins recovered by the processes of the present disclosure differ in that they are generally acid-soluble, meaning they are soluble in acidic liquid media.

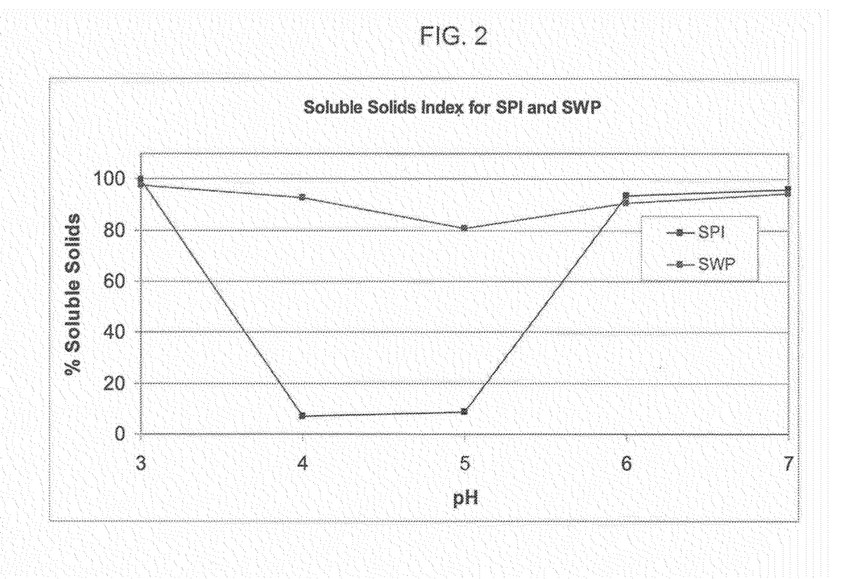

The present disclosure provides soy whey protein compositions derived from an aqueous soy whey that exhibit advantageous characteristics over soy proteins found in the prior art. For example, the soy whey proteins isolated according to the methods of the present invention possess high solubility (i.e. SSI % greater than 80) across a relatively wide pH range of the aqueous (typically acidic) medium (e.g. an aqueous medium having a pH of from about 2 to about 10, from about 2 to about 7, or from about 2 to about 6) at ambient conditions (e.g. a temperature of about 25° C.). As shown in Table 1 and graphically illustrated in FIG. 2, the solubility of the soy whey proteins isolated in accordance with the methods of the present disclosure, at all pH values tested, was at least 80%, and in all but one instance (i.e. pH 4) was at least about 90%. These findings were compared with soy protein isolate, which was shown to display poor solubility characteristics at the same acid pH values. This unique characteristic enables the soy whey proteins of the present invention to be used in applications having acidic pH levels, which represents a significant advantage over soy isolate.

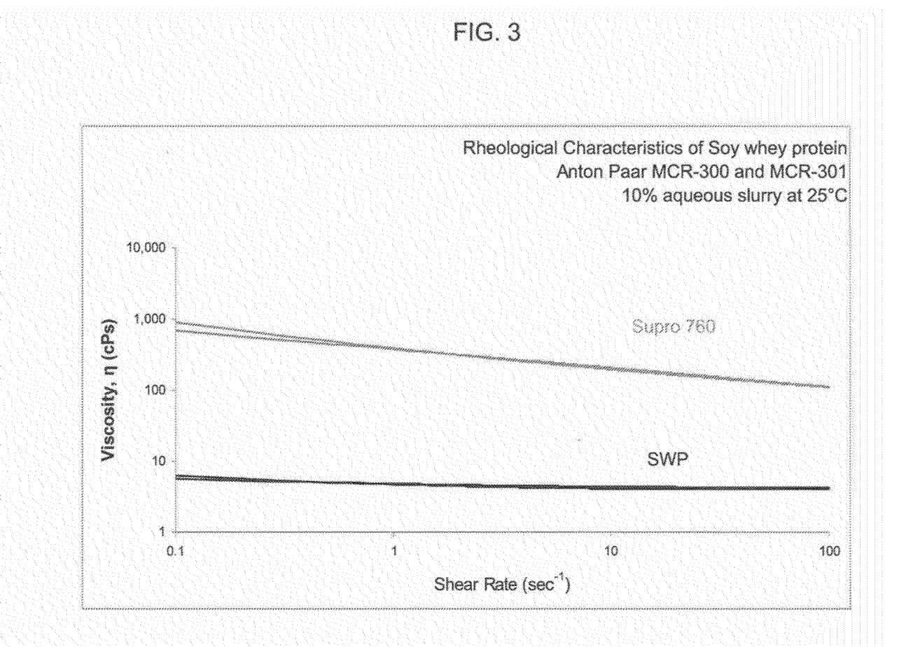

In addition to solubility, the soy whey proteins of the present disclosure also possess much lower viscosity than other soy whey proteins. As shown in Table 1 and as graphically illustrated in FIG. 3, the soy whey proteins of the present invention displayed viscoelastic properties (i.e. rheological properties) more similar to that of water than shown by soy protein isolate. The viscosity of water is about 1 centipoise (cP) at 20° C. The soy whey proteins of the present disclosure were found to exhibit viscosity within the range of from about 2.0 to 10.0 cP, and preferably from about 3.6 to 7.5 cP. This low viscosity, in addition to its high solubility at acidic pH levels, makes the soy whey protein of the present disclosure available and better suited for use in certain applications that regularly involve the use of other soy proteins (e.g., in beverages), because it has much better flow characteristics than that of soy isolate.

TABLE 1
Solubility and Viscoelastic Properties of Soy Whey Compared to
Other Soy Proteins

| | SWP | Supro 500E | Supro 670 | Supro 760 |
|---|---|---|---|---|
| SSI %, pH 3.0 | 99 | 100 | | |
| SSI %, pH 4.0 | 82.3 | 7 | | |
| SSI %, pH 5.0 | 89.4 | 9 | | |
| SSI %, pH 6.0 | 99.3 | 94 | | |
| SSI %, pH 7.0 | 99.4 | 96 | | |
| viscosity, cPs | 4.3 | | | 385 |

As Table 2 illustrates, the other physical characteristics, with the exception of the viscoelastic properties and solubility, of the soy whey protein recovered in accordance with the methods of the present disclosure were found to be very similar to that of soy isolate.

TABLE 2
Physical Characteristic Ranges of Soy Whey Compared to Other
Soy Proteins

| | ranges, | | combined |
|---|---|---|---|
| | leper | ranges, St. Louis | SWP range |
| moisture | 2.94-9.34 | 3.91-8.29 | 2.9-9.4 |
| protein_db | 71.0-89.3 | 62.48-85.17 | 62.4-89.3 |
| ash_db | 1.19-6.23 | 1.19-13.57 | 1.19-13.57 |
| fat_db | 0.201-1.11 | 0.14-1.57 | 0.14-1.57 |
| carbohydrate | 7.2-23.7 | 5.4-30.5 | 5.4-30.5 |
| by diff_db | (10 & 20 kDa | | |
| | membrane) | | |

| | | | combined |
|---|---|---|---|
| | leper SWP | St. Louis SWP | range |
| SSI %, pH 3.0 | 79-99 | 71.6-100 | 71-100 |
| SSI %, pH 4.0 | 68.7-97.3 | 67.4-94.7 | 67-98 |
| SSI %, pH 5.0 | 70.4-88.9 | 69.4-91.5 | 69-92 |
| SSI %, pH 6.0 | 79.1-93.49 | 75.1-100 | 75-100 |
| SSI %, pH 7.0 | 77.6-97.2 | 79.6-100 | 77-100 |
| viscosity, cPs | 3.6-7.5 | 3.3 (1 sample | 3.3-7.5 |
| | | only) | |

### B. Aqueous Whey Streams

Aqueous whey streams and molasses streams, which are types of soy processing streams, are generated from the process of refining a whole legume or oilseed. The whole legume or oilseed may be derived from a variety of suitable plants. By way of non-limiting example, suitable plants include leguminous plants, including for example, soybeans, corn, peas, canola, sunflowers, sorghum, rice, amaranth, potato, tapioca, arrowroot, canna, lupin, rape, wheat, oats, rye, barley, and mixtures thereof. In one embodiment, the leguminous plant is soybean and the aqueous whey stream generated from the process of refining the soybean is an aqueous soy whey stream.

Aqueous soy whey streams generated in the manufacture of soy protein isolates are generally relatively dilute and are typically discarded as waste. More particularly, the aqueous soy whey stream typically has a total solids content of less than about 10 wt. %, typically less than about 7.5 wt. % and, still more typically, less than about 5 wt. %. For example, in various aspects, the solids content of the aqueous soy whey stream is from about 0.5 to about 10 wt. %, from about 1 wt. % to about 4 wt. %, or from about 1 to about 3 wt. % (e.g. about 2 wt. %). Thus, during commercial soy protein isolate production, a significant volume of waste water that must be treated or disposed is generated.

Soy whey streams typically contain a significant portion of the initial soy protein content of the starting material soybeans. As used herein the term “soy protein” generally refers to any and all of the proteins native to soybeans. Naturally occurring soy proteins are generally globular proteins having a hydrophobic core surrounded by a hydrophilic shell. Numerous soy proteins have been identified including, for example, storage proteins such as glycinin and β-conglycinin. Soy proteins likewise include protease inhibitors, such as the above-noted BBI proteins. Soy proteins also include hemagglutinins such as lectin, lipoxygenases, β-amylase, and lunasin. It is to be noted that the soy plant may be transformed to produce other proteins not normally expressed by soy plants. It is to be understood that reference herein to “soy proteins” likewise contemplates proteins thus produced.

On a dry weight basis, soy proteins constitute at least about 10 wt. %, at least about 15 wt. %, or at least about 20 wt. % of the soy whey stream (dry weight basis). Typically, soy proteins constitute from about 10 to about 40 wt. %, or from about 25 to about 30 wt. % of the soy whey stream (dry weight basis). Soy protein isolates typically contain a significant portion of the storage proteins of the soybean. However, the soy whey stream remaining after isolate precipitation likewise contains one or more soy storage proteins.

In addition to the various soy proteins, the aqueous soy whey stream likewise comprises one or more carbohydrates (i.e. sugars). Generally, sugars constitute at least about 25%, at least about 35%, or at least about 45% by weight of the soy whey stream (dry weight basis). Typically, sugars constitute from about 25% to about 75%, more typically from about 35% to about 65% and, still more typically, from about 40% to about 60% by weight of the soy whey stream (dry weight basis).

The sugars of the soy whey stream generally include one or more monosaccharides, and/or one or more oligosaccharides or polysaccharides. For example, in various aspects, the soy whey stream comprises monosaccharides selected from the group consisting of glucose, fructose, and combinations thereof. Typically, monosaccharides constitute from about 0.5% to about 10 wt. % and, more typically from about 1% to about 5 wt. % of the soy whey stream (dry weight basis). Further in accordance with these and various other aspects, the soy whey stream comprises oligosaccharides selected from the group consisting of sucrose, raffinose, stachyose, and combinations thereof. Typically, oligosaccharides constitute from about 30% to about 60% and, more typically, from about 40% to about 50% by weight of the soy whey stream (dry weight basis).

The aqueous soy whey stream also typically comprises an ash fraction that includes a variety of components including, for example, various minerals, isoflavones, phytic acid, citric acid, saponins, and vitamins. Minerals typically present in the soy whey stream include sodium, potassium, calcium, phosphorus, magnesium, chloride, iron, manganese, zinc, copper, and combinations thereof. Vitamins present in the soy whey stream include, for example, thiamine and riboflavin. Regardless of its precise composition, the ash fraction typically constitutes from about 5% to about 30% and, more typically, from about 10% to about 25% by weight of the soy whey stream (dry weight basis).

The aqueous soy whey stream also typically comprises a fat fraction that generally constitutes from about 0.1% to about 5% by weight of the soy whey stream (dry weight basis). In certain aspects of the invention, the fat content is measured by acid hydrolysis and is about 3% by weight of the soy whey stream (dry weight basis).

In addition to the above components, the aqueous soy whey stream also typically comprises one or more microorganisms including, for example, various bacteria, molds, and yeasts. The proportions of these components typically vary from about 100 to about 1×10⁹ colony forming units (CFU) per milliliter. As detailed elsewhere herein, in various aspects, the aqueous soy whey stream is treated to remove these component(s) prior to protein recovery and/or isolation.

As noted, conventional production of soy protein isolates typically includes disposal of the aqueous soy whey stream remaining following isolation of the soy protein isolate. In accordance with the present disclosure, recovery of one or more proteins and various other components (e.g. sugars and minerals) results in a relatively pure aqueous whey stream. Conventional soy whey streams from which the protein and one or more components have not been removed generally require treatment prior to disposal and/or reuse. In accordance with various aspects of the present disclosure the aqueous whey stream may be disposed of or utilized as process water with minimal, if any, treatment. For example, the aqueous whey stream may be used in one or more filtration (e.g. diafiltration) operations of the present disclosure.

In addition to recovery of BBI proteins from aqueous soy whey streams generated in the manufacture of soy protein isolates, it is to be understood that the processes described herein are likewise suitable for recovery of one or more components of soy molasses streams generated in the manufacture of a soy protein concentrate, as soy molasses streams are an additional type of soy processing stream.

### C. General Description of Process for Soy Whey Protein Recovery

The following is a general description of the various steps that make up the overall process. A key to the process is to start with the whey protein pretreatment step, which uniquely changes the soy whey and protein properties. From there, the other steps may be performed using the raw material sources as listed in each step, as will be shown in the discussion of the various embodiments to follow.

It is understood by those skilled in the art of separation technology that there can be residual components in each permeate or retentate stream since separation is never 100%. Further, one skilled in the art realizes that separation technology can vary depending on the starting raw material.

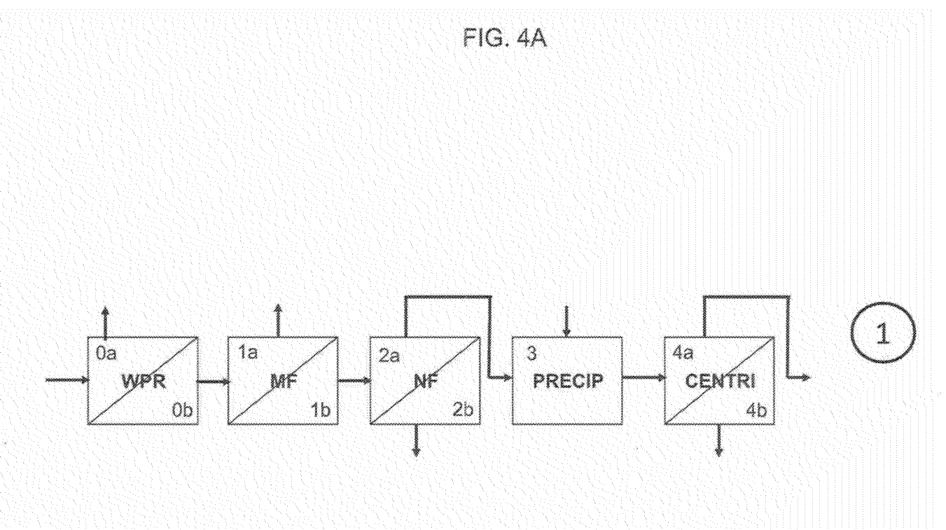

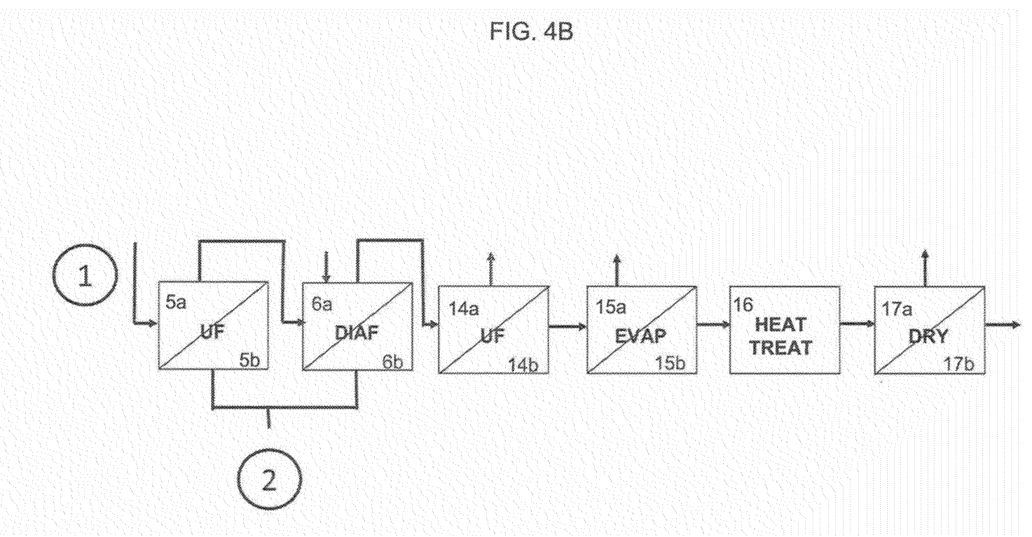

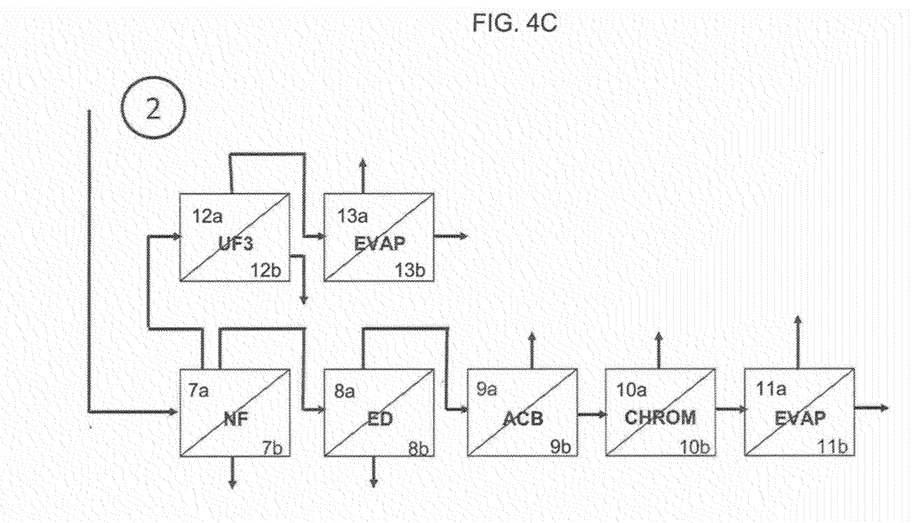

Step 0 (as shown in FIG. 4A)—Whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kiloDalton (kD)) in stream 0a (retentate) and insoluble large molecular weight proteins (between about 300 kD and between about 50 kD) in stream 0b (permeate), such as pre-treated soy whey, storage proteins, and combinations thereof.

Step 1 (as shown in FIG. 4A)—Microbiology reduction can start with the product of the whey protein pretreatment step, including but not limited to pre-treated soy whey. This step involves microfiltration of the pre-treated soy whey. Process variables and alternatives in this step include but are not limited to, centrifugation, dead-end filtration, heat sterilization, ultraviolet sterilization, microfiltration, crossflow membrane filtration, and combinations thereof. Crossflow membrane filtration includes but is not limited to: spiral-wound, plate and frame, hollow fiber, ceramic, dynamic or rotating disk, nanofiber, and combinations thereof. The pH of step 1 can be between about 2.0 and about 12.0, preferably about 5.3. The temperature can be between about 5° C. and about 90° C., preferably about 50° C. Products from step 1 include but are not limited to storage proteins, microorganisms, silicon, and combinations thereof in stream 1a (retentate) and purified pre-treated soy whey in stream 1b (permeate).

Step 2 (as shown in FIG. 4A)—A water and mineral removal can start with the purified pre-treated soy whey from stream 1b or 4a, or pre-treated soy whey from stream 0b. It includes a nanofiltration step for water removal and partial mineral removal. Process variables and alternatives in this step include but are not limited to, crossflow membrane filtration, reverse osmosis, evaporation, nanofiltration, and combinations thereof. Crossflow membrane filtration includes but is not limited to: spiral-wound, plate and frame, hollow fiber, ceramic, dynamic or rotating disk, nanofiber, and combinations thereof. The pH of step 2 can be between about 2.0 and about 12.0, preferably about 5.3. The temperature can be between about 5° C. and about 90° C., preferably about 50° C. Products from this water removal step include but are not limited to purified pre-treated soy whey in stream 2a (retentate) and water, some minerals, monovalent cations and combinations thereof in stream 2b (permeate).

Step 3 (as shown in FIG. 4A)—the mineral precipitation step can start with purified pre-treated soy whey from stream 2a or pretreated soy whey from streams 0a or 1b. It includes a precipitation step by pH and/or temperature change. Process variables and alternatives in this step include but are not limited to, an agitated or recirculating reaction tank. Processing aids that can be used in the mineral precipitation step include but are not limited to, acids, bases, calcium hydroxide, sodium hydroxide, hydrochloric acid, sodium chloride, phytase, and combinations thereof. The pH of step 3 can be between about 2.0 and about 12.0, preferably about 8.0. The temperature can be between about 5° C. and about 90° C., preferably about 50° C. The pH hold times can vary between about 0 minutes to about 60 minutes, preferably about 10 minutes. The product of stream 3 is a suspension of purified pre-treated soy whey and precipitated minerals.

Step 4 (as shown in FIG. 4A)—the mineral removal step can start with the suspension of purified pre-treated whey and precipitated minerals from stream 3. It includes a centrifugation step. Process variables and alternatives in this step include but are not limited to, centrifugation, filtration, dead-end filtration, crossflow membrane filtration and combinations thereof. Crossflow membrane filtration includes but is not limited to: spiral-wound, plate and frame, hollow fiber, ceramic, dynamic or rotating disk, nanofiber, and combinations thereof. Products from the mineral removal step include but are not limited to a de-mineralized pre-treated whey in stream 4a (retentate) and insoluble minerals with some protein mineral complexes in stream 4b (permeate).

Step 5 (as shown in FIG. 4B)—the protein separation and concentration step can start with purified pre-treated whey from stream 4a or the whey from streams 0a, 1b, or 2a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Step 6 (as shown in FIG. 4B)—the protein washing and purification step can start with soy whey protein, BBI, KTI, storage proteins, other proteins or purified pre-treated whey from stream 4a or 5a, or whey from streams 0a, 1b, or 2a. It includes a diafiltration step. Process variables and alternatives in this step include but are not limited to, reslurrying, crossflow membrane filtration, ultrafiltration, water diafiltration, buffer diafiltration, and combinations thereof. Crossflow membrane filtration includes but is not limited to: spiral-wound, plate and frame, hollow fiber, ceramic, dynamic or rotating disk, nanofiber, and combinations thereof. Processing aids that can be used in the protein washing and purification step include but are not limited to, water, steam, and combinations thereof. The pH of step 6 can be between about 2.0 and about 12.0, preferably about 7.0. The temperature can be between about 5° C. and about 90° C., preferably about 75° C. Products from stream 6a (retentate) include but are not limited to, soy whey protein, BBI, KTI, storage proteins, other proteins, and combinations thereof. Other proteins include but are not limited to lunasin, lectins, dehydrins, lipoxygenase, and combinations thereof. Products from stream 6b (permeate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Minerals include but are not limited to calcium citrate.

Step 7 (as shown in FIG. 4C)—a water removal step can start with peptides, soy oligosaccharides, water, minerals, and combinations thereof from stream 5b and/or stream 6b. Soy oligosaccharides include but are not limited to sucrose, raffinose, stachyose, verbascose, monosaccharides, and combinations thereof. It includes a nanofiltration step. Process variables and alternatives in this step include but are not limited to, reverse osmosis, evaporation, nanofiltration, water diafiltration, buffer diafiltration, and combinations thereof. The pH of step 7 can be between about 2.0 and about 12.0, preferably about 7.0. The temperature can be between about 5° C. and about 90° C., preferably about 50° C. Products from stream 7a (retentate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Products from stream 7b (permeate) include but are not limited to, water, minerals, and combinations thereof.

Step 8 (as shown in FIG. 4C)—a mineral removal step can start with peptides, soy oligosaccharides, water, minerals, and combinations thereof from streams 5b, 6b, 7a, and/or 12a. Soy oligosaccharides include but are not limited to sucrose, raffinose, stachyose, verbascose, monosaccharides, and combinations thereof. It includes an electrodialysis membrane step. Process variables and alternatives in this step include but are not limited to, ion exchange columns, chromatography, and combinations thereof. Processing aids that can be used in this mineral removal step include but are not limited to, water, enzymes, and combinations thereof. Enzymes include but are not limited to protease, phytase, and combinations thereof. The pH of step 8 can be between about 2.0 and about 12.0, preferably about 7.0. The temperature can be between about 5° C. and about 90° C., preferably about 40° C. Products from stream 8a (retentate) include but are not limited to, de-mineralized soy oligosaccharides with conductivity between about 10 milli Siemens (mS) and about 0.5 mS, preferably about 2 mS, and combinations thereof. Soy oligosaccharides include but are not limited to sucrose, raffinose, stachyose, verbascose, monosaccharides, and combinations thereof. Products from stream 8b include but are not limited to, minerals, water, and combinations thereof.

Step 9 (as shown in FIG. 4C)—a color removal step can start with de-mineralized soy oligosaccharides from streams 8a, 5b, 6b, and/or 7a). It utilizes an active carbon bed. Process variables and alternatives in this step include but are not limited to, ion exchange. Processing aids that can be used in this color removal step include but are not limited to, active carbon, ion exchange resins, and combinations thereof. The temperature can be between about 5° C. and about 90° C., preferably about 40° C. Products from stream 9a (retentate) include but are not limited to, color compounds. Stream 9b is decolored. Products from stream 9b (permeate) include but are not limited to, soy oligosaccharides, and combinations thereof. Soy oligosaccharides include but are not limited to sucrose, raffinose, stachyose, verbascose, monosaccharides, and combinations thereof.

Step 10 (as shown in FIG. 4C)—a soy oligosaccharide fractionation step can start with soy oligosaccharides, and combinations thereof from streams 9b, 5b, 6b, 7a, and/or 8a. Soy oligosaccharides include but are not limited to sucrose, raffinose, stachyose, verbascose, monosaccharides, and combinations thereof. It includes a chromatography step. Process variables and alternatives in this step include but are not limited to, chromatography, nanofiltration, and combinations thereof. Processing aids that can be used in this soy oligosaccharide fractionation step include but are not limited to acid and base to adjust the pH as one know in the art and related to the resin used. Products from stream 10a (retentate) include but are not limited to, soy oligosaccharides such as sucrose, monosaccharides, and combinations thereof. Products from stream 10b (permeate) include but are not limited to soy oligosaccharides such as, raffinose, stachyose, verbascose, and combinations thereof.

Step 11 (as shown in FIG. 4C)—a water removal step can start with soy oligosaccharides such as, raffinose, stachyose, verbascose, and combinations thereof from streams 9b, 5b, 6b, 7a, 8a, and/or 10a. It includes an evaporation step. Process variables and alternatives in this step include but are not limited to, evaporation, reverse osmosis, nanofiltration, and combinations thereof. Processing aids that can be used in this water removal step include but are not limited to, defoamer, steam, vacuum, and combinations thereof. The temperature can be between about 5° C. and about 90° C., preferably about 60° C. Products from stream 11a (retentate) include but are not limited to, water. Products from stream 11b (permeate) include but are not limited to, soy oligosaccharides, such as, raffinose, stachyose, verbascose, and combinations thereof.

Step 12 (as shown in FIG. 4C)—an additional protein separation from soy oligosaccharides step can start with peptides, soy oligosaccharides, water, minerals, and combinations thereof from stream 7b. Soy oligosaccharides include but are not limited to sucrose, raffinose, stachyose, verbascose, monosaccharides, and combinations thereof. It includes an ultrafiltration step. Process variables and alternatives in this step include but are not limited to, crossflow membrane filtration, ultrafiltration with pore sizes between about 50 kD and about 1 kD, and combinations thereof. Crossflow membrane filtration includes but is not limited to: spiral-wound, plate and frame, hollow fiber, ceramic, dynamic or rotating disk, nanofiber, and combinations thereof. Processing aids that can be used in this protein separation from sugars step include but are not limited to, acids, bases, protease, phytase, and combinations thereof. The pH of step 12 can be between about 2.0 and about 12.0, preferably about 7.0. The temperature can be between about 5° C. and about 90° C., preferably about 75° C. Products from stream 12a (retentate) include but are not limited to, soy oligosaccharides, water, minerals, and combinations thereof. Soy oligosaccharides include but are not limited to sucrose, raffinose, stachyose, verbascose, monosaccharides, and combinations thereof. Minerals include but are not limited to calcium citrate. This stream 12a stream can be fed to stream 8. Products from stream 12b (permeate) include but are not limited to, peptides, and other proteins. Other proteins include but are not limited to lunasin, lectins, dehydrins, lipoxygenase, and combinations thereof.

Step 13 (as shown in FIG. 4C)—a water removal step can start with, peptides, and other proteins. Other proteins include but are not limited to lunasin, lectins, dehydrins, lipoxygenase, and combinations thereof. It includes an evaporation step. Process variables and alternatives in this step include but are not limited to, reverse osmosis, nanofiltration, spray drying and combinations thereof. Products from stream 13a (retentate) include but are not limited to, water. Products from stream 13b (permeate) include but are not limited to, peptides, other proteins, and combinations thereof. Other proteins include but are not limited to lunasin, lectins, dehydrins, lipoxygenase, and combinations thereof.

Step 14 (as shown in FIG. 4B)—a protein fractionation step may be done by starting with soy whey protein, BBI, KTI, storage proteins, other proteins, and combinations thereof from streams 6a and/or 5a. Other proteins include but are not limited to lunasin, lectins, dehydrins, lipoxygenase, and combinations thereof. It includes an ultrafiltration (with pore sizes from 100 kD to 10 kD) step. Process variables and alternatives in this step include but are not limited to, crossflow membrane filtration, ultrafiltration, nanofiltration, and combinations thereof. Crossflow membrane filtration includes but is not limited to: spiral-wound, plate and frame, hollow fiber, ceramic, dynamic or rotating disk, nanofiber, and combinations thereof. The pH of step 14 can be between about 2.0 and about 12.0, preferably about 7.0. The temperature can be between about 5° C. and about 90° C., preferably about 75° C. Products from stream 14a (retentate) include but are not limited to, storage proteins. Products from stream 14b (permeate) include but are not limited to, soy whey protein, BBI, KTI and, other proteins. Other proteins include but are not limited to lunasin, lectins, dehydrins, lipoxygenase, and combinations thereof.

Step 15 (as shown in FIG. 4B)—a water removal step can start with soy whey protein, BBI, KTI and, other proteins from streams 6a, 5a, and/or 14b. Other proteins include but are not limited to lunasin, lectins, dehydrins, lipoxygenase, and combinations thereof. It includes an evaporation step. Process variables and alternatives in this step include but are not limited to, evaporation, nanofiltration, RO, and combinations thereof. Products from stream 15a (retentate) include but are not limited to, water. Stream 15b (permeate) products include but are not limited to soy whey protein, BBI, KTI and, other proteins. Other proteins include but are not limited to lunasin, lectins, dehydrins, lipoxygenase, and combinations thereof.

Step 16 (as shown in FIG. 4B)—a heat treatment and flash cooling step can start with soy whey protein, BBI, KTI and, other proteins from streams 6a, 5a, 14b, and/or 15b. Other proteins include but are not limited to lunasin, lectins, dehydrins, lipoxygenase, and combinations thereof. It includes an ultra high temperature step. Process variables and alternatives in this step include but are not limited to, heat sterilization, evaporation, and combinations thereof. Processing aids that can be used in this heat treatment and flash cooling step include but are not limited to, water, steam, and combinations thereof. The temperature can be between about 129° C. and about 160° C., preferably about 152° C. Temperature hold time can be between about 8 seconds and about 15 seconds, preferably about 9 seconds. Products from stream 16 include but are not limited to, soy whey protein.

Step 17 (as shown in FIG. 4B)—a drying step can start with soy whey protein, BBI, KTI and, other proteins from streams 6a, 5a, 14b, 15b, and/or 16. It includes a drying step. The liquid feed temperature can be between about 50° C. and about 95° C., preferably about 82° C. The inlet temperature can be between about 175° C. and about 370° C., preferably about 290° C. The exhaust temperature can be between about 65° C. and about 98° C., preferably about 88° C. Products from stream 17a (retentate) include but are not limited to, water. Products from stream 17b (permeate) include but are not limited to, soy whey protein which includes, BBI, KTI and, other proteins. Other proteins include but are not limited to lunasin, lectins, dehydrins, lipoxygenase, and combinations thereof.

The soy whey protein products of the current application include raw whey, a soy whey protein precursor after the ultrafiltration step of Step 17, a dry soy whey protein that can be dried by any means known in the art, and combinations thereof. All of these products can be used as is as soy whey protein or can be further processed to purify specific components of interest, such as, but not limited to BBI, KTI, and combinations thereof.

### D. Preferred Embodiments of the Process for the Recovery of Soy Whey Protein

Embodiment 1 starts with Step 0 (See FIG. 4A) as follows: Whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kiloDalton (kD)) in stream 0a (retentate) and insoluble large molecular weight proteins (between about 300 kD and between about 50 kD) in stream 0b (permeate), such as pre-treated soy whey, storage proteins, and combinations thereof. Next

Step 5 (See FIG. 4B) is done. Thus, the protein separation and concentration step in this embodiment starts with the whey from stream 0a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Embodiment 2—starts with Step 0 (See FIG. 4A) as follows: Whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kiloDalton (kD)) in stream 0a (retentate) and insoluble large molecular weight proteins (between about 300 kD and between about 50 kD) in stream 0b (permeate), such as pre-treated soy whey, storage proteins, and combinations thereof.

Next Step 5 (See FIG. 4B) is done. Thus, the protein separation and concentration step in this embodiment starts with the whey from stream 0a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Finally Step 6 (See FIG. 4B), the protein washing and purification step starts with soy whey protein, BBI, KTI, storage proteins, other proteins or purified pre-treated whey from stream 5a. It includes a diafiltration step. Process variables and alternatives in this step include but are not limited to, reslurrying, crossflow membrane filtration, ultrafiltration, water diafiltration, buffer diafiltration, and combinations thereof. Crossflow membrane filtration includes but is not limited to: spiral-wound, plate and frame, hollow fiber, ceramic, dynamic or rotating disk, nanofiber, and combinations thereof. Processing aids that can be used in the protein washing and purification step include but are not limited to, water, steam, and combinations thereof. The pH of step 6 can be between about 2.0 and about 12.0, preferably about 7.0. The temperature can be between about 5° C. and about 90° C., preferably about 75° C. Products from stream 6a (retentate) include but are not limited to, soy whey protein, BBI, KTI, storage proteins, other proteins, and combinations thereof. Other proteins include but are not limited to lunasin, lectins, dehydrins, lipoxygenase, and combinations thereof. Products from stream 6b (permeate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Minerals include but are not limited to calcium citrate.

Embodiment 3 starts with Step 0 (See FIG. 4A) which is a whey protein pretreatment that can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kiloDalton (kD)) in stream 0a (retentate) and insoluble large molecular weight proteins (between about 300 kD and between about 50 kD) in stream 0b (permeate), such as pre-treated soy whey, storage proteins, and combinations thereof.

Step 3 (See FIG. 4A) the mineral precipitation step can start with purified pre-treated soy whey from stream 0a. It includes a precipitation step by pH and/or temperature change. Process variables and alternatives in this step include but are not limited to, an agitated or recirculating reaction tank. Processing aids that can be used in the mineral precipitation step include but are not limited to, acids, bases, calcium hydroxide, sodium hydroxide, hydrochloric acid, sodium chloride, phytase, and combinations thereof. The pH of step 3 can be between about 2.0 and about 12.0, preferably about 8.0. The temperature can be between about 5° C. and about 90° C., preferably about 50° C. The pH hold times can vary between about 0 minutes to about 60 minutes, preferably about 10 minutes. The product of stream 3 is a suspension of purified pre-treated soy whey and precipitated minerals.

Step 4 (See FIG. 4A) the mineral removal step can start with the suspension of purified pre-treated whey and precipitated minerals from stream 3. It includes a centrifugation step. Process variables and alternatives in this step include but are not limited to, centrifugation, filtration, dead-end filtration, crossflow membrane filtration and combinations thereof. Crossflow membrane filtration includes but is not limited to: spiral-wound, plate and frame, hollow fiber, ceramic, dynamic or rotating disk, nanofiber, and combinations thereof. Products from the mineral removal step include but are not limited to a de-mineralized pre-treated whey in stream 4a (retentate) and insoluble minerals with some protein mineral complexes in stream 4b (permeate).

Finally, Step 5 (See FIG. 4B) the protein separation and concentration step can start with purified pre-treated whey from stream 4a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Embodiment 4 starts with Step 0 (See FIG. 4A) whey protein pretreatment that can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kiloDalton (kD)) in stream 0a (retentate) and insoluble large molecular weight proteins (between about 300 kD and between about 50 kD) in stream 0b (permeate), such as pre-treated soy whey, storage proteins, and combinations thereof.

Step 3 (See FIG. 4A) the mineral precipitation step can start with purified pre-treated soy whey from stream 0a. It includes a precipitation step by pH and/or temperature change. Process variables and alternatives in this step include but are not limited to, an agitated or recirculating reaction tank. Processing aids that can be used in the mineral precipitation step include but are not limited to, acids, bases, calcium hydroxide, sodium hydroxide, hydrochloric acid, sodium chloride, phytase, and combinations thereof. The pH of step 3 can be between about 2.0 and about 12.0, preferably about 8.0. The temperature can be between about 5° C. and about 90° C., preferably about 50° C. The pH hold times can vary between about 0 minutes to about 60 minutes, preferably about 10 minutes. The product of stream 3 is a suspension of purified pre-treated soy whey and precipitated minerals.

Step 4 (See FIG. 4A)—the mineral removal step can start with the suspension of purified pre-treated whey and precipitated minerals from stream 3. It includes a centrifugation step. Process variables and alternatives in this step include but are not limited to, centrifugation, filtration, dead-end filtration, crossflow membrane filtration and combinations thereof. Crossflow membrane filtration includes but is not limited to: spiral-wound, plate and frame, hollow fiber, ceramic, dynamic or rotating disk, nanofiber, and combinations thereof. Products from the mineral removal step include but are not limited to a de-mineralized pre-treated whey in stream 4a (retentate) and insoluble minerals with some protein mineral complexes in stream 4b (permeate).

Step 5 (See FIG. 4B)—the protein separation and concentration step can start with purified pre-treated whey from stream 4a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Finally, Step 6 (See FIG. 4B) the protein washing and purification step can start with soy whey protein, BBI, KTI, storage proteins, other proteins or purified pre-treated whey from stream 5a. It includes a diafiltration step. Process variables and alternatives in this step include but are not limited to, reslurrying, crossflow membrane filtration, ultrafiltration, water diafiltration, buffer diafiltration, and combinations thereof. Crossflow membrane filtration includes but is not limited to: spiral-wound, plate and frame, hollow fiber, ceramic, dynamic or rotating disk, nanofiber, and combinations thereof. Processing aids that can be used in the protein washing and purification step include but are not limited to, water, steam, and combinations thereof. The pH of step 6 can be between about 2.0 and about 12.0, preferably about 7.0. The temperature can be between about 5° C. and about 90° C., preferably about 75° C. Products from stream 6a (retentate) include but are not limited to, soy whey protein, BBI, KTI, storage proteins, other proteins, and combinations thereof. Other proteins include but are not limited to lunasin, lectins, dehydrins, lipoxygenase, and combinations thereof. Products from stream 6b (permeate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Minerals include but are not limited to calcium citrate.

Embodiment 5 starts with Step 0 (See FIG. 4A) the whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kiloDalton (kD)) in stream 0a (retentate) and insoluble large molecular weight proteins (between about 300 kD and between about 50 kD) in stream 0b (permeate), such as pre-treated soy whey, storage proteins, and combinations thereof.

Step 3 (See FIG. 4A) the mineral precipitation step can start with pre-treated soy whey from stream 0a. It includes a precipitation step by pH and/or temperature change. Process variables and alternatives in this step include but are not limited to, an agitated or recirculating reaction tank. Processing aids that can be used in the mineral precipitation step include but are not limited to, acids, bases, calcium hydroxide, sodium hydroxide, hydrochloric acid, sodium chloride, phytase, and combinations thereof. The pH of step 3 can be between about 2.0 and about 12.0, preferably about 8.0. The temperature can be between about 5° C. and about 90° C., preferably about 50° C. The pH hold times can vary between about 0 minutes to about 60 minutes, preferably about 10 minutes. The product of stream 3 is a suspension of purified pre-treated soy whey and precipitated minerals.

Step 4 (See FIG. 4A)—the mineral removal step can start with the suspension of purified pre-treated whey and precipitated minerals from stream 3. It includes a centrifugation step. Process variables and alternatives in this step include but are not limited to, centrifugation, filtration, dead-end filtration, crossflow membrane filtration and combinations thereof. Crossflow membrane filtration includes but is not limited to: spiral-wound, plate and frame, hollow fiber, ceramic, dynamic or rotating disk, nanofiber, and combinations thereof. Products from the mineral removal step include but are not limited to a de-mineralized pre-treated whey in stream 4a (retentate) and insoluble minerals with some protein mineral complexes in stream 4b (permeate).

Step 5 (See FIG. 4B) the protein separation and concentration step can start with purified pre-treated whey from stream 4a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Step 6 (See FIG. 4B)—the protein washing and purification step can start with soy whey protein, BBI, KTI, storage proteins, other proteins or purified pre-treated whey from stream 5a. It includes a diafiltration step. Process variables and alternatives in this step include but are not limited to, reslurrying, crossflow membrane filtration, ultrafiltration, water diafiltration, buffer diafiltration, and combinations thereof. Crossflow membrane filtration includes but is not limited to: spiral-wound, plate and frame, hollow fiber, ceramic, dynamic or rotating disk, nanofiber, and combinations thereof. Processing aids that can be used in the protein washing and purification step include but are not limited to, water, steam, and combinations thereof. The pH of step 6 can be between about 2.0 and about 12.0, preferably about 7.0. The temperature can be between about 5° C. and about 90° C., preferably about 75° C. Products from stream 6a (retentate) include but are not limited to, soy whey protein, BBI, KTI, storage proteins, other proteins, and combinations thereof. Other proteins include but are not limited to lunasin, lectins, dehydrins, lipoxygenase, and combinations thereof. Products from stream 6b (permeate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Minerals include but are not limited to calcium citrate.

Step 16 (See FIG. 4B) a heat treatment and flash cooling step can start with soy whey protein, BBI, KTI and, other proteins from streams 6a. Other proteins include but are not limited to lunasin, lectins, dehydrins, lipoxygenase, and combinations thereof. It includes an ultra high temperature step. Process variables and alternatives in this step include but are not limited to, heat sterilization, evaporation, and combinations thereof. Processing aids that can be used in this heat treatment and flash cooling step include but are not limited to, water, steam, and combinations thereof. The temperature can be between about 129° C. and about 160° C., preferably about 152° C. Temperature hold time can be between about 8 seconds and about 15 seconds, preferably about 9 seconds. Products from stream 16 include but are not limited to, soy whey protein.

Finally, Step 17 (See FIG. 4B)—a drying step can start with soy whey protein, BBI, KTI and, other proteins from stream 16. It includes a drying step. The liquid feed temperature can be between about 50° C. and about 95° C., preferably about 82° C. The inlet temperature can be between about 175° C. and about 370° C., preferably about 290° C. The exhaust temperature can be between about 65° C. and about 98° C., preferably about 88° C. Products from stream 17a (retentate) include but are not limited to, water. Products from stream 17b (permeate) include but are not limited to, soy whey protein which includes, BBI, KTI and, other proteins. Other proteins include but are not limited to lunasin, lectins, dehydrins, lipoxygenase, and combinations thereof.

Embodiment 6 starts with Step 0 (See FIG. 4A) the whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kiloDalton (kD)) in stream 0a (retentate) and insoluble large molecular weight proteins (between about 300 kD and between about 50 kD) in stream 0b (permeate), such as pre-treated soy whey, storage proteins, and combinations thereof.

Step 3 (See FIG. 4A) the mineral precipitation step can start with pre-treated soy whey from stream 0a. It includes a precipitation step by pH and/or temperature change. Process variables and alternatives in this step include but are not limited to, an agitated or recirculating reaction tank. Processing aids that can be used in the mineral precipitation step include but are not limited to, acids, bases, calcium hydroxide, sodium hydroxide, hydrochloric acid, sodium chloride, phytase, and combinations thereof. The pH of step 3 can be between about 2.0 and about 12.0, preferably about 8.0. The temperature can be between about 5° C. and about 90° C., preferably about 50° C. The pH hold times can vary between about 0 minutes to about 60 minutes, preferably about 10 minutes. The product of stream 3 is a suspension of purified pre-treated soy whey and precipitated minerals.

Step 4 (See FIG. 4A) the mineral removal step can start with the suspension of purified pre-treated whey and precipitated minerals from stream 3. It includes a centrifugation step. Process variables and alternatives in this step include but are not limited to, centrifugation, filtration, dead-end filtration, crossflow membrane filtration and combinations thereof. Crossflow membrane filtration includes but is not limited to: spiral-wound, plate and frame, hollow fiber, ceramic, dynamic or rotating disk, nanofiber, and combinations thereof. Products from the mineral removal step include but are not limited to a de-mineralized pre-treated whey in stream 4a (retentate) and insoluble minerals with some protein mineral complexes in stream 4b (permeate).

Step 5 (See FIG. 4B) the protein separation and concentration step can start with purified pre-treated whey from stream 4a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Step 6 (See FIG. 4B) the protein washing and purification step can start with soy whey protein, BBI, KTI, storage proteins, other proteins or purified pre-treated whey from stream 5a. It includes a diafiltration step. Process variables and alternatives in this step include but are not limited to, reslurrying, crossflow membrane filtration, ultrafiltration, water diafiltration, buffer diafiltration, and combinations thereof. Crossflow membrane filtration includes but is not limited to: spiral-wound, plate and frame, hollow fiber, ceramic, dynamic or rotating disk, nanofiber, and combinations thereof. Processing aids that can be used in the protein washing and purification step include but are not limited to, water, steam, and combinations thereof. The pH of step 6 can be between about 2.0 and about 12.0, preferably about 7.0. The temperature can be between about 5° C. and about 90° C., preferably about 75° C. Products from stream 6a (retentate) include but are not limited to, soy whey protein, BBI, KTI, storage proteins, other proteins, and combinations thereof. Other proteins include but are not limited to lunasin, lectins, dehydrins, lipoxygenase, and combinations thereof. Products from stream 6b (permeate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Minerals include but are not limited to calcium citrate.

Step 15 (See FIG. 4B) a water removal step can start with soy whey protein, BBI, KTI and, other proteins from stream 6a. Other proteins include but are not limited to lunasin, lectins, dehydrins, lipoxygenase, and combinations thereof. It includes an evaporation step. Process variables and alternatives in this step include but are not limited to, evaporation, nanofiltration, RO, and combinations thereof. Products from stream 15a (retentate) include but are not limited to, water. Stream 15b (permeate) products include but are not limited to soy whey protein, BBI, KTI and, other proteins. Other proteins include but are not limited to lunasin, lectins, dehydrins, lipoxygenase, and combinations thereof.

Step 16 (See FIG. 4B) a heat treatment and flash cooling step can start with soy whey protein, BBI, KTI and, other proteins from stream 15b. Other proteins include but are not limited to lunasin, lectins, dehydrins, lipoxygenase, and combinations thereof. It includes an ultra high temperature step. Process variables and alternatives in this step include but are not limited to, heat sterilization, evaporation, and combinations thereof. Processing aids that can be used in this heat treatment and flash cooling step include but are not limited to, water, steam, and combinations thereof. The temperature can be between about 129° C. and about 160° C., preferably about 152° C. Temperature hold time can be between about 8 seconds and about 15 seconds, preferably about 9 seconds. Products from stream 16 include but are not limited to, soy whey protein.

Finally, Step 17 (See FIG. 4B)—a drying step can start with soy whey protein, BBI, KTI and, other proteins from stream 16. It includes a drying step. The liquid feed temperature can be between about 50° C. and about 95° C., preferably about 82° C. The inlet temperature can be between about 175° C. and about 370° C., preferably about 290° C. The exhaust temperature can be between about 65° C. and about 98° C., preferably about 88° C. Products from stream 17a (retentate) include but are not limited to, water. Products from stream 17b (permeate) include but are not limited to, soy whey protein which includes, BBI, KTI and, other proteins. Other proteins include but are not limited to lunasin, lectins, dehydrins, lipoxygenase, and combinations thereof.

Embodiment 7 starts with Step 0 (See FIG. 4A) the whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kiloDalton (kD)) in stream 0a (retentate) and insoluble large molecular weight proteins (between about 300 kD and between about 50 kD) in stream 0b (permeate), such as pre-treated soy whey, storage proteins, and combinations thereof.

Step 2 (See FIG. 4A) a water and mineral removal can start with the pre-treated soy whey from stream 0b. It includes a nanofiltration step for water removal and partial mineral removal. Process variables and alternatives in this step include but are not limited to, crossflow membrane filtration, reverse osmosis, evaporation, nanofiltration, and combinations thereof. Crossflow membrane filtration includes but is not limited to: spiral-wound, plate and frame, hollow fiber, ceramic, dynamic or rotating disk, nanofiber, and combinations thereof. The pH of step 2 can be between about 2.0 and about 12.0, preferably about 5.3. The temperature can be between about 5° C. and about 90° C., preferably about 50° C. Products from this water removal step include but are not limited to purified pre-treated soy whey in stream 2a (retentate) and water, some minerals, monovalent cations and combinations thereof in stream 2b (permeate).

Finally, Step 5 (See FIG. 4B) the protein separation and concentration step can start with the whey from stream 2a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Embodiment 8 starts with Step 0 (See FIG. 4A) the whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kiloDalton (kD)) in stream 0a (retentate) and insoluble large molecular weight proteins (between about 300 kD and between about 50 kD) in stream 0b (permeate), such as pre-treated soy whey, storage proteins, and combinations thereof.

Step 2 (See FIG. 4A) a water and mineral removal can start with the pre-treated soy whey from stream 0b. It includes a nanofiltration step for water removal and partial mineral removal. Process variables and alternatives in this step include but are not limited to, crossflow membrane filtration, reverse osmosis, evaporation, nanofiltration, and combinations thereof. Crossflow membrane filtration includes but is not limited to: spiral-wound, plate and frame, hollow fiber, ceramic, dynamic or rotating disk, nanofiber, and combinations thereof. The pH of step 2 can be between about 2.0 and about 12.0, preferably about 5.3. The temperature can be between about 5° C. and about 90° C., preferably about 50° C. Products from this water removal step include but are not limited to purified pre-treated soy whey in stream 2a (retentate) and water, some minerals, monovalent cations and combinations thereof in stream 2b (permeate).

Step 5 (See FIG. 4B) the protein separation and concentration step can start with the whey from stream 2a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Finally, Step 6 (See FIG. 4B) the protein washing and purification step can start with soy whey protein, BBI, KTI, storage proteins, other proteins or purified pre-treated whey from stream 5a. It includes a diafiltration step. Process variables and alternatives in this step include but are not limited to, reslurrying, crossflow membrane filtration, ultrafiltration, water diafiltration, buffer diafiltration, and combinations thereof. Crossflow membrane filtration includes but is not limited to: spiral-wound, plate and frame, hollow fiber, ceramic, dynamic or rotating disk, nanofiber, and combinations thereof. Processing aids that can be used in the protein washing and purification step include but are not limited to, water, steam, and combinations thereof. The pH of step 6 can be between about 2.0 and about 12.0, preferably about 7.0. The temperature can be between about 5° C. and about 90° C., preferably about 75° C. Products from stream 6a (retentate) include but are not limited to, soy whey protein, BBI, KTI, storage proteins, other proteins, and combinations thereof. Other proteins include but are not limited to lunasin, lectins, dehydrins, lipoxygenase, and combinations thereof. Products from stream 6b (permeate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Minerals include but are not limited to calcium citrate.

Embodiment 9 starts with Step 0 (See FIG. 4A) the whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kiloDalton (kD)) in stream 0a (retentate) and insoluble large molecular weight proteins (between about 300 kD and between about 50 kD) in stream 0b (permeate), such as pre-treated soy whey, storage proteins, and combinations thereof.

Step 2 (See FIG. 4A) a water and mineral removal can start with the pre-treated soy whey from stream 0b. It includes a nanofiltration step for water removal and partial mineral removal. Process variables and alternatives in this step include but are not limited to, crossflow membrane filtration, reverse osmosis, evaporation, nanofiltration, and combinations thereof. Crossflow membrane filtration includes but is not limited to: spiral-wound, plate and frame, hollow fiber, ceramic, dynamic or rotating disk, nanofiber, and combinations thereof. The pH of step 2 can be between about 2.0 and about 12.0, preferably about 5.3. The temperature can be between about 5° C. and about 90° C., preferably about 50° C. Products from this water removal step include but are not limited to purified pre-treated soy whey in stream 2a (retentate) and water, some minerals, monovalent cations and combinations thereof in stream 2b (permeate).

Step 3 (See FIG. 4A) the mineral precipitation step can start with purified pre-treated soy whey from stream 2a. It includes a precipitation step by pH and/or temperature change. Process variables and alternatives in this step include but are not limited to, an agitated or recirculating reaction tank. Processing aids that can be used in the mineral precipitation step include but are not limited to, acids, bases, calcium hydroxide, sodium hydroxide, hydrochloric acid, sodium chloride, phytase, and combinations thereof. The pH of step 3 can be between about 2.0 and about 12.0, preferably about 8.0. The temperature can be between about 5° C. and about 90° C., preferably about 50° C. The pH hold times can vary between about 0 minutes to about 60 minutes, preferably about 10 minutes. The product of stream 3 is a suspension of purified pre-treated soy whey and precipitated minerals.

Step 4 (See FIG. 4A) the mineral removal step can start with the suspension of purified pre-treated whey and precipitated minerals from stream 3. It includes a centrifugation step. Process variables and alternatives in this step include but are not limited to, centrifugation, filtration, dead-end filtration, crossflow membrane filtration and combinations thereof. Crossflow membrane filtration includes but is not limited to: spiral-wound, plate and frame, hollow fiber, ceramic, dynamic or rotating disk, nanofiber, and combinations thereof. Products from the mineral removal step include but are not limited to a de-mineralized pre-treated whey in stream 4a (retentate) and insoluble minerals with some protein mineral complexes in stream 4b (permeate).

Step 5 (See FIG. 4B) the protein separation and concentration step can start with purified pre-treated whey from stream 4a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Embodiment 10 starts with Step 0 (See FIG. 4A) the whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kiloDalton (kD)) in stream 0a (retentate) and insoluble large molecular weight proteins (between about 300 kD and between about 50 kD) in stream 0b (permeate), such as pre-treated soy whey, storage proteins, and combinations thereof.

Step 2 (See FIG. 4A) a water and mineral removal can start with the pre-treated soy whey from stream 0b. It includes a nanofiltration step for water removal and partial mineral removal. Process variables and alternatives in this step include but are not limited to, crossflow membrane filtration, reverse osmosis, evaporation, nanofiltration, and combinations thereof. Crossflow membrane filtration includes but is not limited to: spiral-wound, plate and frame, hollow fiber, ceramic, dynamic or rotating disk, nanofiber, and combinations thereof. The pH of step 2 can be between about 2.0 and about 12.0, preferably about 5.3. The temperature can be between about 5° C. and about 90° C., preferably about 50° C. Products from this water removal step include but are not limited to purified pre-treated soy whey in stream 2a (retentate) and water, some minerals, monovalent cations and combinations thereof in stream 2b (permeate).

Step 3 (See FIG. 4A) the mineral precipitation step can start with purified pre-treated soy whey from stream 2a. It includes a precipitation step by pH and/or temperature change. Process variables and alternatives in this step include but are not limited to, an agitated or recirculating reaction tank. Processing aids that can be used in the mineral precipitation step include but are not limited to, acids, bases, calcium hydroxide, sodium hydroxide, hydrochloric acid, sodium chloride, phytase, and combinations thereof. The pH of step 3 can be between about 2.0 and about 12.0, preferably about 8.0. The temperature can be between about 5° C. and about 90° C., preferably about 50° C. The pH hold times can vary between about 0 minutes to about 60 minutes, preferably about 10 minutes. The product of stream 3 is a suspension of purified pre-treated soy whey and precipitated minerals.

Step 4 (See FIG. 4A) the mineral removal step can start with the suspension of purified pre-treated whey and precipitated minerals from stream 3. It includes a centrifugation step. Process variables and alternatives in this step include but are not limited to, centrifugation, filtration, dead-end filtration, crossflow membrane filtration and combinations thereof. Crossflow membrane filtration includes but is not limited to: spiral-wound, plate and frame, hollow fiber, ceramic, dynamic or rotating disk, nanofiber, and combinations thereof. Products from the mineral removal step include but are not limited to a de-mineralized pre-treated whey in stream 4a (retentate) and insoluble minerals with some protein mineral complexes in stream 4b (permeate).

Step 5 (See FIG. 4B) the protein separation and concentration step can start with purified pre-treated whey from stream 4a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Finally, Step 6 (See FIG. 4B) the protein washing and purification step can start with soy whey protein, BBI, KTI, storage proteins, other proteins or purified pre-treated whey from stream 5a. It includes a diafiltration step. Process variables and alternatives in this step include but are not limited to, reslurrying, crossflow membrane filtration, ultrafiltration, water diafiltration, buffer diafiltration, and combinations thereof. Crossflow membrane filtration includes but is not limited to: spiral-wound, plate and frame, hollow fiber, ceramic, dynamic or rotating disk, nanofiber, and combinations thereof. Processing aids that can be used in the protein washing and purification step include but are not limited to, water, steam, and combinations thereof. The pH of step 6 can be between about 2.0 and about 12.0, preferably about 7.0. The temperature can be between about 5° C. and about 90° C., preferably about 75° C. Products from stream 6a (retentate) include but are not limited to, soy whey protein, BBI, KTI, storage proteins, other proteins, and combinations thereof. Other proteins include but are not limited to lunasin, lectins, dehydrins, lipoxygenase, and combinations thereof. Products from stream 6b (permeate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Minerals include but are not limited to calcium citrate.

Embodiment 11 starts with Step 0 (See FIG. 4A) the whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kiloDalton (kD)) in stream 0a (retentate) and insoluble large molecular weight proteins (between about 300 kD and between about 50 kD) in stream 0b (permeate), such as pre-treated soy whey, storage proteins, and combinations thereof.

Step 2 (See FIG. 4A) a water and mineral removal can start with the pre-treated soy whey from stream 0b. It includes a nanofiltration step for water removal and partial mineral removal. Process variables and alternatives in this step include but are not limited to, crossflow membrane filtration, reverse osmosis, evaporation, nanofiltration, and combinations thereof. Crossflow membrane filtration includes but is not limited to: spiral-wound, plate and frame, hollow fiber, ceramic, dynamic or rotating disk, nanofiber, and combinations thereof. The pH of step 2 can be between about 2.0 and about 12.0, preferably about 5.3. The temperature can be between about 5° C. and about 90° C., preferably about 50° C. Products from this water removal step include but are not limited to purified pre-treated soy whey in stream 2a (retentate) and water, some minerals, monovalent cations and combinations thereof in stream 2b (permeate).

Step 3 (See FIG. 4A) the mineral precipitation step can start with purified pre-treated soy whey from stream 2a. It includes a precipitation step by pH and/or temperature change. Process variables and alternatives in this step include but are not limited to, an agitated or recirculating reaction tank. Processing aids that can be used in the mineral precipitation step include but are not limited to, acids, bases, calcium hydroxide, sodium hydroxide, hydrochloric acid, sodium chloride, phytase, and combinations thereof. The pH of step 3 can be between about 2.0 and about 12.0, preferably about 8.0. The temperature can be between about 5° C. and about 90° C., preferably about 50° C. The pH hold times can vary between about 0 minutes to about 60 minutes, preferably about 10 minutes. The product of stream 3 is a suspension of purified pre-treated soy whey and precipitated minerals.

Step 4 (See FIG. 4A)—the mineral removal step can start with the suspension of purified pre-treated whey and precipitated minerals from stream 3. It includes a centrifugation step. Process variables and alternatives in this step include but are not limited to, centrifugation, filtration, dead-end filtration, crossflow membrane filtration and combinations thereof. Crossflow membrane filtration includes but is not limited to: spiral-wound, plate and frame, hollow fiber, ceramic, dynamic or rotating disk, nanofiber, and combinations thereof. Products from the mineral removal step include but are not limited to a de-mineralized pre-treated whey in stream 4a (retentate) and insoluble minerals with some protein mineral complexes in stream 4b (permeate).

Step 5 (See FIG. 4B)—the protein separation and concentration step can start with purified pre-treated whey from stream 4a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Step 6 (See FIG. 4B) the protein washing and purification step can start with soy whey protein, BBI, KTI, storage proteins, other proteins or purified pre-treated whey from stream 5a. It includes a diafiltration step. Process variables and alternatives in this step include but are not limited to, reslurrying, crossflow membrane filtration, ultrafiltration, water diafiltration, buffer diafiltration, and combinations thereof. Crossflow membrane filtration includes but is not limited to: spiral-wound, plate and frame, hollow fiber, ceramic, dynamic or rotating disk, nanofiber, and combinations thereof. Processing aids that can be used in the protein washing and purification step include but are not limited to, water, steam, and combinations thereof. The pH of step 6 can be between about 2.0 and about 12.0, preferably about 7.0. The temperature can be between about 5° C. and about 90° C., preferably about 75° C. Products from stream 6a (retentate) include but are not limited to, soy whey protein, BBI, KTI, storage proteins, other proteins, and combinations thereof. Other proteins include but are not limited to lunasin, lectins, dehydrins, lipoxygenase, and combinations thereof. Products from stream 6b (permeate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Minerals include but are not limited to calcium citrate.

Step 16 (See FIG. 4B) a heat treatment and flash cooling step can start with soy whey protein, BBI, KTI and, other proteins from stream 6a. Other proteins include but are not limited to lunasin, lectins, dehydrins, lipoxygenase, and combinations thereof. It includes an ultra high temperature step. Process variables and alternatives in this step include but are not limited to, heat sterilization, evaporation, and combinations thereof. Processing aids that can be used in this heat treatment and flash cooling step include but are not limited to, water, steam, and combinations thereof. The temperature can be between about 129° C. and about 160° C., preferably about 152° C. Temperature hold time can be between about 8 seconds and about 15 seconds, preferably about 9 seconds. Products from stream 16 include but are not limited to, soy whey protein.

Finally, Step 17 (See FIG. 4B)—a drying step can start with soy whey protein, BBI, KTI and, other proteins from stream 16. It includes a drying step. The liquid feed temperature can be between about 50° C. and about 95° C., preferably about 82° C. The inlet temperature can be between about 175° C. and about 370° C., preferably about 290° C. The exhaust temperature can be between about 65° C. and about 98° C., preferably about 88° C. Products from stream 17a (retentate) include but are not limited to, water. Products from stream 17b (permeate) include but are not limited to, soy whey protein which includes, BBI, KTI and, other proteins. Other proteins include but are not limited to lunasin, lectins, dehydrins, lipoxygenase, and combinations thereof.

Embodiment 12 starts with Step 0 (See FIG. 4A) the whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kiloDalton (kD)) in stream 0a (retentate) and insoluble large molecular weight proteins (between about 300 kD and between about 50 kD) in stream 0b (permeate), such as pre-treated soy whey, storage proteins, and combinations thereof.

Step 2 (See FIG. 4A) a water and mineral removal can start with the purified pre-treated soy whey from stream 1b or pre-treated soy whey from stream 0b. It includes a nanofiltration step for water removal and partial mineral removal. Process variables and alternatives in this step include but are not limited to, crossflow membrane filtration, reverse osmosis, evaporation, nanofiltration, and combinations thereof. Crossflow membrane filtration includes but is not limited to: spiral-wound, plate and frame, hollow fiber, ceramic, dynamic or rotating disk, nanofiber, and combinations thereof. The pH of step 2 can be between about 2.0 and about 12.0, preferably about 5.3. The temperature can be between about 5° C. and about 90° C., preferably about 50° C. Products from this water removal step include but are not limited to purified pre-treated soy whey in stream 2a (retentate) and water, some minerals, monovalent cations and combinations thereof in stream 2b (permeate).

Step 3 (See FIG. 4A) the mineral precipitation step can start with purified pre-treated soy whey from stream 2a. It includes a precipitation step by pH and/or temperature change. Process variables and alternatives in this step include but are not limited to, an agitated or recirculating reaction tank. Processing aids that can be used in the mineral precipitation step include but are not limited to, acids, bases, calcium hydroxide, sodium hydroxide, hydrochloric acid, sodium chloride, phytase, and combinations thereof. The pH of step 3 can be between about 2.0 and about 12.0, preferably about 8.0. The temperature can be between about 5° C. and about 90° C., preferably about 50° C. The pH hold times can vary between about 0 minutes to about 60 minutes, preferably about 10 minutes. The product of stream 3 is a suspension of purified pre-treated soy whey and precipitated minerals.

Step 4 (See FIG. 4A) the mineral removal step can start with the suspension of purified pre-treated whey and precipitated minerals from stream 3. It includes a centrifugation step. Process variables and alternatives in this step include but are not limited to, centrifugation, filtration, dead-end filtration, crossflow membrane filtration and combinations thereof. Crossflow membrane filtration includes but is not limited to: spiral-wound, plate and frame, hollow fiber, ceramic, dynamic or rotating disk, nanofiber, and combinations thereof. Products from the mineral removal step include but are not limited to a de-mineralized pre-treated whey in stream 4a (retentate) and insoluble minerals with some protein mineral complexes in stream 4b (permeate).

Step 5 (See FIG. 4B) the protein separation and concentration step can start with purified pre-treated whey from stream 4a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Step 6 (See FIG. 4B) the protein washing and purification step can start with soy whey protein, BBI, KTI, storage proteins, other proteins or purified pre-treated whey from stream 5a. It includes a diafiltration step. Process variables and alternatives in this step include but are not limited to, reslurrying, crossflow membrane filtration, ultrafiltration, water diafiltration, buffer diafiltration, and combinations thereof. Crossflow membrane filtration includes but is not limited to: spiral-wound, plate and frame, hollow fiber, ceramic, dynamic or rotating disk, nanofiber, and combinations thereof. Processing aids that can be used in the protein washing and purification step include but are not limited to, water, steam, and combinations thereof. The pH of step 6 can be between about 2.0 and about 12.0, preferably about 7.0. The temperature can be between about 5° C. and about 90° C., preferably about 75° C. Products from stream 6a (retentate) include but are not limited to, soy whey protein, BBI, KTI, storage proteins, other proteins, and combinations thereof. Other proteins include but are not limited to lunasin, lectins, dehydrins, lipoxygenase, and combinations thereof. Products from stream 6b (permeate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Minerals include but are not limited to calcium citrate.

Step 15 (See FIG. 4B) a water removal step can start with soy whey protein, BBI, KTI and, other proteins from stream 6a. Other proteins include but are not limited to lunasin, lectins, dehydrins, lipoxygenase, and combinations thereof. It includes an evaporation step. Process variables and alternatives in this step include but are not limited to, evaporation, nanofiltration, RO, and combinations thereof. Products from stream 15a (retentate) include but are not limited to, water. Stream 15b (permeate) products include but are not limited to soy whey protein, BBI, KTI and, other proteins. Other proteins include but are not limited to lunasin, lectins, dehydrins, lipoxygenase, and combinations thereof.

Step 16 (See FIG. 4B) a heat treatment and flash cooling step can start with soy whey protein, BBI, KTI and, other proteins from stream 15b. Other proteins include but are not limited to lunasin, lectins, dehydrins, lipoxygenase, and combinations thereof. It includes an ultra high temperature step. Process variables and alternatives in this step include but are not limited to, heat sterilization, evaporation, and combinations thereof. Processing aids that can be used in this heat treatment and flash cooling step include but are not limited to, water, steam, and combinations thereof. The temperature can be between about 129° C. and about 160° C., preferably about 152° C. Temperature hold time can be between about 8 seconds and about 15 seconds, preferably about 9 seconds. Products from stream 16 include but are not limited to, soy whey protein.

Finally, Step 17 (See FIG. 4B) a drying step can start with soy whey protein, BBI, KTI and, other proteins from stream 16. It includes a drying step. The liquid feed temperature can be between about 50° C. and about 95° C., preferably about 82° C. The inlet temperature can be between about 175° C. and about 370° C., preferably about 290° C. The exhaust temperature can be between about 65° C. and about 98° C., preferably about 88° C. Products from stream 17a (retentate) include but are not limited to, water. Products from stream 17b (permeate) include but are not limited to, soy whey protein which includes, BBI, KTI and, other proteins. Other proteins include but are not limited to lunasin, lectins, dehydrins, lipoxygenase, and combinations thereof.

Embodiment 13 starts with Step 0 (See FIG. 4A) the whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kiloDalton (kD)) in stream 0a (retentate) and insoluble large molecular weight proteins (between about 300 kD and between about 50 kD) in stream 0b (permeate), such as pre-treated soy whey, storage proteins, and combinations thereof.

Step 3 (See FIG. 4A) the mineral precipitation step can start with pre-treated soy whey from stream 0a. It includes a precipitation step by pH and/or temperature change. Process variables and alternatives in this step include but are not limited to, an agitated or recirculating reaction tank. Processing aids that can be used in the mineral precipitation step include but are not limited to, acids, bases, calcium hydroxide, sodium hydroxide, hydrochloric acid, sodium chloride, phytase, and combinations thereof. The pH of step 3 can be between about 2.0 and about 12.0, preferably about 8.0. The temperature can be between about 5° C. and about 90° C., preferably about 50° C. The pH hold times can vary between about 0 minutes to about 60 minutes, preferably about 10 minutes. The product of stream 3 is a suspension of purified pre-treated soy whey and precipitated minerals.

Step 4 (See FIG. 4A) the mineral removal step can start with the suspension of purified pre-treated whey and precipitated minerals from stream 3. It includes a centrifugation step. Process variables and alternatives in this step include but are not limited to, centrifugation, filtration, dead-end filtration, crossflow membrane filtration and combinations thereof. Crossflow membrane filtration includes but is not limited to: spiral-wound, plate and frame, hollow fiber, ceramic, dynamic or rotating disk, nanofiber, and combinations thereof. Products from the mineral removal step include but are not limited to a de-mineralized pre-treated whey in stream 4a (retentate) and insoluble minerals with some protein mineral complexes in stream 4b (permeate).

Step 2 (See FIG. 4A) a water and mineral removal can start with the purified pre-treated soy whey from stream 1b or pre-treated soy whey from stream 0b. It includes a nanofiltration step for water removal and partial mineral removal. Process variables and alternatives in this step include but are not limited to, crossflow membrane filtration, reverse osmosis, evaporation, nanofiltration, and combinations thereof. Crossflow membrane filtration includes but is not limited to: spiral-wound, plate and frame, hollow fiber, ceramic, dynamic or rotating disk, nanofiber, and combinations thereof. The pH of step 2 can be between about 2.0 and about 12.0, preferably about 5.3. The temperature can be between about 5° C. and about 90° C., preferably about 50° C. Products from this water removal step include but are not limited to purified pre-treated soy whey in stream 2a (retentate) and water, some minerals, monovalent cations and combinations thereof in stream 2b (permeate).

Finally, Step 5 (See FIG. 4B) the protein separation and concentration step can start with the whey from stream 2a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Embodiment 14 starts with Step 0 (See FIG. 4A) the whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kiloDalton (kD)) in stream 0a (retentate) and insoluble large molecular weight proteins (between about 300 kD and between about 50 kD) in stream 0b (permeate), such as pre-treated soy whey, storage proteins, and combinations thereof.

Step 3 (See FIG. 4A) the mineral precipitation step can start with pretreated soy whey from stream 0a. It includes a precipitation step by pH and/or temperature change. Process variables and alternatives in this step include but are not limited to, an agitated or recirculating reaction tank. Processing aids that can be used in the mineral precipitation step include but are not limited to, acids, bases, calcium hydroxide, sodium hydroxide, hydrochloric acid, sodium chloride, phytase, and combinations thereof. The pH of step 3 can be between about 2.0 and about 12.0, preferably about 8.0. The temperature can be between about 5° C. and about 90° C., preferably about 50° C. The pH hold times can vary between about 0 minutes to about 60 minutes, preferably about 10 minutes. The product of stream 3 is a suspension of purified pre-treated soy whey and precipitated minerals.

Step 4 (See FIG. 4A) the mineral removal step can start with the suspension of purified pre-treated whey and precipitated minerals from stream 3. It includes a centrifugation step. Process variables and alternatives in this step include but are not limited to, centrifugation, filtration, dead-end filtration, crossflow membrane filtration and combinations thereof. Crossflow membrane filtration includes but is not limited to: spiral-wound, plate and frame, hollow fiber, ceramic, dynamic or rotating disk, nanofiber, and combinations thereof. Products from the mineral removal step include but are not limited to a de-mineralized pre-treated whey in stream 4a (retentate) and insoluble minerals with some protein mineral complexes in stream 4b (permeate).

Step 2 (See FIG. 4A) a water and mineral removal can start with the purified pre-treated soy whey from stream 4a. It includes a nanofiltration step for water removal and partial mineral removal. Process variables and alternatives in this step include but are not limited to, crossflow membrane filtration, reverse osmosis, evaporation, nanofiltration, and combinations thereof. Crossflow membrane filtration includes but is not limited to: spiral-wound, plate and frame, hollow fiber, ceramic, dynamic or rotating disk, nanofiber, and combinations thereof. The pH of step 2 can be between about 2.0 and about 12.0, preferably about 5.3. The temperature can be between about 5° C. and about 90° C., preferably about 50° C. Products from this water removal step include but are not limited to purified pre-treated soy whey in stream 2a (retentate) and water, some minerals, monovalent cations and combinations thereof in stream 2b (permeate).

Step 5 (See FIG. 4B) the protein separation and concentration step can start with the whey from stream 2a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Finally, Step 6 (See FIG. 4B) the protein washing and purification step can start with soy whey protein, BBI, KTI, storage proteins, other proteins or purified pre-treated whey from stream 5a. It includes a diafiltration step. Process variables and alternatives in this step include but are not limited to, reslurrying, crossflow membrane filtration, ultrafiltration, water diafiltration, buffer diafiltration, and combinations thereof. Crossflow membrane filtration includes but is not limited to: spiral-wound, plate and frame, hollow fiber, ceramic, dynamic or rotating disk, nanofiber, and combinations thereof. Processing aids that can be used in the protein washing and purification step include but are not limited to, water, steam, and combinations thereof. The pH of step 6 can be between about 2.0 and about 12.0, preferably about 7.0. The temperature can be between about 5° C. and about 90° C., preferably about 75° C. Products from stream 6a (retentate) include but are not limited to, soy whey protein, BBI, KTI, storage proteins, other proteins, and combinations thereof. Other proteins include but are not limited to lunasin, lectins, dehydrins, lipoxygenase, and combinations thereof. Products from stream 6b (permeate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Minerals include but are not limited to calcium citrate.

Embodiment 15 starts with Step 0 (See FIG. 4A) the whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kiloDalton (kD)) in stream 0a (retentate) and insoluble large molecular weight proteins (between about 300 kD and between about 50 kD) in stream 0b (permeate), such as pre-treated soy whey, storage proteins, and combinations thereof.

Step 3 (See FIG. 4A) the mineral precipitation step can start with pretreated soy whey from stream 0a. It includes a precipitation step by pH and/or temperature change. Process variables and alternatives in this step include but are not limited to, an agitated or recirculating reaction tank. Processing aids that can be used in the mineral precipitation step include but are not limited to, acids, bases, calcium hydroxide, sodium hydroxide, hydrochloric acid, sodium chloride, phytase, and combinations thereof. The pH of step 3 can be between about 2.0 and about 12.0, preferably about 8.0. The temperature can be between about 5° C. and about 90° C., preferably about 50° C. The pH hold times can vary between about 0 minutes to about 60 minutes, preferably about 10 minutes. The product of stream 3 is a suspension of purified pre-treated soy whey and precipitated minerals.

Step 4 (See FIG. 4A) the mineral removal step can start with the suspension of purified pre-treated whey and precipitated minerals from stream 3. It includes a centrifugation step. Process variables and alternatives in this step include but are not limited to, centrifugation, filtration, dead-end filtration, crossflow membrane filtration and combinations thereof. Crossflow membrane filtration includes but is not limited to: spiral-wound, plate and frame, hollow fiber, ceramic, dynamic or rotating disk, nanofiber, and combinations thereof. Products from the mineral removal step include but are not limited to a de-mineralized pre-treated whey in stream 4a (retentate) and insoluble minerals with some protein mineral complexes in stream 4b (permeate).

Step 2 (See FIG. 4A) a water and mineral removal can start with the purified pre-treated soy whey from stream 1b or pre-treated soy whey from stream 0b. It includes a nanofiltration step for water removal and partial mineral removal. Process variables and alternatives in this step include but are not limited to, crossflow membrane filtration, reverse osmosis, evaporation, nanofiltration, and combinations thereof. Crossflow membrane filtration includes but is not limited to: spiral-wound, plate and frame, hollow fiber, ceramic, dynamic or rotating disk, nanofiber, and combinations thereof. The pH of step 2 can be between about 2.0 and about 12.0, preferably about 5.3. The temperature can be between about 5° C. and about 90° C., preferably about 50° C. Products from this water removal step include but are not limited to purified pre-treated soy whey in stream 2a (retentate) and water, some minerals, monovalent cations and combinations thereof in stream 2b (permeate).

Step 5 (See FIG. 4B) the protein separation and concentration step can start with the whey from stream 2a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Step 6 (See FIG. 4B) the protein washing and purification step can start with soy whey protein, BBI, KTI, storage proteins, other proteins or purified pre-treated whey from stream 5a. It includes a diafiltration step. Process variables and alternatives in this step include but are not limited to, reslurrying, crossflow membrane filtration, ultrafiltration, water diafiltration, buffer diafiltration, and combinations thereof. Crossflow membrane filtration includes but is not limited to: spiral-wound, plate and frame, hollow fiber, ceramic, dynamic or rotating disk, nanofiber, and combinations thereof. Processing aids that can be used in the protein washing and purification step include but are not limited to, water, steam, and combinations thereof. The pH of step 6 can be between about 2.0 and about 12.0, preferably about 7.0. The temperature can be between about 5° C. and about 90° C., preferably about 75° C. Products from stream 6a (retentate) include but are not limited to, soy whey protein, BBI, KTI, storage proteins, other proteins, and combinations thereof. Other proteins include but are not limited to lunasin, lectins, dehydrins, lipoxygenase, and combinations thereof. Products from stream 6b (permeate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Minerals include but are not limited to calcium citrate.

Step 16 (See FIG. 4B) a heat treatment and flash cooling step can start with soy whey protein, BBI, KTI and, other proteins from stream 6a. Other proteins include but are not limited to lunasin, lectins, dehydrins, lipoxygenase, and combinations thereof. It includes an ultra high temperature step. Process variables and alternatives in this step include but are not limited to, heat sterilization, evaporation, and combinations thereof. Processing aids that can be used in this heat treatment and flash cooling step include but are not limited to, water, steam, and combinations thereof. The temperature can be between about 129° C. and about 160° C., preferably about 152° C. Temperature hold time can be between about 8 seconds and about 15 seconds, preferably about 9 seconds. Products from stream 16 include but are not limited to, soy whey protein.

Finally, Step 17 (See FIG. 4B) a drying step can start with soy whey protein, BBI, KTI and, other proteins from stream 16. It includes a drying step. The liquid feed temperature can be between about 50° C. and about 95° C., preferably about 82° C. The inlet temperature can be between about 175° C. and about 370° C., preferably about 290° C. The exhaust temperature can be between about 65° C. and about 98° C., preferably about 88° C. Products from stream 17a (retentate) include but are not limited to, water. Products from stream 17b (permeate) include but are not limited to, soy whey protein which includes, BBI, KTI and, other proteins. Other proteins include but are not limited to lunasin, lectins, dehydrins, lipoxygenase, and combinations thereof.

Embodiment 16 starts with Step 0 (See FIG. 4A) the whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kiloDalton (kD)) in stream 0a (retentate) and insoluble large molecular weight proteins (between about 300 kD and between about 50 kD) in stream 0b (permeate), such as pre-treated soy whey, storage proteins, and combinations thereof.

Step 3 (See FIG. 4A) the mineral precipitation step can start with pretreated soy whey from stream 0a. It includes a precipitation step by pH and/or temperature change. Process variables and alternatives in this step include but are not limited to, an agitated or recirculating reaction tank. Processing aids that can be used in the mineral precipitation step include but are not limited to, acids, bases, calcium hydroxide, sodium hydroxide, hydrochloric acid, sodium chloride, phytase, and combinations thereof. The pH of step 3 can be between about 2.0 and about 12.0, preferably about 8.0. The temperature can be between about 5° C. and about 90° C., preferably about 50° C. The pH hold times can vary between about 0 minutes to about 60 minutes, preferably about 10 minutes. The product of stream 3 is a suspension of purified pre-treated soy whey and precipitated minerals.

Step 4 (See FIG. 4A) the mineral removal step can start with the suspension of purified pre-treated whey and precipitated minerals from stream 3. It includes a centrifugation step. Process variables and alternatives in this step include but are not limited to, centrifugation, filtration, dead-end filtration, crossflow membrane filtration and combinations thereof. Crossflow membrane filtration includes but is not limited to: spiral-wound, plate and frame, hollow fiber, ceramic, dynamic or rotating disk, nanofiber, and combinations thereof. Products from the mineral removal step include but are not limited to a de-mineralized pre-treated whey in stream 4a (retentate) and insoluble minerals with some protein mineral complexes in stream 4b (permeate).

Step 2 (See FIG. 4A) a water and mineral removal can start with the purified pre-treated soy whey from stream 4a. It includes a nanofiltration step for water removal and partial mineral removal. Process variables and alternatives in this step include but are not limited to, crossflow membrane filtration, reverse osmosis, evaporation, nanofiltration, and combinations thereof. Crossflow membrane filtration includes but is not limited to: spiral-wound, plate and frame, hollow fiber, ceramic, dynamic or rotating disk, nanofiber, and combinations thereof. The pH of step 2 can be between about 2.0 and about 12.0, preferably about 5.3. The temperature can be between about 5° C. and about 90° C., preferably about 50° C. Products from this water removal step include but are not limited to purified pre-treated soy whey in stream 2a (retentate) and water, some minerals, monovalent cations and combinations thereof in stream 2b (permeate).

Step 5 (See FIG. 4B) the protein separation and concentration step can start with the whey from stream 2a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Step 6 (See FIG. 4B) the protein washing and purification step can start with soy whey protein, BBI, KTI, storage proteins, other proteins or purified pre-treated whey from stream 5a. It includes a diafiltration step. Process variables and alternatives in this step include but are not limited to, reslurrying, crossflow membrane filtration, ultrafiltration, water diafiltration, buffer diafiltration, and combinations thereof. Crossflow membrane filtration includes but is not limited to: spiral-wound, plate and frame, hollow fiber, ceramic, dynamic or rotating disk, nanofiber, and combinations thereof. Processing aids that can be used in the protein washing and purification step include but are not limited to, water, steam, and combinations thereof. The pH of step 6 can be between about 2.0 and about 12.0, preferably about 7.0. The temperature can be between about 5° C. and about 90° C., preferably about 75° C. Products from stream 6a (retentate) include but are not limited to, soy whey protein, BBI, KTI, storage proteins, other proteins, and combinations thereof. Other proteins include but are not limited to lunasin, lectins, dehydrins, lipoxygenase, and combinations thereof. Products from stream 6b (permeate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Minerals include but are not limited to calcium citrate.

Step 15 (See FIG. 4B) a water removal step can start with soy whey protein, BBI, KTI and, other proteins from stream 6a. Other proteins include but are not limited to lunasin, lectins, dehydrins, lipoxygenase, and combinations thereof. It includes an evaporation step. Process variables and alternatives in this step include but are not limited to, evaporation, nanofiltration, RO, and combinations thereof. Products from stream 15a (retentate) include but are not limited to, water. Stream 15b (permeate) products include but are not limited to soy whey protein, BBI, KTI and, other proteins. Other proteins include but are not limited to lunasin, lectins, dehydrins, lipoxygenase, and combinations thereof.

Step 16 (See FIG. 4B) a heat treatment and flash cooling step can start with soy whey protein, BBI, KTI and, other proteins from stream 15b. Other proteins include but are not limited to lunasin, lectins, dehydrins, lipoxygenase, and combinations thereof. It includes an ultra high temperature step. Process variables and alternatives in this step include but are not limited to, heat sterilization, evaporation, and combinations thereof. Processing aids that can be used in this heat treatment and flash cooling step include but are not limited to, water, steam, and combinations thereof. The temperature can be between about 129° C. and about 160° C., preferably about 152° C. Temperature hold time can be between about 8 seconds and about 15 seconds, preferably about 9 seconds. Products from stream 16 include but are not limited to, soy whey protein.

Finally, Step 17 (See FIG. 4B) a drying step can start with soy whey protein, BBI, KTI and, other proteins from stream 16. It includes a drying step. The liquid feed temperature can be between about 50° C. and about 95° C., preferably about 82° C. The inlet temperature can be between about 175° C. and about 370° C., preferably about 290° C. The exhaust temperature can be between about 65° C. and about 98° C., preferably about 88° C. Products from stream 17a (retentate) include but are not limited to, water. Products from stream 17b (permeate) include but are not limited to, soy whey protein which includes, BBI, KTI and, other proteins. Other proteins include but are not limited to lunasin, lectins, dehydrins, lipoxygenase, and combinations thereof.

Embodiment 17 starts with Step 0 (See FIG. 4A) the whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kiloDalton (kD)) in stream 0a (retentate) and insoluble large molecular weight proteins (between about 300 kD and between about 50 kD) in stream 0b (permeate), such as pre-treated soy whey, storage proteins, and combinations thereof.

Step 1 (See FIG. 4A) Microbiology reduction can start with the product of the whey protein pretreatment step, including but not limited to pre-treated soy whey. This step involves microfiltration of the pre-treated soy whey. Process variables and alternatives in this step include but are not limited to, centrifugation, dead-end filtration, heat sterilization, ultraviolet sterilization, microfiltration, crossflow membrane filtration, and combinations thereof. Crossflow membrane filtration includes but is not limited to: spiral-wound, plate and frame, hollow fiber, ceramic, dynamic or rotating disk, nanofiber, and combinations thereof. The pH of step 1 can be between about 2.0 and about 12.0, preferably about 5.3. The temperature can be between about 5° C. and about 90° C., preferably about 50° C. Products from step 1 include but are not limited to storage proteins, microorganisms, silicon, and combinations thereof in stream 1a (retentate) and purified pre-treated soy whey in stream 1b (permeate).

Step 3 (See FIG. 4A) the mineral precipitation step can start with pretreated soy whey from stream 1 b. It includes a precipitation step by pH and/or temperature change. Process variables and alternatives in this step include but are not limited to, an agitated or recirculating reaction tank. Processing aids that can be used in the mineral precipitation step include but are not limited to, acids, bases, calcium hydroxide, sodium hydroxide, hydrochloric acid, sodium chloride, phytase, and combinations thereof. The pH of step 3 can be between about 2.0 and about 12.0, preferably about 8.0. The temperature can be between about 5° C. and about 90° C., preferably about 50° C. The pH hold times can vary between about 0 minutes to about 60 minutes, preferably about 10 minutes. The product of stream 3 is a suspension of purified pre-treated soy whey and precipitated minerals.

Step 4 (See FIG. 4A) the mineral removal step can start with the suspension of purified pre-treated whey and precipitated minerals from stream 3. It includes a centrifugation step. Process variables and alternatives in this step include but are not limited to, centrifugation, filtration, dead-end filtration, crossflow membrane filtration and combinations thereof. Crossflow membrane filtration includes but is not limited to: spiral-wound, plate and frame, hollow fiber, ceramic, dynamic or rotating disk, nanofiber, and combinations thereof. Products from the mineral removal step include but are not limited to a de-mineralized pre-treated whey in stream 4a (retentate) and insoluble minerals with some protein mineral complexes in stream 4b (permeate).

Step 2 (See FIG. 4A)—A water and mineral removal can start with the purified pre-treated soy whey from stream 4a. It includes a nanofiltration step for water removal and partial mineral removal. Process variables and alternatives in this step include but are not limited to, crossflow membrane filtration, reverse osmosis, evaporation, nanofiltration, and combinations thereof. Crossflow membrane filtration includes but is not limited to: spiral-wound, plate and frame, hollow fiber, ceramic, dynamic or rotating disk, nanofiber, and combinations thereof. The pH of step 2 can be between about 2.0 and about 12.0, preferably about 5.3. The temperature can be between about 5° C. and about 90° C., preferably about 50° C. Products from this water removal step include but are not limited to purified pre-treated soy whey in stream 2a (retentate) and water, some minerals, monovalent cations and combinations thereof in stream 2b (permeate).

Step 5 (See FIG. 4B) the protein separation and concentration step can start with the whey from stream 2a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Step 6 (See FIG. 4B) the protein washing and purification step can start with soy whey protein, BBI, KTI, storage proteins, other proteins or purified pre-treated whey from stream 5a. It includes a diafiltration step. Process variables and alternatives in this step include but are not limited to, reslurrying, crossflow membrane filtration, ultrafiltration, water diafiltration, buffer diafiltration, and combinations thereof. Crossflow membrane filtration includes but is not limited to: spiral-wound, plate and frame, hollow fiber, ceramic, dynamic or rotating disk, nanofiber, and combinations thereof. Processing aids that can be used in the protein washing and purification step include but are not limited to, water, steam, and combinations thereof. The pH of step 6 can be between about 2.0 and about 12.0, preferably about 7.0. The temperature can be between about 5° C. and about 90° C., preferably about 75° C. Products from stream 6a (retentate) include but are not limited to, soy whey protein, BBI, KTI, storage proteins, other proteins, and combinations thereof. Other proteins include but are not limited to lunasin, lectins, dehydrins, lipoxygenase, and combinations thereof. Products from stream 6b (permeate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Minerals include but are not limited to calcium citrate.

Step 15 (See FIG. 4B) a water removal step can start with soy whey protein, BBI, KTI and, other proteins from stream 6a. Other proteins include but are not limited to lunasin, lectins, dehydrins, lipoxygenase, and combinations thereof. It includes an evaporation step. Process variables and alternatives in this step include but are not limited to, evaporation, nanofiltration, reverse osmosis, and combinations thereof. Products from stream 15a (retentate) include but are not limited to, water. Stream 15b (permeate) products include but are not limited to soy whey protein, BBI, KTI and, other proteins. Other proteins include but are not limited to lunasin, lectins, dehydrins, lipoxygenase, and combinations thereof.

Step 16 (See FIG. 4B) a heat treatment and flash cooling step can start with soy whey protein, BBI, KTI and, other proteins from stream 15b. Other proteins include but are not limited to lunasin, lectins, dehydrins, lipoxygenase, and combinations thereof. It includes an ultra high temperature step. Process variables and alternatives in this step include but are not limited to, heat sterilization, evaporation, and combinations thereof. Processing aids that can be used in this heat treatment and flash cooling step include but are not limited to, water, steam, and combinations thereof. The temperature can be between about 129° C. and about 160° C., preferably about 152° C. Temperature hold time can be between about 8 seconds and about 15 seconds, preferably about 9 seconds. Products from stream 16 include but are not limited to, soy whey protein.

Finally, Step 17 (See FIG. 4B) a drying step can start with soy whey protein, BBI, KTI and, other proteins from stream 16. It includes a drying step. The liquid feed temperature can be between about 50° C. and about 95° C., preferably about 82° C. The inlet temperature can be between about 175° C. and about 370° C., preferably about 290° C. The exhaust temperature can be between about 65° C. and about 98° C., preferably about 88° C. Products from stream 17a (retentate) include but are not limited to, water. Products from stream 17b (permeate) include but are not limited to, soy whey protein which includes, BBI, KTI and, other proteins. Other proteins include but are not limited to lunasin, lectins, dehydrins, lipoxygenase, and combinations thereof.

Embodiment 18 starts with Step 0 (See FIG. 4A) the whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kiloDalton (kD)) in stream 0a (retentate) and insoluble large molecular weight proteins (between about 300 kD and between about 50 kD) in stream 0b (permeate), such as pre-treated soy whey, storage proteins, and combinations thereof.

Step 1 (See FIG. 4A) Microbiology reduction can start with the product of the whey protein pretreatment step, including but not limited to pre-treated soy whey. This step involves microfiltration of the pre-treated soy whey. Process variables and alternatives in this step include but are not limited to, centrifugation, dead-end filtration, heat sterilization, ultraviolet sterilization, microfiltration, crossflow membrane filtration, and combinations thereof. Crossflow membrane filtration includes but is not limited to: spiral-wound, plate and frame, hollow fiber, ceramic, dynamic or rotating disk, nanofiber, and combinations thereof. The pH of step 1 can be between about 2.0 and about 12.0, preferably about 5.3. The temperature can be between about 5° C. and about 90° C., preferably about 50° C. Products from step 1 include but are not limited to storage proteins, microorganisms, silicon, and combinations thereof in stream 1a (retentate) and purified pre-treated soy whey in stream 1b (permeate).

Step 2 (See FIG. 4A) a water and mineral removal can start with the purified pre-treated soy whey from stream 1 b. It includes a nanofiltration step for water removal and partial mineral removal. Process variables and alternatives in this step include but are not limited to, crossflow membrane filtration, reverse osmosis, evaporation, nanofiltration, and combinations thereof. Crossflow membrane filtration includes but is not limited to: spiral-wound, plate and frame, hollow fiber, ceramic, dynamic or rotating disk, nanofiber, and combinations thereof. The pH of step 2 can be between about 2.0 and about 12.0, preferably about 5.3. The temperature can be between about 5° C. and about 90° C., preferably about 50° C. Products from this water removal step include but are not limited to purified pre-treated soy whey in stream 2a (retentate) and water, some minerals, monovalent cations and combinations thereof in stream 2b (permeate).

Step 3 (See FIG. 4A) the mineral precipitation step can start with purified pre-treated soy whey from stream 2a. It includes a precipitation step by pH and/or temperature change. Process variables and alternatives in this step include but are not limited to, an agitated or recirculating reaction tank. Processing aids that can be used in the mineral precipitation step include but are not limited to, acids, bases, calcium hydroxide, sodium hydroxide, hydrochloric acid, sodium chloride, phytase, and combinations thereof. The pH of step 3 can be between about 2.0 and about 12.0, preferably about 8.0. The temperature can be between about 5° C. and about 90° C., preferably about 50° C. The pH hold times can vary between about 0 minutes to about 60 minutes, preferably about 10 minutes. The product of stream 3 is a suspension of purified pre-treated soy whey and precipitated minerals.

Step 4 (See FIG. 4A)—the mineral removal step can start with the suspension of purified pre-treated whey and precipitated minerals from stream 3. It includes a centrifugation step. Process variables and alternatives in this step include but are not limited to, centrifugation, filtration, dead-end filtration, crossflow membrane filtration and combinations thereof. Crossflow membrane filtration includes but is not limited to: spiral-wound, plate and frame, hollow fiber, ceramic, dynamic or rotating disk, nanofiber, and combinations thereof. Products from the mineral removal step include but are not limited to a de-mineralized pre-treated whey in stream 4a (retentate) and insoluble minerals with some protein mineral complexes in stream 4b (permeate).

Step 5 (See FIG. 4B) the protein separation and concentration step can start with purified pre-treated whey from stream 4a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Step 6 (See FIG. 4B) the protein washing and purification step can start with soy whey protein, BBI, KTI, storage proteins, other proteins or purified pre-treated whey from stream 5a. It includes a diafiltration step. Process variables and alternatives in this step include but are not limited to, reslurrying, crossflow membrane filtration, ultrafiltration, water diafiltration, buffer diafiltration, and combinations thereof. Crossflow membrane filtration includes but is not limited to: spiral-wound, plate and frame, hollow fiber, ceramic, dynamic or rotating disk, nanofiber, and combinations thereof. Processing aids that can be used in the protein washing and purification step include but are not limited to, water, steam, and combinations thereof. The pH of step 6 can be between about 2.0 and about 12.0, preferably about 7.0. The temperature can be between about 5° C. and about 90° C., preferably about 75° C. Products from stream 6a (retentate) include but are not limited to, soy whey protein, BBI, KTI, storage proteins, other proteins, and combinations thereof. Other proteins include but are not limited to lunasin, lectins, dehydrins, lipoxygenase, and combinations thereof. Products from stream 6b (permeate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Minerals include but are not limited to calcium citrate.

Step 15 (See FIG. 4B) a water removal step can start with soy whey protein, BBI, KTI and, other proteins from stream 6a. Other proteins include but are not limited to lunasin, lectins, dehydrins, lipoxygenase, and combinations thereof. It includes an evaporation step. Process variables and alternatives in this step include but are not limited to, evaporation, nanofiltration, reverse osmosis, and combinations thereof. Products from stream 15a (retentate) include but are not limited to, water. Stream 15b (permeate) products include but are not limited to soy whey protein, BBI, KTI and, other proteins. Other proteins include but are not limited to lunasin, lectins, dehydrins, lipoxygenase, and combinations thereof.

Step 16 (See FIG. 4B) a heat treatment and flash cooling step can start with soy whey protein, BBI, KTI and, other proteins from stream 15b. Other proteins include but are not limited to lunasin, lectins, dehydrins, lipoxygenase, and combinations thereof. It includes an ultra high temperature step. Process variables and alternatives in this step include but are not limited to, heat sterilization, evaporation, and combinations thereof. Processing aids that can be used in this heat treatment and flash cooling step include but are not limited to, water, steam, and combinations thereof. The temperature can be between about 129° C. and about 160° C., preferably about 152° C. Temperature hold time can be between about 8 seconds and about 15 seconds, preferably about 9 seconds. Products from stream 16 include but are not limited to, soy whey protein.

Finally, Step 17 (See FIG. 4B) a drying step can start with soy whey protein, BBI, KTI and, other proteins from stream 16. It includes a drying step. The liquid feed temperature can be between about 50° C. and about 95° C., preferably about 82° C. The inlet temperature can be between about 175° C. and about 370° C., preferably about 290° C. The exhaust temperature can be between about 65° C. and about 98° C., preferably about 88° C. Products from stream 17a (retentate) include but are not limited to, water. Products from stream 17b (permeate) include but are not limited to, soy whey protein which includes, BBI, KTI and, other proteins. Other proteins include but are not limited to lunasin, lectins, dehydrins, lipoxygenase, and combinations thereof.

### E. Embodiments Directed to Recovery of Sugars

Embodiment 19 encompasses Step 7 (See FIG. 4C) a water removal step can start with peptides, soy oligosaccharides, water, minerals, and combinations thereof from stream 5b and/or stream 6b. Soy oligosaccharides include but are not limited to sucrose, raffinose, stachyose, verbascose, monosaccharides, and combinations thereof. It includes a nanofiltration step. Process variables and alternatives in this step include but are not limited to, reverse osmosis, evaporation, nanofiltration, water diafiltration, buffer diafiltration, and combinations thereof. The pH of step 7 can be between about 2.0 and about 12.0, preferably about 7.0. The temperature can be between about 5° C. and about 90° C., preferably about 50° C. Products from stream 7a (retentate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Products from stream 7b (permeate) include but are not limited to, water, minerals, and combinations thereof.

Embodiment 20 starts with Step 7 (See FIG. 4C) a water removal step can start with peptides, soy oligosaccharides, water, minerals, and combinations thereof from stream 5b and/or stream 6b. Soy oligosaccharides include but are not limited to sucrose, raffinose, stachyose, verbascose, monosaccharides, and combinations thereof. It includes a nanofiltration step. Process variables and alternatives in this step include but are not limited to, reverse osmosis, evaporation, nanofiltration, water diafiltration, buffer diafiltration, and combinations thereof. The pH of step 7 can be between about 2.0 and about 12.0, preferably about 7.0. The temperature can be between about 5° C. and about 90° C., preferably about 50° C. Products from stream 7a (retentate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Products from stream 7b (permeate) include but are not limited to, water, minerals, and combinations thereof.

Finally, Step 11 (See FIG. 4C) a water removal step can start with soy oligosaccharides such as, raffinose, stachyose, verbascose, and combinations thereof from stream 7a. It includes an evaporation step. Process variables and alternatives in this step include but are not limited to, evaporation, reverse osmosis, nanofiltration, and combinations thereof. Processing aids that can be used in this water removal step include but are not limited to, defoamer, steam, vacuum, and combinations thereof. The temperature can be between about 5° C. and about 90° C., preferably about 60° C. Products from stream 11a (retentate) include but are not limited to, water. Products from stream 11 b (permeate) include but are not limited to, soy oligosaccharides, such as, raffinose, stachyose, verbascose, and combinations thereof.

Embodiment 21 starts with Step 7 (See FIG. 4C) a water removal step can start with peptides, soy oligosaccharides, water, minerals, and combinations thereof from stream 5b and/or stream 6b. Soy oligosaccharides include but are not limited to sucrose, raffinose, stachyose, verbascose, monosaccharides, and combinations thereof. It includes a nanofiltration step. Process variables and alternatives in this step include but are not limited to, reverse osmosis, evaporation, nanofiltration, water diafiltration, buffer diafiltration, and combinations thereof. The pH of step 7 can be between about 2.0 and about 12.0, preferably about 7.0. The temperature can be between about 5° C. and about 90° C., preferably about 50° C. Products from stream 7a (retentate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Products from stream 7b (permeate) include but are not limited to, water, minerals, and combinations thereof.

Finally, Step 8 (See FIG. 4C) a mineral removal step can start with peptides, soy oligosaccharides, water, minerals, and combinations thereof from stream 7a. Soy oligosaccharides include but are not limited to sucrose, raffinose, stachyose, verbascose, monosaccharides, and combinations thereof. It includes an electrodialysis membrane step. Process variables and alternatives in this step include but are not limited to, ion exchange columns, chromatography, and combinations thereof. Processing aids that can be used in this mineral removal step include but are not limited to, water, enzymes, and combinations thereof. Enzymes include but are not limited to protease, phytase, and combinations thereof. The pH of step 8 can be between about 2.0 and about 12.0, preferably about 7.0. The temperature can be between about 5° C. and about 90° C., preferably about 40° C. Products from stream 8a (retentate) include but are not limited to, de-mineralized soy oligosaccharides with conductivity between about 10 milli Siemens (mS) and about 0.5 mS, preferably about 2 mS, and combinations thereof. Soy oligosaccharides include but are not limited to sucrose, raffinose, stachyose, verbascose, monosaccharides, and combinations thereof. Products from stream 8b include but are not limited to, minerals, water, and combinations thereof.

Embodiment 22 starts with Step 7 (See FIG. 4C) a water removal step can start with peptides, soy oligosaccharides, water, minerals, and combinations thereof from stream 5b and/or stream 6b. Soy oligosaccharides include but are not limited to sucrose, raffinose, stachyose, verbascose, monosaccharides, and combinations thereof. It includes a nanofiltration step. Process variables and alternatives in this step include but are not limited to, reverse osmosis, evaporation, nanofiltration, water diafiltration, buffer diafiltration, and combinations thereof. The pH of step 7 can be between about 2.0 and about 12.0, preferably about 7.0. The temperature can be between about 5° C. and about 90° C., preferably about 50° C. Products from stream 7a (retentate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Products from stream 7b (permeate) include but are not limited to, water, minerals, and combinations thereof.

Step 8 (See FIG. 4C) a mineral removal step can start with peptides, soy oligosaccharides, water, minerals, and combinations thereof from stream 7a. Soy oligosaccharides include but are not limited to sucrose, raffinose, stachyose, verbascose, monosaccharides, and combinations thereof. It includes an electrodialysis membrane step. Process variables and alternatives in this step include but are not limited to, ion exchange columns, chromatography, and combinations thereof. Processing aids that can be used in this mineral removal step include but are not limited to, water, enzymes, and combinations thereof. Enzymes include but are not limited to protease, phytase, and combinations thereof. The pH of step 8 can be between about 2.0 and about 12.0, preferably about 7.0. The temperature can be between about 5° C. and about 90° C., preferably about 40° C. Products from stream 8a (retentate) include but are not limited to, de-mineralized soy oligosaccharides with conductivity between about 10 milli Siemens (mS) and about 0.5 mS, preferably about 2 mS, and combinations thereof. Soy oligosaccharides include but are not limited to sucrose, raffinose, stachyose, verbascose, monosaccharides, and combinations thereof. Products from stream 8b include but are not limited to, minerals, water, and combinations thereof.

Finally, Step 11 (See FIG. 4C) a water removal step can start with soy oligosaccharides such as, raffinose, stachyose, verbascose, and combinations thereof from stream 8a. It includes an evaporation step. Process variables and alternatives in this step include but are not limited to, evaporation, reverse osmosis, nanofiltration, and combinations thereof. Processing aids that can be used in this water removal step include but are not limited to, defoamer, steam, vacuum, and combinations thereof. The temperature can be between about 5° C. and about 90° C., preferably about 60° C. Products from stream 11a (retentate) include but are not limited to, water. Products from stream 11 b (permeate) include but are not limited to, soy oligosaccharides, such as, raffinose, stachyose, verbascose, and combinations thereof.

Embodiment 23 starts with Step 7 (See FIG. 4C) a water removal step can start with peptides, soy oligosaccharides, water, minerals, and combinations thereof from stream 5b and/or stream 6b. Soy oligosaccharides include but are not limited to sucrose, raffinose, stachyose, verbascose, monosaccharides, and combinations thereof. It includes a nanofiltration step. Process variables and alternatives in this step include but are not limited to, reverse osmosis, evaporation, nanofiltration, water diafiltration, buffer diafiltration, and combinations thereof. The pH of step 7 can be between about 2.0 and about 12.0, preferably about 7.0. The temperature can be between about 5° C. and about 90° C., preferably about 50° C. Products from stream 7a (retentate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Products from stream 7b (permeate) include but are not limited to, water, minerals, and combinations thereof.

Step 8 (See FIG. 4C) a mineral removal step can start with peptides, soy oligosaccharides, water, minerals, and combinations thereof from stream 7a. Soy oligosaccharides include but are not limited to sucrose, raffinose, stachyose, verbascose, monosaccharides, and combinations thereof. It includes an electrodialysis membrane step. Process variables and alternatives in this step include but are not limited to, ion exchange columns, chromatography, and combinations thereof. Processing aids that can be used in this mineral removal step include but are not limited to, water, enzymes, and combinations thereof. Enzymes include but are not limited to protease, phytase, and combinations thereof. The pH of step 8 can be between about 2.0 and about 12.0, preferably about 7.0. The temperature can be between about 5° C. and about 90° C., preferably about 40° C. Products from stream 8a (retentate) include but are not limited to, de-mineralized soy oligosaccharides with conductivity between about 10 milli Siemens (mS) and about 0.5 mS, preferably about 2 mS, and combinations thereof. Soy oligosaccharides include but are not limited to sucrose, raffinose, stachyose, verbascose, monosaccharides, and combinations thereof. Products from stream 8b include but are not limited to, minerals, water, and combinations thereof.

Step 9 (See FIG. 4C) a color removal step can start with de-mineralized soy oligosaccharides from stream 8a. It utilizes an active carbon bed. Process variables and alternatives in this step include but are not limited to, ion exchange. Processing aids that can be used in this color removal step include but are not limited to, active carbon, ion exchange resins, and combinations thereof. The temperature can be between about 5° C. and about 90° C., preferably about 40° C. Products from stream 9a (retentate) include but are not limited to, color compounds. Stream 9b is decolored. Products from stream 9b (permeate) include but are not limited to, soy oligosaccharides, and combinations thereof. Soy oligosaccharides include but are not limited to sucrose, raffinose, stachyose, verbascose, monosaccharides, and combinations thereof.

Step 10 (See FIG. 4C) a soy oligosaccharide fractionation step can start with soy oligosaccharides, and combinations thereof from stream 9b. Soy oligosaccharides include but are not limited to sucrose, raffinose, stachyose, verbascose, monosaccharides, and combinations thereof. It includes a chromatography step. Process variables and alternatives in this step include but are not limited to, chromatography, nanofiltration, and combinations thereof. Processing aids that can be used in this soy oligosaccharide fractionation step include but are not limited to acid and base to adjust the pH as one know in the art and related to the resin used. Products from stream 10a (retentate) include but are not limited to, soy oligosaccharides such as sucrose, monosaccharides, and combinations thereof. Products from stream 10b (permeate) include but are not limited to soy oligosaccharides such as, raffinose, stachyose, verbascose, and combinations thereof.

Finally, Step 11 (See FIG. 4C) a water removal step can start with soy oligosaccharides such as, raffinose, stachyose, verbascose, and combinations thereof from stream 10a. It includes an evaporation step. Process variables and alternatives in this step include but are not limited to, evaporation, reverse osmosis, nanofiltration, and combinations thereof. Processing aids that can be used in this water removal step include but are not limited to, defoamer, steam, vacuum, and combinations thereof. The temperature can be between about 5° C. and about 90° C., preferably about 60° C. Products from stream 11a (retentate) include but are not limited to, water. Products from stream 11 b (permeate) include but are not limited to, soy oligosaccharides, such as, raffinose, stachyose, verbascose, and combinations thereof.

### F. Compositions Comprising Soy Whey Proteins

The soy whey proteins that have been recovered from soy processing streams in accordance with the methods of the present disclosure and that possess the novel characteristics described in more detail in A., above, may further be used in dessert compositions. Specifically, the compositions of the present invention comprise the soy whey proteins described herein combined with at least one additional ingredient to form a dessert product.

Non-limiting examples of dessert products that may be made by the present disclosure are puddings, whipped toppings, gelatins, meringues, nougats, and frozen confections such as ice cream, water ice, sherbet, and the like.

### (a) Soy Whey Protein

The dessert compositions of the present invention will comprise, as one of the ingredients, soy whey protein which has been recovered from soy processing streams in accordance with the methods of the current invention. The amount of soy whey protein present in the ingredient(s) utilized can and will vary depending on the desired product. By way of example, the concentration of soy whey protein in the dessert composition may be about 60%, 55%, 50%, 45%, 40%, 35%, 30%, 25%, 20%, 15%, 10%, 5%, 2%, 1% or 0.05% by weight. For example, the amount of soy whey protein present in the dessert composition may range from about 0.05% to about 60% by weight. In another embodiment, the amount of soy whey protein present in the dessert composition may range from about 5% to about 30% by weight. In an additional embodiment, the amount of soy whey protein present in the dessert composition may range from about 10% to about 25% by weight.

The soy whey protein may be added to the pre-mix or at a subsequent processing step in the preparation of the dessert food composition. In one embodiment, the soy whey protein is added in a pre-mix with water to form a protein slurry and the additional dry blended ingredients are added at a later stage. In an alternative embodiment, the soy whey protein is added to the dry ingredients in a dry form as part of the dry blend pre-mix before adding to the liquid ingredients. Preferably, the soy whey protein is added to the water after the sequestering agents have been added. Alternatively, the soy whey protein could also be mixed with other dry ingredients prior to being added to the water or other liquid ingredients.

(b) Protein-Containing Material

In addition to the soy whey protein obtained through the methods of the present disclosure, other optional protein-containing material may also be present in the dessert composition. While ingredients comprising proteins derived from plants are typically used, it is also envisioned that proteins derived from other sources, such as animal sources, may be utilized without departing from the scope of the invention. For example, a dairy protein selected from the group consisting of casein, caseinates, whey protein, and mixtures thereof, may be utilized. By way of further example, an egg protein selected from the group consisting of ovalbumin, ovoglobulin, ovomucin, ovomucoid, ovotransferrin, ovovitella, ovovitellin, albumin globulin, and vitellin may be used.

In an exemplary embodiment, at least one ingredient derived from a variety of suitable plants will be present in the dessert composition. By way of non-limiting example, suitable plants include legumes, corn, peas, canola, sunflower, sorghum, rice, amaranth, potato, tapioca, arrowroot, canna, lupin, rape, wheat, oats, rye, barley, and mixtures thereof. In a preferred embodiment, the additional protein-containing material is isolated from soybeans.

Suitable soybean derived protein-containing ingredients (“soy protein material”) which may be present in the dessert composition include soy protein isolate, soy protein concentrate, soy protein flour, soy protein hydrolysate, and mixtures thereof. Generally speaking, when soy isolate is used, an isolate is preferably selected that is not a highly hydrolyzed soy protein isolate. In certain embodiments, highly hydrolyzed soy protein isolates may be used in combination with other soy protein isolates. Examples of commercially available soy protein material that may be utilized in the invention include, for example and among them include SUPRO® 120, SUPRO® 620, SUPRO® 670, SUPRO® XF 8020, SUPRO® XT219D, and combinations thereof, all of which are available from Solae, LLC (St. Louis, Mo.). The amount of protein present in the dessert composition can and will vary depending upon the desired dessert product.

The amount of additional protein-containing material that optionally may be present in the dessert composition may range from about 0% to about 30% by weight. In another embodiment, the amount of additional protein-containing material present in the dessert composition may range from about 2% to about 20% by weight. In an additional embodiment, the amount of additional protein-containing material that may be present in the dessert composition may range from about 3% to about 10% by weight. In another embodiment, no additional protein-containing material except for the soy whey protein is included in the dessert composition.

### (c) Carbohydrate Source

The soy whey protein detailed above may be combined with at least one carbohydrate source. Generally, the carbohydrate source is starch (pre-gelatinized starch or modified food starch), sugar, or flour (wheat, rice, corn, peanut, konjac). Suitable starches are known in the art and may include starches derived from vegetables (including legumes) or grains. Non-limiting examples of suitable starches may include starch derived from corn, potato, rice, wheat, arrowroot, guar gum, locust bean, tapioca, arracacha, buckwheat, banana, barley, cassava, konjac, kudzu, oca, sago, sorghum, sweet potato, taro, yams, and mixtures thereof. Edible legumes, such as favas, lentils and peas are also rich in suitable starches. Non-limiting examples of suitable sugars may include sucrose, dextrose, lactose, and fructose.

Regardless of the specific carbohydrate source used, the percentage of starch utilized in the dessert product typically determines, in part, its texture when it is expanded. As such, the amount of carbohydrates present in the dessert product can and will vary depending on the desired texture of the dessert product. For example, the amount of carbohydrates present in the dessert composition may range from about 1% to about 30% by weight. In another embodiment, the amount of carbohydrates present in the dessert composition may range from about 3% to about 20% by weight. In an additional embodiment, the amount of carbohydrates that may be present in the dessert composition may range from about 5% to about 10% by weight.

### (d) Additional Ingredients

In addition to the ingredients detailed in (a)-(c) above, a variety of other ingredients may be added to the pre-blend or at a subsequent processing step without departing from the scope of the invention. For example, dietary fiber, antioxidants, antimicrobial agents, thickening agents, vegetable oils, animal derived fats, stabilizers, emulsifiers, flavoring agents, sweetening agents, coloring agents, sequestering agents, juice concentrates, pH-adjusting agents, preservatives, dairy products, other nutrients, and combinations thereof may be included.

In one embodiment, the pre-blend may comprise a vegetable oil. Non-limiting examples of suitable vegetable oils include palm oil, rapeseed oil, soybean oil, sunflower oil, canola oil, corn oil, coconut oil, lecithin, soy lecithin. The percent of the pre-blend comprised of a vegetable oil will depend, in part, on the vegetable oil used and desired product. Generally, a vegetable oil may comprise between about 0.1% and 45% by weight of the pre-blend. Preferably, a vegetable oil may comprise between about 1% and 30% by weight of the pre-blend.

In one embodiment, the pre-blend may comprise an emulsifier. Non-limiting examples of suitable emulsifiers include distilled mono and diglycerides, propylene glycol monoesters, sodium stearoyl-2-lactylate, polysorbate 60, lecithin, hydroxylated lecithin and any other emulsifier known and used in the industry. The percent of the pre-blend comprised of an emulsifier will depend, in part, on the emulsifier used and desired product. Generally, an emulsifier may comprise between about 0.01% and 10% by weight of the pre-blend. Preferably, an emulsifier may comprise between about 0.05% and 5% by weight of the pre-blend. More preferably, an emulsifier may comprise between about 0.5% to 2% by weight of the pre-blend.

Antioxidant additives include ascorbic acid, BHA, BHT, TBHQ, vitamins A, C, and E and derivatives, and various plant extracts such as those containing cartenoids, tocopherols or flavonoids having antioxidant properties, may be included to increase the shelf-life or nutritionally enhance the food product. The antioxidants may have a presence at levels from about 0.01% to about 10%, preferably fro about 0.05% to about 5%, and more preferably from about 0.1% to about 2% by weight of the ingredients.

The dessert composition may optionally include a thickening agent depending on the desired dessert product to be produced. Suitable thickening agents may include carrageenan, cellulose gum, cellulose gel, starch, gum arabic, xanthan gum, and any other thickening agent known and used in the industry. The thickening agent may be present in the dessert composition at levels from about 0.01% to about 10%, preferably from about 0.05% to about 5%, and more preferably from about 0.1% to about 2% by weight of the ingredients. As will be appreciated by a skilled artisan, the amount of thickening agent, if any, added to the dessert composition can and will depend upon the type of dessert product desired.

The dessert composition may optionally comprise a stabilizer. Non-limiting examples of suitable stabilizers used in the art include pectin, agar agar, food gums such as locust bean gum, xanthan gum, cellulose gum, gum arabic and guar gum, alginic acid, carrageenan, gelatin, calcium chloride, lecithin, mono- and diglycerides, and any other stabilizer known and used in the industry. The stabilizer may be present in the dessert composition at a level from about 0.01% to about 10%, preferably from about 0.05% to about 5%, and more preferably from about 0.1% to about 2% by weight of the composition. As will be appreciated by a skilled artisan, the amount of stabilizer, if any, added to the dessert composition can and will depend upon the type of dessert product desired.

In some embodiments, it may be desirable to lower or raise the pH of the dessert composition depending on the type of dessert end product desired. Thus, the dessert composition may be contacted with a pH-adjusting agent. In one embodiment, the pH of the dessert composition may range from about 3.0 to about 7.5. In another embodiment, the pH of the dessert composition may be higher than about 7.2. In another embodiment, the pH of the dessert composition may be lower than about 4.5. Several pH-adjusting agents are suitable for use in the invention. The pH-adjusting agent may be organic or alternatively, it may be inorganic. In exemplary embodiments, the pH-adjusting agent is a food grade edible acid. Non-limiting acids suitable for use in the invention include acetic, lactic, hydrochloric, phosphoric, citric, tartaric, malic, glucono, deltalactone, gluconic, and combinations thereof. In an exemplary embodiment, the pH-adjusting agent is citric acid. In an alternative embodiment, the pH-adjusting agent may be a pH-raising agent, such as but not limited to disodium diphosphate and potassium hydroxide. As will be appreciated by a skilled artisan, the amount of pH-adjusting agent contacted with the dessert composition can and will vary depending on several parameters, including, the agent selected and the desired pH.

The dessert product may optionally include a variety of flavorings, spices, or other ingredients to naturally enhance the taste of the final dessert product. As will be appreciated by a skilled artisan, the selection of ingredients added to the dessert composition can and will depend upon the type of dessert product desired.

The dessert product may optionally include an ingredient that is a dairy product. Suitable non-limiting examples of dairy products that may additionally be added to the dessert composition are skim milk, reduced fat milk, 2% milk, whole milk, cream, ice cream, evaporated milk, yogurt, buttermilk, dry milk powder, non-fat dry milk powder, milk proteins, acid casein, caseinate (e.g., sodium caseinate, calcium caseinate, etc.), whey protein concentrate, and combinations thereof.

In one embodiment, the dessert composition may further comprise a flavoring agent. The flavoring agent may include any suitable edible flavoring agent known in the art including, but not limited to, salt, any flower flavor, any spice flavor, vanilla, any fruit flavor, caramel, nut flavor, beef, poultry (e.g. chicken or turkey), pork or seafood flavors, dairy flavors such as butter and cheese, any vegetable flavor and combinations thereof.

The flavoring may also be sweet. Sugar, whey, corn syrup solids, honey, glucose, sucrose, fructose, maltodextrin, sucralose, corn syrup (liquid or solids), honey, maple syrup, etc. may be used for sweet flavors. Additionally, other sweet flavors may be used (e.g., chocolate, chocolate mint, caramel, toffee, butterscotch, mint, and peppermint flavorings). Sugar alcohols may also be used as sweeteners.

A wide variety of fruit or citrus flavors may also be used. Non-limiting examples of fruit or citrus flavors include strawberry, banana, pineapple, coconut, cherry, orange, and lemon flavors.

A wide variety of spice flavors may also be used. Non-limiting examples include herb and garlic, sour cream and onion, honey mustard, hot mustard, dry roast, barbecue, jalapeno, red pepper, garlic, chili, sweet and sour seasoning, sweet seasoning, hot and spicy seasoning, savory flavor seasoning, vegetable seasonings, and combinations thereof.

In an additional embodiment, the dessert composition may further comprise a coloring agent. The coloring agent may be any suitable food coloring, additive, dye or lake known to those skilled in the art. Suitable food colorants may include, but are not limited to, for example, Food, Drug and Cosmetic (FD&C) Blue No. 1, FD&C Blue No. 2, FD&C Green No. 3, FD&C Red No. 3, FD&C Red No. 40, FD&C Yellow No. 5, FD&C Yellow No. 6, Orange B, Citrus Red No. 2 and combinations thereof. Other coloring agents may include annatto extract, b-apo-8′-carotenal, beta-carotene, beet powder, canthanxantin, caramel color, carrot oil, cochineal extract, cottonseed flour, ferrous gluconate, fruit juice, grape color extract, paprika, riboflavin, saffron, titanium dioxide, turmeric, and vegetable juice. These coloring agents may be combined or mixed as is common to those skilled in the art to produce a final coloring agent.

In a further embodiment, the food composition may further comprise a nutrient such as a vitamin, a mineral, an antioxidant, an omega-3 fatty acid, or an herb. Suitable vitamins include Vitamins A, C and E, which are also antioxidants, and Vitamins B and D. Examples of minerals that may be added include the salts of aluminum, ammonium, calcium, magnesium, and potassium. Suitable omega-3 fatty acids include docosahexanenoic acid (DHA). Herbs that may be added include basil, celery leaves, chervil, chives, cilantro, parsley, oregano, tarragon, and thyme.

### (e) Processing into Dessert Products

As referenced herein, the dessert compositions comprising soy whey proteins recovered from processing streams may undergo typical processing known in the industry to produce the desired dessert-type end product. Generally speaking, any method of processing known in the industry can be used to produce the desired dessert product.

For example, in one embodiment, the food compositions comprising soy whey proteins recovered from processing streams may undergo processing involving ingredient blending and a heat treatment step. In another embodiment, the compositions may additionally undergo pasteurization either prior or subsequent to any initial heat treatment. In a further embodiment, the compositions may additionally undergo homogenization prior to, subsequent to or in lieu of pasteurization. In yet another embodiment, the compositions comprising soy whey proteins recovered from processing streams may additionally be cooled in accordance with typical industry standards following the heat treatment, pasteurization and/or homogenization, prior to forming a dessert product. The cooling of the dessert composition may include refrigeration, freezing, or a combination of both.

### DEFINITIONS

To facilitate understanding of the invention, several terms are defined below.

The term “acid soluble” as used herein refers to a substance having a solubility of at least about 80% with a concentration of 10 grams per liter (g/L) in an aqueous medium having a pH of from about 2 to about 7.

The terms “soy protein isolate” or “isolated soy protein,” as used herein, refer to a soy material having a protein content of at least about 90% soy protein on a moisture free basis.

The term “other proteins” as used herein referred to throughout the application are defined as including but not limited to: lunasin, lectins, dehydrins, lipoxygenase, and combinations thereof.

The term “soy whey protein” as used herein is defined as including protein soluble at those pHs where soy storage proteins are typically insoluble, including but not limited to BBI, KTI, lunasin, lipoxygenase, dehydrins, lectins, and combinations thereof. Soy whey protein may further include storage proteins.

The term “subject” or “subjects” as used herein refers to a mammal (preferably a human), bird, fish, reptile, or amphibian, in need of treatment for a pathological state, which pathological state includes, but is not limited to, diseases associated with muscle, uncontrolled cell growth, autoimmune diseases, and cancer.

The term “processing stream” as used herein refers to the secondary or incidental product derived from the process of refining a whole legume or oilseed, including an aqueous or solvent stream, which includes, for example, an aqueous soy extract stream, an aqueous soymilk extract stream, an aqueous soy whey stream, an aqueous soy molasses stream, an aqueous soy protein concentrate soy molasses stream, an aqueous soy permeate stream, and an aqueous tofu whey stream, and additionally includes soy whey protein, for example, in both liquid and dry powder form, that can be recovered as an intermediate product in accordance with the methods disclosed herein.

The term “dessert food product” as used herein broadly refers to a mixture of a combination of safe and suitable ingredients including, but not limited to, soy whey protein, carbohydrates, stabilizers, and emulsifiers. Other ingredients such as dairy products, sweeteners, antioxidants, vitamins, minerals, coloring, and flavoring and may also be included. Specific dessert food products include, for example, puddings, gelatins, meringues, nougats, whipped toppings, frozen confections, and the like.

The term “frozen confection” broadly refers to a frozen mixture of a combination of safe and suitable ingredients including, but not limited to, milk, sweetener, stabilizers, emulsifiers, coloring, and flavoring. Other ingredients such as egg products and starch hydrolysates may also be included. Specific frozen confections include ice cream and its lower fat varieties, frozen custards, mellorine (vegetable fat-containing frozen desserts), sherbets, and water ices. Some of these products are served in either soft frozen or hard frozen form. Also included as frozen confections would be parevine-type products (non-dairy frozen desserts), which are similar to ice cream and its various forms except that the dairy has been replaced by safe and suitable ingredients.

When introducing elements of the present invention or the preferred embodiments(s) thereof, the articles “a,” “an,” “the” and “said” are intended to mean that there are one or more of the elements. The terms “comprising,” “including” and “having” are intended to be inclusive and mean that there may be additional elements other than the listed elements.

As various changes could be made in the above compounds, products and methods without departing from the scope of the invention, it is intended that all matter contained in the above description and in the examples given below, shall be interpreted as illustrative and not in a limiting sense.

### EXAMPLES

### Example 1

### Recovery and Fractionation of Soy Whey Protein from Aqueous Soy Whey Using Novel Membrane Process

145 liters of aqueous raw soy whey (not pre-treated) with a total solids content of 3.7% and dry basis protein content of 19.8% was microfiltered using two different membranes in an OPTISEP® 7000 module, manufactured by SmartFlow Technologies. The first membrane, BTS-25, was a polysulfone construction with 0.5 um pore size manufactured by Pall. Aqueous soy whey was concentrated to a 1.6× factor, at an average flux of 30 liters/meter²/hr (LMH). The concentrated aqueous soy whey was then passed through a modified polysulfone microfiltration membrane, MPS 0.45, manufactured by Pall. The aqueous soy whey was concentrated from 1.6× to 11× at an average flux of 28 LMH.

Permeate from the microfiltration process, 132 liters total, was then introduced into an OPTISEP® 7000 module with ultrafiltration membranes, RC100, which are 100 kDa regenerated cellulose membranes manufactured by Microdyn-Nadir. The microfiltered aqueous soy whey was concentrated to about 20× using a 20 L tank setup at an average flux of 30 LMH before being transferred to a 5 L tank setup in order to minimize the hold-up volume of the system. In the smaller tank, the aqueous soy whey was concentrated from 20× to 66× at an average flux rate of 9 LMH, reaching a final retentate volume of 2 liters. The final retentate was 24.0% total solids, and 83.0% dry basis protein content.

128 liters of sugar and mineral enriched RC100 permeate was then introduced into an OPTISEP® 7000 module with polysulfone thin film nanofiltration membranes with a 35% NaCl rejection rate, NF20, manufactured by Sepro. The feed was concentrated 18× at an average flux rate of 4.7 LMH. The retentate from this process step, 9 liters, was enriched in the various sugar species. The permeate stream from the NF20 separation process, 121 liters, contained the minerals and water.

The permeate of the NF20 process was then introduced into an OPTISEP® 3000 module with thin film reverse osmosis membranes with a 98.2% NaCl rejection rate, SG, manufactured by GE. The feed was concentrated 12× at an average flux rate of 8 LMH. The permeate of the SG membrane, 9.2 liters, consisted primarily of water, suitable for re-use in a process with minimal further treatment. The retentate of the SG process, 0.8 liters, consisted predominantly of a concentrated mineral fraction.

### Example 2

### Recovery and Fractionation of Soy Whey Protein from Soy Molasses Using Novel Membrane Process

61.7 liters of soy molasses with a total solids content of 62.7% and dry basis protein content of 18.5% was diluted with 61.7 liters of water prior to microfiltration. The diluted soy molasses was then microfiltered using an OPTISEP® 7000 module, manufactured by SmartFlow Technologies. The diluted soy molasses passed through a modified polysulfone microfiltration membrane, MPS 0.45, manufactured by Pall. The diluted soy molasses was concentrated to a 1.3× factor, at an average flux of 6 liters/meter²/hr (LMH).

Permeate from the microfiltration process, 25 liters total, was then introduced into an OPTISEP® 7000 module with ultrafiltration membranes, RC100, which are 100 kDa regenerated cellulose membranes manufactured by Microdyn-Nadir. The microfiltered diluted soy molasses was diafiltered with 2 volumes of water prior to being concentrated to 7.6× at an average flux of 20 LMH, reaching a final retentate volume of 2 liters. The final retentate was 17.5% total solids, and 22.0% dry basis protein content.

72 liters of sugar and mineral enriched RC100 permeate was then introduced into an OPTISEP® 7000 module with polysulfone thin film nanofiltration membranes with a 35% NaCl rejection rate, NF20, manufactured by Sepro. The feed was concentrated 3× at an average flux rate of 4.0 LMH. The retentate from this process step, 23 liters, was enriched in the various sugar species. The permeate stream from the NF20 separation process, 48 liters, contained the minerals and water.

A portion of the permeate of the NF20 process, 10 liters, was then introduced into an OPTISEP® 3000 module with thin film reverse osmosis membranes with a 98.2% NaCl rejection rate, SG, manufactured by GE. The feed was concentrated 6.7× at an average flux rate of 7.9 LMH. The permeate of the SG membrane, 8.5 liters, consisted primarily of water, suitable for re-use in a process with minimal further treatment. The retentate of the SG process, 1.5 liters, consisted predominantly of a concentrated mineral fraction.

### Example 3

### Capture of Bulk Soy Whey Protein from Defatted Soy Flour Extract

Defatted soy flour (DSF) was extracted by adding a 15:1 ratio of water to DSF at a pH of 7.8 and stirring for 20 minutes prior to filtration. The extract was microfiltered using an OPTISEP® 800 module, manufactured by SmartFlow Technologies. The microfiltration membrane, MMM-0.8, was a polysulfone and polyvinylpropylene construction with 0.8 um pore size manufactured by Pall. Aqueous soy extract was concentrated to a 2.0× factor, at an average flux of 29 liters/meter²/hr (LMH). Permeate from the microfiltration process was then introduced into an OPTISEP® 800 module with ultrafiltration membranes, RC100, which are 100 kDa regenerated cellulose membranes manufactured by Microdyn-Nadir. The microfiltered aqueous soy extract was concentrated to about 6.3× at an average flux rate of 50 LMH. The final retentate measured 84.7% dry basis protein content.

### Example 4

### Capture of Bulk Soy Whey Protein Using Continuous Separation Technology CSEP (Simulated Moving Bed Chromatography

CSEP experiments were performed by passing feed material (soy whey) through a column (ID 1.55 cm, length 9.5 cm, volume 18 mL) packed with SP GibcoCel resin. The column was connected to a positive displacement pump and samples of flow through and eluates were collected at the outlet of the column. Different experimental conditions were used to determine the effect of feed concentration, feed flow rate and elution flow rate on the binding capacity of the resin.

Feed Concentration

Soy whey was prepared from the defatted soy flake. Briefly, one part of defatted flake was mixed with 15 parts of water at 32° C. The pH of the solution was adjusted to 7.0 using 2 M NaOH and proteins were extracted into the aqueous phase by stirring the solution for 15 min. The protein extract was separated from the insoluble material by centrifugation at 3000×g for 10 min. The pH of the collected supernatant was adjusted to 4.5 using 1 M HCl and the solution was stirred for 15 min followed by heating to a temperature of 57° C. This treatment resulted in precipitation of the storage proteins while the whey proteins remained soluble. The precipitated proteins were separated from the whey by centrifugation at 3000×g for 10 min.

In some cases, the soy whey was concentrated using a Lab-Scale Amicon DC-10LA ultrafiltration unit and Amicon 3K membrane. Prior to ultrafiltration, pH of soy whey was adjusted to 5.5 with 2 M NaOH to avoid membrane fouling at acidic conditions. 10 L of whey was processed with the flux at −100 mL/min. Once the concentration factor of 5 in the retentate was reached, both retentate and permeate streams were collected. Soy whey concentrates 2.5×, 3×, and 4× were prepared by mixing a known amount of permeate and 5× whey concentrate. The pH of all soy concentrates was readjusted if necessary to 4.5.

Feed Flow Rate

During dynamic adsorption, as fluid flows through the resin bed, the proteins are adsorbed by the resin and reach equilibrium with the liquid phase. As the whey is loaded onto the column, the bound protein band extends down the column and reaches equilibrium with the liquid phase. When the resin is saturated with adsorbed proteins, the concentration of the proteins in the liquid phase exiting the column will be similar to the protein concentration in the feed. The curve describing the change in the flow through concentration compared to the feed concentration with the passage of fluid is the breakthrough curve. The concentration of protein in the solid phase increases as the breakthrough curve is developed, and the adsorption wave moves through the bed. As more fluid is passed through the bed, the flow through concentration increases asymptotically to the incoming fluid stream and at the same time a similar phenomena is achieved with the solid phase.

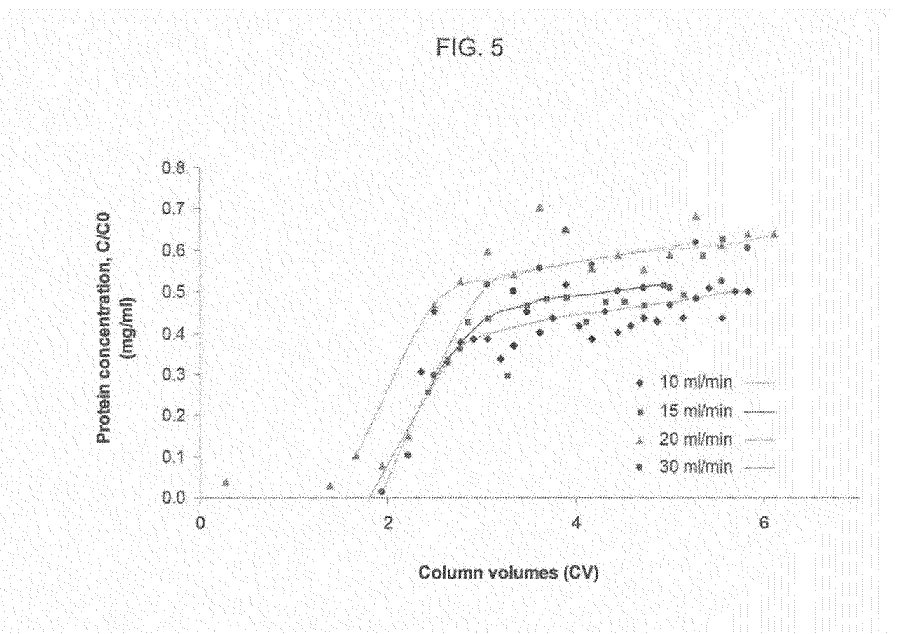

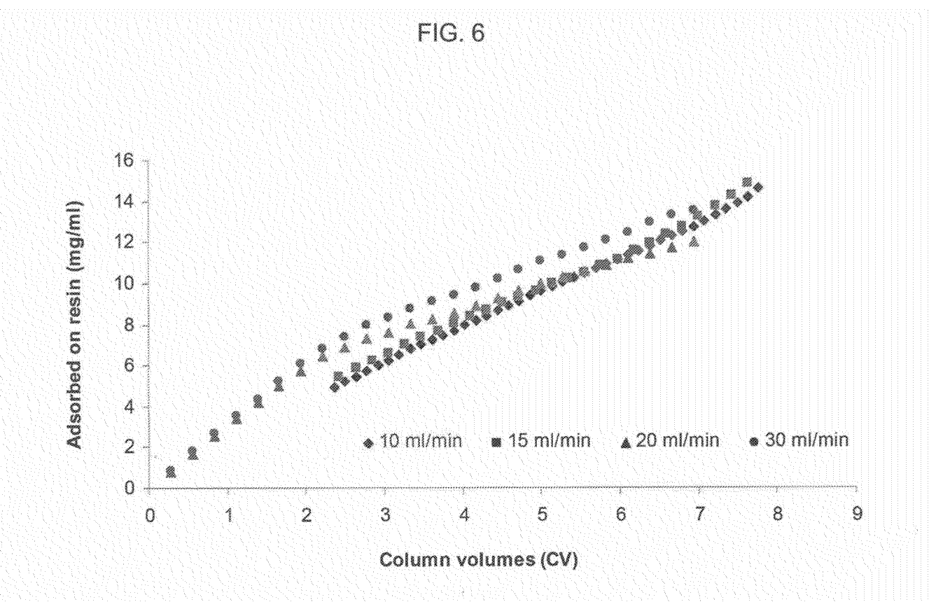

The flow through protein concentration data at three different linear velocity rates were plotted against the column volumes of soy whey loaded (see FIG. 5). These data indicated that increasing the linear flow rate of loading by a factor of 3 resulted in about 10% increase in the unabsorbed proteins in the flow through after loading 6 column volumes of soy whey. Therefore the linear flow rate does not significantly impact the adsorption characteristics of the soy whey proteins with the SP Gibco resin. The equilibrium adsorption data (see FIG. 6) showed that the soy whey protein adsorbed on the resin (calculated using mass balance of protein feed to the system and the protein concentration in the flow through, in equilibrium with the protein in the liquid stream, and plotted against the column volumes passed through the resin bed) varied little with flow rate of the feed at the fluxes tested.

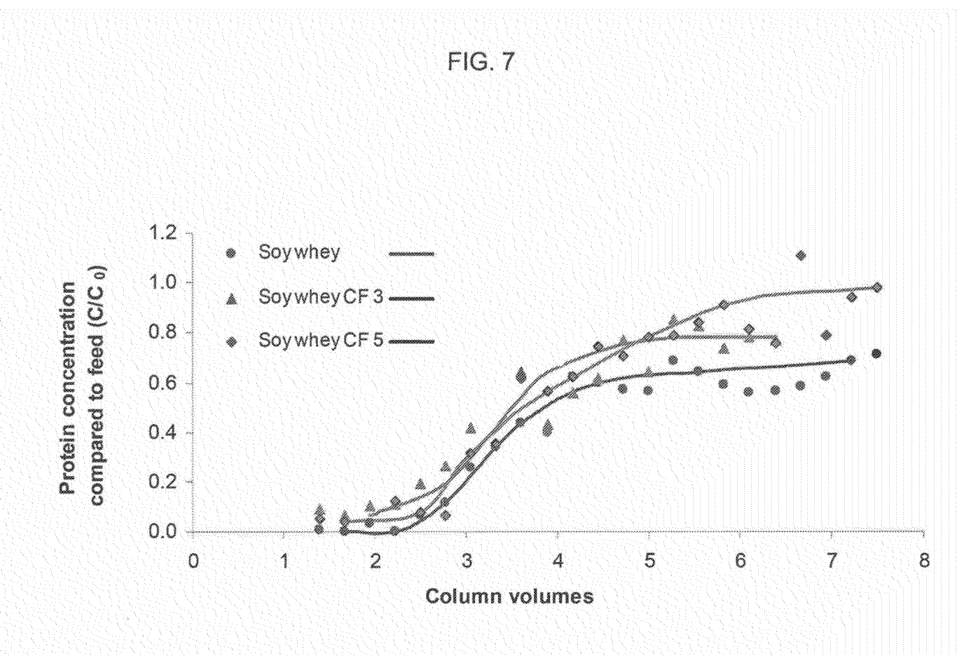

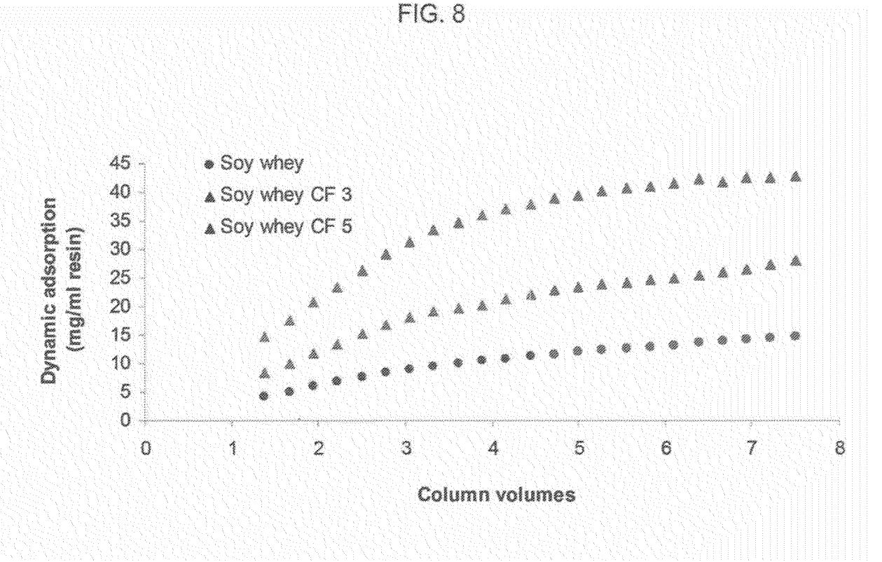

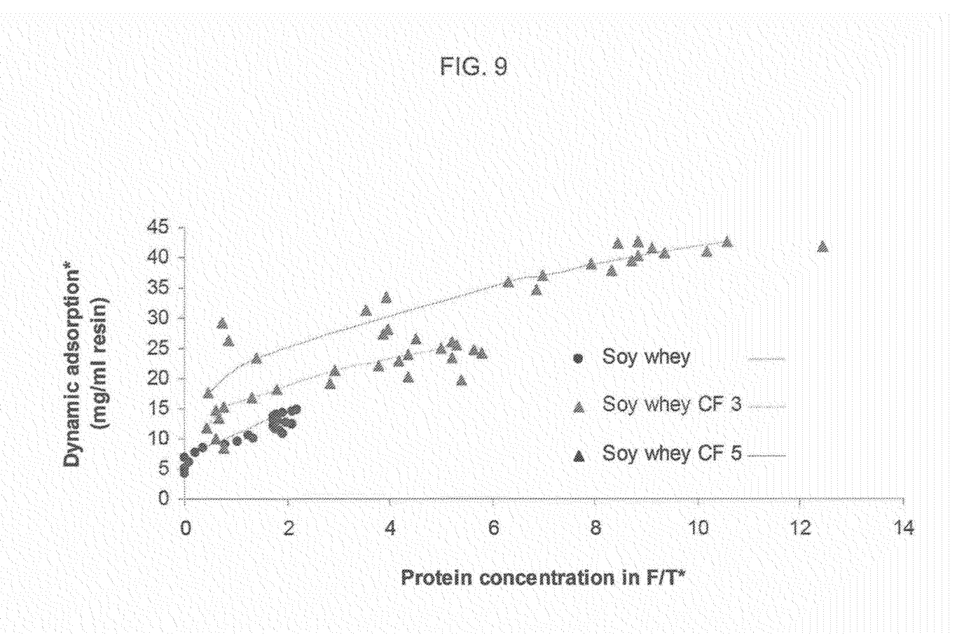

The profile of the breakthrough curve, where soy whey and soy whey concentrated by a factor of 3 and 5 was applied to an SP Gibco resin bed at 15 mL/min (8.5 cm/min linear flow rate), was similar with all three concentrations (see FIG. 7). This result indicated that as the feed protein concentration was increased the resin reached equilibrium with the protein concentration in the liquid stream by striving to reach maximum capacity. This increased adsorption is depicted in FIG. 8 where the protein concentration in the solid phase in equilibrium with the liquid phase has been plotted against the column volumes of soy whey passed through the bed. These data show that the protein adsorbed by the resin significantly increased with soy whey concentration factor, and hence the protein concentration in the soy whey (see FIG. 8). FIG. 9 shows the equilibrium characteristics of the resin and the flow through. This chart shows that as the number of column volumes were passed through the bed, the adsorption of proteins in the resin phase increased asymptotically but the protein content in the flow through also increased. Adsorption capacity can be increased by using concentrated whey and loading at high column volumes but this resulted in a relatively high protein content in the flow through. However, the high protein content in the flow through was minimized by counter current operation using a 2-stage adsorption strategy.

Based on the dynamic adsorption data (see FIG. 9), loading whey concentrated by factor >5 to achieve a protein concentration of >11 mg/mL and loading about 3.5 column volumes resulted in about 35 mg protein adsorbed per mL of resin, and the equilibrium protein concentration in the flow through was about 6.8 mg/mL. Presenting this primary flow through to another resin bed in a second pass (loading about 3.5 column volumes) resulted in a protein concentration in the flow through of about 1.3 mg/mL. Therefore, using two passes of adsorption and operating the chromatography in counter current mode resulted in adsorption of about 90% of the available soy protein that could be absorbed from soy whey at pH 4.5.

Elution Flow Rate

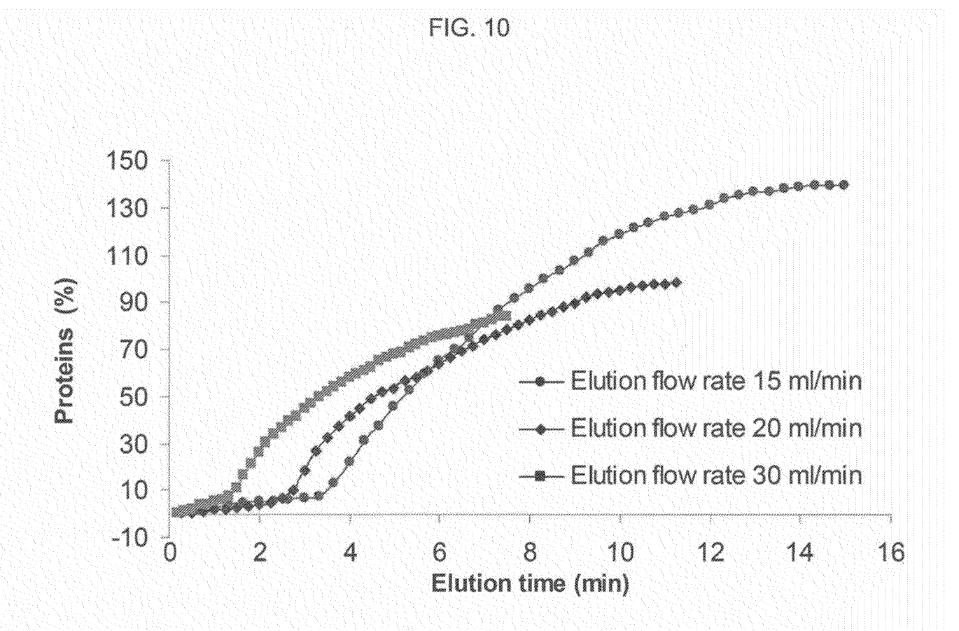

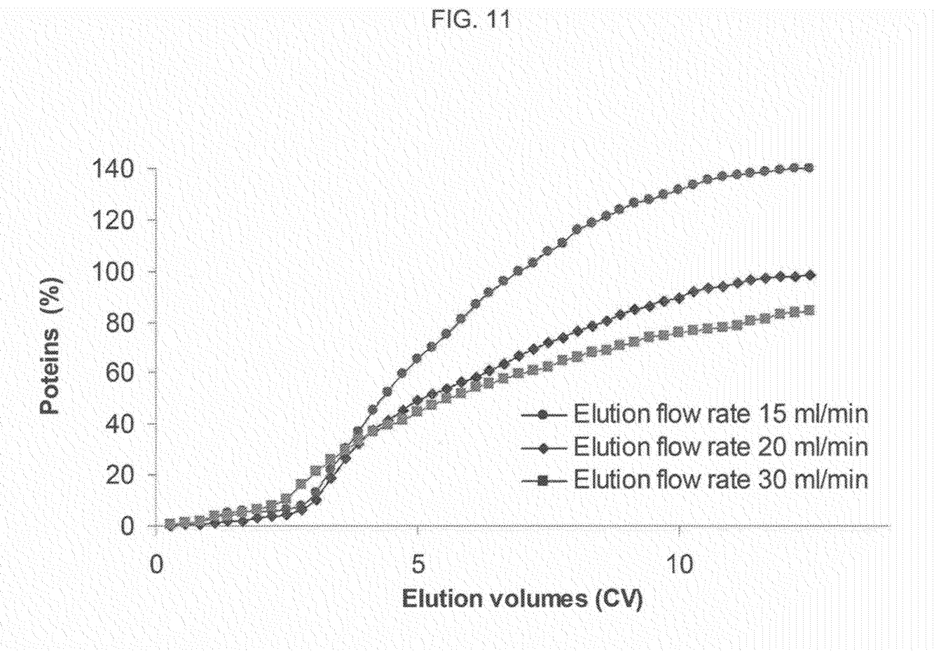

The effect of elution flow rate was investigated at three different flow rates and the recovery data are shown in Table 3. The recovery of protein at low flow rates in duplicate experiments resulted in recoveries of over 164% and 200%. The data indicate that eluting at 20 and 30 mL/min (11.3 and 17.0 cm/min, respectively) did not significantly affect the recoveries. Moreover, operating at higher flow rates achieved much faster elution (see FIG. 10), however at these higher flow rates a larger column volume of eluate was required to complete the elution (see FIG. 11). The need for a larger column volume of eluate was overcome by recycling the eluate which also reduced the total volume required for elution and also presented a more concentrated protein stream to the downstream ultrafiltration unit, reducing the membrane area needed for protein concentration.

TABLE 3
Elution and recovery of bound soy whey proteins at three different
flow rates.

| | ELUTION FLOW RATES | | |
|---|---|---|---|
| | 15 mL/min | 20 mL/min | 30 mL/min |
| Protein adsorbed | 75.4 ± 4.4 | 70.8 ± 2.7 | 72.9 ± 4.8 |
| (mg) | | | |
| Protein eluted | 139.7 ± 22.9 | 73.2 ± 1.5 | 68.4 ± 6.8 |
| (mg) | | | |
| Recovery (%) | 184.2 ± 19.7 | 103.4 ± 6.1 | 93.8 ± 15.6 |

Protein adsorption was calculated as the difference in the protein content in the feed and flow through by mass balance.

### Example 5

### Capture of Bulk Soy Whey Protein from a Pre-Treated Whey Process (PT)

The feed stream to the process, pre-treated whey protein, (also referred to PT whey) had approximately 1.4%-2.0% solids. It was comprised of approximately 18% minerals, 18% protein, and 74% sugars and other materials. Implementation of a Nanofiltration (NF) process allowed for water removal while retaining most of the sugars and protein, and other solid material, in the process to be recovered downstream. The NF membranes (Alfa Laval NF99 8038/48) for the trial were polyamide type thin film composite on polyester membranes with a 2 kDa molecular weight cutoff (MWCO) that allowed water, monovalent cations, and a very small amount of sugars and protein to pass through the pores. The membrane housing held 3 membrane elements. Each element was 8 inches in diameter and had 26.4 square meters of membrane surface area. The total membrane surface area for the process was 79.2 square meters. These membranes were stable up to 1 bar of pressure drop across each membrane element. For the entire module containing 3 membrane elements, a pressure drop of 3 bar was the maximum allowable. The NF feed rate of PT whey was approximately 2,500 L/hour. The temperature of this feed was approximately 45-50° C., and the temperature of the NF operation was regulated to be in this range using cooling water. Initial product flux rates were approximately 16-22 liters per meter squared per hour (LMH). The feed pressure at the inlet of the module was approximately 6 bar. Through the duration of the 6 hour run, the flux dropped as a result of fouling. The feed pressure was increased incrementally to maintain higher flux, but as fouling occurred, the pressure was increased to the maximum, and the flux slowly tapered from that point. Volumetric concentration factors were between 2× and approximately 4×.

A Precipitation step was performed to separate, e.g., phosphorous and calcium salts and complexes from the PT whey. Precipitation conditions were at pH 9 while maintaining the temperature at 45° C. with a residence time of approximately 15 minutes. The precipitation process occurred in a 1000 liter. This tank had multiple inlets and outlets where materials can be piped into and out of it. A small centrifugal pump circulated product out of the tank and back into the side of the tank to promote agitation and effective mixing of the 35% NaOH added to the system to maintain the target pH. This pump also sent product into the centrifuge when one of the T-valves connected to this recirculation loop was opened. Concentrated PT whey from the NF was fed directly into the top of the tank. 35% NaOH was connected into the feed line from the NF in order to control the pH at the target value. PT whey was fed into this mixing tank at approximately 2,500 L/hour and fed out at the same rate.

In following process step, an Alfa Laval Disc Centrifuge (Clara 80) with intermittent solids ejection system was used to separate precipitated solids (including insoluble soy fiber, insoluble soy protein) from the rest of the sugar- and protein-containing whey stream. In this process, concentrated PT whey from the precipitation tank was pumped into a disc-centrifuge where this suspension was rotated and accelerated by centrifugal force. The heavier fraction (precipitated solids) settles on the walls of the rotating centrifuge bowl with the lighter fraction (soluble liquid) was clarified through the use of disc-stacks and continuously discharged for the next step of the process. The separated precipitated solids was discharged at a regular interval (typically between 1 and 10 minutes). The clarified whey stream was less then 0.2% solids on a volumetric basis. The continuous feed flow rate was approximately 2.5 m3/hr, with a pH of 9.0 and 45° C. The insoluble fraction reached Ash=30-60%; Na=0.5-1.5% dry basis, K=1.5-3% dry basis, Ca=6-9% dry basis, Mg=3-6% dry basis, P=10-15% dry basis, Cl=1-2% dry basis, Fe, Mn, Zn, Cu<0.15% dry basis. Changes to the soluble fraction were as follows: Phytic acid was approximately 0.3% dry basis (85% reduction, P=0.2-0.3% dry basis (85-90% reduction), Ca=0.35-0.45% dry basis (80-85% reduction), Mg=0.75-0.85% dry basis (15-20% reduction).

The next step was an Ultrafiltration (UF) membrane. Protein was concentrated by being retained by a membrane while other smaller solutes pass into the permeated stream. From the centrifuge a diluted stream the containing protein, minerals and sugars was fed to the UF. The UF equipment and the membrane were supplied from Alfa Laval while the CIP chemicals came from Ecolab, Inc. The tested membrane, GR70PP/80 from Alfa-Laval, had a MWCO of 10 kD and was constructed of polyethersulfone (PES) cast onto a polypropylene polymer backing. The feed pressure varied throughout the trial from 1-7 bar, depending upon the degree of fouling of the membranes. The temperature was controlled to approximately 65° C. The system was a feed and bleed setup, where the retentate was recycled back to the feed tank while the permeate proceeded on to the next step in the process. The system was operated until a volume concentration factor of 30× was reached. The feed rate to the UF was approximately 1,600 L/hour. The setup had the ability to house 3 tubes worth of 6.3″ membrane elements. However, only one of the three tubes was used. The membrane skid had an automatic control system that allowed control of the temperature, operating pressures (inlet, outlet, and differential) and volume concentration factor during process. Once the process reached the target volume concentration factor, typically after 6-8 hours of operation, the retentate was diafiltered (DF) with one cubic meter of water, (approximately 5 parts of diafiltration water per part of concentrated retentate) to yield a high protein retentate. After a processing cycle, the system was cleaned with a typical CIP protocol used with most protein purification processes. The retentate contained about 80% dry basis protein after diafiltration.

The permeate of the UF/DF steps contained the sugars and was further concentrated in a Reverse Osmosis Membrane system (RO). The UF permeate was transferred to an RO system to concentrate the feed stream from approximately 2% total solids (TS) to 20% TS. The process equipment and membranes (RO98pHt) for the RO unit operation were supplied by Alfa-Laval. The feed pressure was increased in order to maintain a constant flux, up to 45 bar at a temperature of 50° C. Typically each batch started at a 2-3% Brix and end at 20-25% Brix (Brix=sugar concentration).

After the RO step the concentrated sugar stream was fed to an Electrodialysis Membrane (ED). Electrodialysis from Eurodia Industrie SA removes minerals from the sugar solution. The electrodialysis process has two product streams. One is the product, or diluate, stream which was further processed to concentrate and pasteurize the SOS concentrate solution. The other stream from the electrodialysis process is a brine solution which contains the minerals that were removed from the feed stream. The trial achieved >80% reduction in conductivity, resulting in a product stream that measured <3 mS/cm conductivity. The batch feed volume was approx 40 liters at a temperature of 40° C. and a pH of 7. The ED unit operated at 18V and had up to 50 cells as a stack size.

The de-mineralized sugar stream from the ED was further processed in an Evaporation step. The evaporation of the SOS stream was carried out on Anhydro's Lab E vacuum evaporator. SOS product was evaporated to 40-75% dry matter with a boiling temperature of approximately 50-55° C. and a ΔT of 5-20° C.

A Spray Dryer was used to dry UF/DF retentate suspension. The UF diafiltrate retentate, with a solids content of approximately 8%, was kept stirred in a tank. The suspension was then fed directly to the spray dryer where it was combined with heated air under pressure and then sprayed through a nozzle. The dryer removed the water from the suspension and generated a dry powder, which was collected in a bucket after it was separated from the air stream in a cyclone. The feed suspension was thermally treated at 150° C. for 9 seconds before it entered the spray dryer to kill the microbiological organisms. The spray dryer was a Production Minor from the company Niro/GEA. The dryer was set up with co-current flow and a two fluid nozzle. The drying conditions varied somewhat during the trial. Feed temperatures were about 80° C., nozzle pressure was about 4 bars, and inlet air temperatures was about 250° C.

### Example 6

### Capture of Bulk Soy Whey Protein Whey Pre-Treatment Process and Cross-Flow Filtration Membranes

Approximately 8000 lbs of aqueous soy whey (also referred to as raw whey) at 110° F. and 4.57 pH from an isolated soy protein extraction and isoelectric precipitation continuous process was fed to a reaction vessel where the pH was increased to 5.3 by the addition of 50% sodium hydroxide. The pH-adjusted raw whey was then fed to a second reaction vessel with a 10 minute average residence time in a continuous process where the temperature was increased to 190° F. by the direct injection of steam. The heated and pH-adjusted raw whey was then cooled to 90 degrees F. by passing through a plate and frame heat exchanger with chilled water as the cooling medium. The cooled raw whey was then fed into an Alfa Laval VNPX510 clarifying centrifuge where the suspended solids, predominantly insoluble large molecular weight proteins, were separated and discharged in the underflow to waste and the clarified centrate proceeded to the next reaction vessel. The pH of the clarified centrate, or pre-treated whey protein, was adjusted to 8.0 using 12.5% sodium hydroxide and held for 10 minutes prior to being fed into an Alfa Laval VNPX510 clarifying centrifuge where the suspended solids, predominantly insoluble minerals, were separated and discharged in the underflow to waste. The clarified centrate proceeded to a surge tank prior to ultrafiltration. Ultrafiltration of the clarified centrate proceeded in a feed and bleed mode at 90° F. using 3.8″ diameter polyethersulfone spiral membranes, PW3838C, made by GE Osmonics, with a 10 kDa molecular weight cut-off. Ultrafiltration continued until a 60× concentration of the initial feed volume was accomplished, which required about 4.5 hrs. The retentate, 114 lbs at 4.5% total solids and 8.2 pH, was transferred to a reaction vessel where the pH was adjusted to 7.4 using 35% hydrochloric acid. The retentate was then heated to 305° F. for 9 seconds via direct steam injection prior to flash cooling to 140° F. in a vacuum chamber. The material was then homogenized by pumping through a homogenizing valve at 6000 psi inlet and 2500 outlet pressure prior to entering the spray drier through a nozzle and orifice combination in order to atomize the solution. The spray drier was operated at 538° F. inlet temperature and 197° F. outlet temperature, and consisted of a drying chamber, cyclone and baghouse. The spray dried soy whey protein, a total of 4 lbs, was collected from the cyclone bottom discharge.

### Example 7

### Capture of Bulk Soy Whey Protein Using Expanded Bed Adsorption (EBA) Chromatography

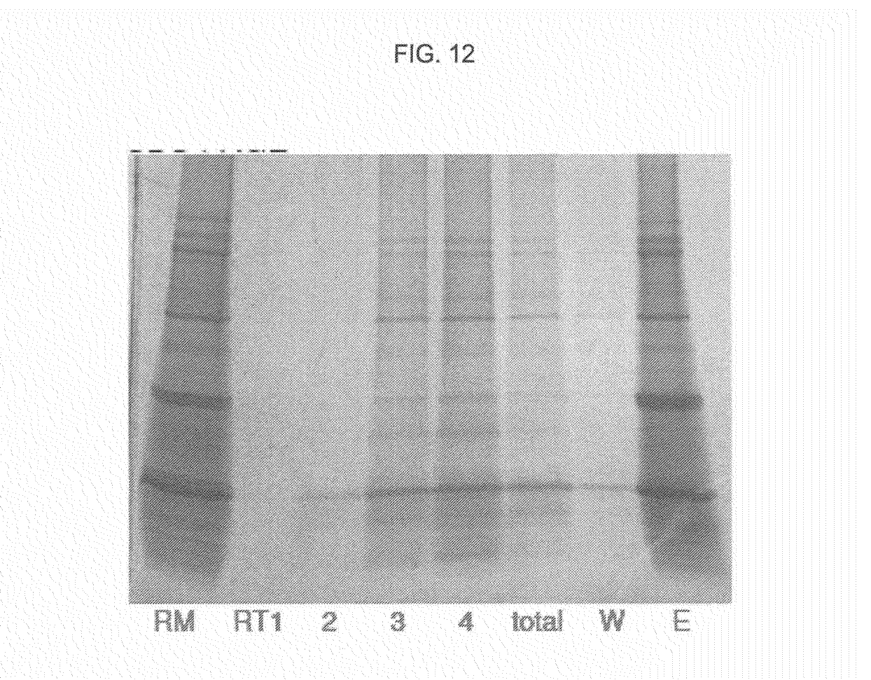

200 ml of aqueous raw soy whey (not pre-treated) with a total solids content of 1.92%, was adjusted to pH 4.5 with acetic acid and applied to a 1×25 cm column of Mimo6ME resin (UpFront Chromatography, Copenhagen Denmark) equilibrated in 10 mM sodium citrate, pH 4.5. Material was loaded onto the column from the bottom up at 20-25° C. using a linear flow rate of 7.5 cm/min. Samples of the column flow-through were collected at regular intervals for later analysis. Unbound material was washed free of the column with 10 column volumes of equilibration buffer, then bound material recovered by elution with 50 mM sodium hydroxide. 10 μls of each fraction recovered during EBA chromatography of aqueous soy whey were separated on a 4-12% SDS-PAGE gel and stained with Coomassie Brilliant Blue R 250 stain. SDS-PAGE analysis of the column load, flow-through, wash, and sodium hydroxide eluate samples is depicted in FIG. 12. As used in FIG. 12, RM: raw material (column load); RT1-4: column flow-through (run through) collected at equal intervals during the load; total: the total run-through fraction; W: column wash; E: column eluate. Binding was reasonably efficient, as very little protein is seen in the initial breakthrough fractions, only showing up in the later fractions. A total of 662 mg of protein was recovered in the eluate, for a yield of 3.3 mg/ml of starting material. Under these conditions, the capacity of this resin was shown to be 33.1 mg of protein per ml of adsorbant.

### Example 8

### Capture of Bulk Soy Whey Protein from Spray-Dried SWP Using Expanded Bed Adsorption (EBA) Chromatography

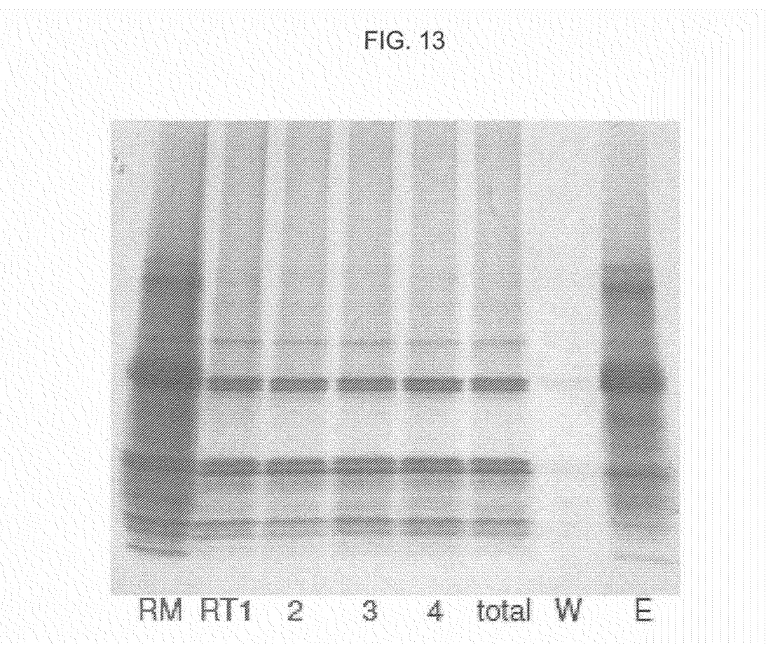

Spray-dried soy whey powder was slurried to a concentration of 10 mg/ml in water and adjusted to pH 4.0 with acetic acid. 400 ml of the slurry was then applied directly to the bottom of a 1×25 cm column of Mimo-4SE resin (UpFront Chromatography, Copenhagen Denmark) that had been equilibrated in 10 mM sodium citrate, pH 4.0. Material was loaded at 20-25° C. using a linear flow rate of 7.5 cm/min. Samples of the column flow-through were collected at regular intervals for later analysis. Unbound material was washed free of the column using 10 column volumes of equilibration buffer. Bound material was eluted with 30 mM NaOH. 10 μls of each fraction recovered during EBA chromatography of a suspension of soy whey powder were separated on a 4-12% SDS-PAGE gel and stained with Coomassie Brilliant Blue R 250 stain. SDS-PAGE analysis of the column load, flow-thru, wash, and eluate are depicted in FIG. 13. As used in FIG. 13, RM: raw material (column load); RT1-4: column flow-through (run through) collected at equal intervals during the load; total: the total run-through fraction; W: column wash; E: column eluate. Binding was not as efficient as was observed using the Mimo6ME resin, as several protein bands are seen in the breakthrough fractions. A total of 2070 mg of protein were recovered in the eluate, for a yield of 5.2 mg/ml of starting material. Under these conditions, the capacity of this resin was shown to be 104 mg of protein per ml of adsorbant.

### Example 9

### Removal of KTI from Bulk Soy Whey Protein Using Expanded Bed Adsorption (EBA) Chromatography

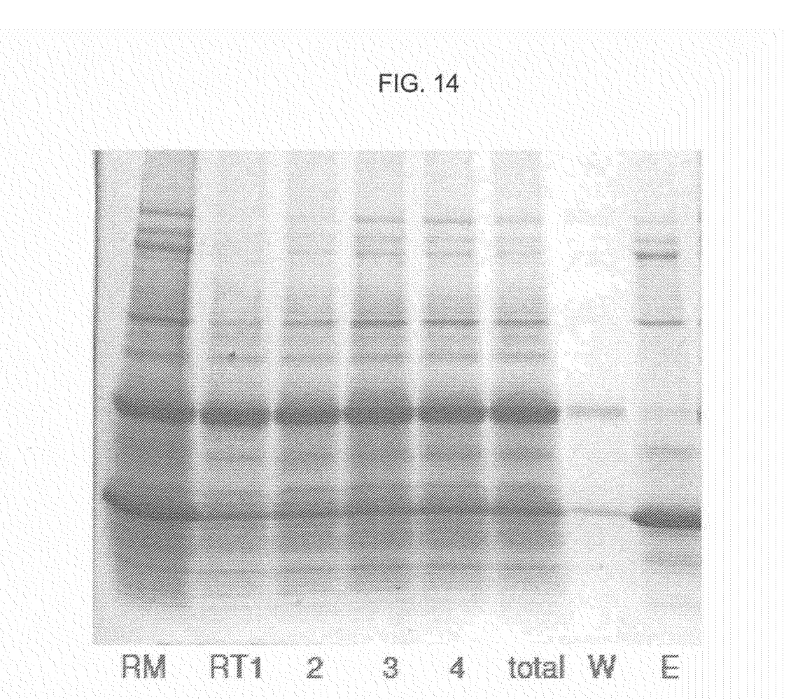

Two procedures were used to remove the majority of contaminating KTI protein from the bulk of the soy whey protein by EBA chromatography. In the first, 200 ml of aqueous raw soy whey (not pre-treated) with a total solids content of 1.92%, was adjusted to pH 6.0 with sodium hydroxide and applied to a 1×25 cm column of Mimo6HE resin (UpFront Chromatography, Copenhagen Denmark) equilibrated in 10 mM sodium citrate, pH 6.0. Material was loaded onto the column from the bottom up at 20-25° C. using a linear flow rate of 7.5 cm/min. Samples of column flow-through were collected at regular intervals for later analysis. Unbound material was washed free of the column with 10 column volumes of equilibration buffer, then bound material recovered by elution with 30 mM sodium hydroxide. 10 μls of each fraction recovered during EBA chromatography of a suspension of soy whey powder were separated on a 4-12% SDS-PAGE gel and stained with Coomassie Brilliant Blue R 250 stain. SDS-PAGE analysis of the column load, flow-through, wash, and sodium hydroxide eluate samples is depicted in FIG. 14. As used in FIG. 14, RM: raw material (column load); RT1-4: flow-through material (run through) collected at equal intervals during the load; total: the total run-through fraction; W: column wash; E: column eluate. The bulk of the loaded protein is clearly seen eluting in the flow-through, while the bulk of the KTI protein remains bound to the resin. A total of 355 mg of protein, the bulk of which is KTI, was recovered in the eluate, for a yield of 1.8 mg/ml of starting material. Under these conditions, the capacity of this resin was shown to be 17.8 mg of KTI (plus minor contaminants) per ml of adsorbant.

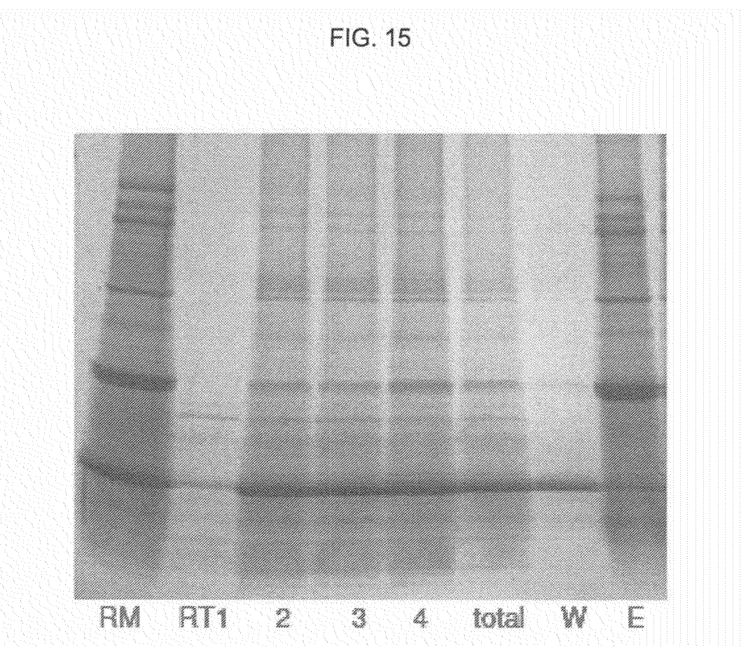

In the second procedure, 160 mls of aqueous raw soy whey (not pre-treated) with a total solids content of 1.92%, was adjusted to pH 5.1 with acetic acid and applied to a 1×25 cm column of Mimo6ZE resin (UpFront Chromatography, Copenhagen Denmark) equilibrated in 10 mM sodium citrate, pH 5.0. Material was loaded onto the column from the bottom up at 20-25° C. using a linear flow rate of 7.5 cm/min. Samples of column flow-through were collected at regular intervals for later analysis. Unbound material was washed free of the column with 10 column volumes of equilibration buffer, then bound material recovered by elution with 30 mM sodium hydroxide. 10 μls of each fraction recovered during EBA chromatography of a suspension of soy whey powder were separated on a 4-12% SDS-PAGE gel and stained with Coomassie Brilliant Blue R 250 stain. SDS-PAGE analysis of the column load, flow-through, wash, and sodium hydroxide eluate samples is depicted in FIG. 15. As used in FIG. 15, RM: raw material (column load); RT1-4: flow-through material (run through) collected at equal intervals during the load; total: the total run-through fraction; W: column wash; E: column eluate. The bulk of the KTI is clearly seen eluting in the flow-through, while the bulk of the remaining protein remains bound to the resin. A total of 355 mg of soy protein essentially devoid of contaminating KTI was recovered in the eluate, for a yield of 2.1 mg/ml of starting material. Under these conditions, the capacity of this resin was shown to be 16.8 mg of soy protein per ml of adsorbant.

### Example 10

### Preparation of a Ready to Eat Pudding Product that Contains a Quantity of Soy Whey Protein

A ready to eat pudding product can be prepared using soy whey protein recovered from a soy processing stream as described hereinabove at various replacement levels. Table 4 is the list of ingredients that can be used to prepare both a ready to eat pudding product comprised of 2 grams of soy whey protein and a product comprised of 30 grams of soy whey protein.

TABLE 4
Ready to Eat Pudding Product Formulation with Soy Whey Protein

| | SWP 2 g | | SWP 30 g | |
|---|---|---|---|---|
| Ingredient | % | gms | % | gms |
| Water | 81.81% | 6544.80 | 78.50% | 6280.00 |
| Soy Whey Protein | 0.70% | 56.00 | 15.50% | 1240.00 |
| Corn Syrup Solids, 25DE | 11.52% | 921.60 | | |
| Butter, unsalted | 3.00% | 240.00 | 3.00% | 240.00 |
| Cocoa | 1.20% | 96.00 | 1.20% | 96.00 |
| Modified food starch | 0.90% | 72.00 | 0.90% | 72.00 |
| Potassium citrate | 0.22% | 17.60 | 0.22% | 17.60 |
| Salt | 0.19% | 15.20 | 0.22% | 17.60 |
| N & A Flavoring Agents | 0.41% | 32.80 | 0.41% | 32.80 |
| Sucralose | 0.03% | 2.40 | 0.03% | 2.40 |
| Acesulfame potassium | 0.01% | 0.80 | 0.01% | 0.80 |
| Potassium sorbate | 0.01% | 0.80 | 0.01% | 0.80 |
| Total | 100.00% | 8000.00 | 100.00% | 8000.00 |

The pudding samples can be formed by first adding the potassium citrate to the formula water and mixing in a conventional jacketed stainless steel food processing kettle such equipped with an air propelled mixer until dispersed. Add the soy whey protein to the water/citrate mixture and heat to a temperature between 48° C. to 55° C. while mixing with moderate shear to facilitate complete protein dispersion and form a protein slurry. Heat the protein slurry to a temperature between 71° C. to 77° C. and continue mixing slowly for 15 minutes to complete the protein hydration. Add the cocoa, sucralose and acesulfame potassium to the slurry and continue mixing for 5 minutes.

Melt the butter at a temperature of 55° C. and add the melted butter to the protein slurry while continuing to mix to achieve a homogenous mixture. Add the salt, sorbate, starch and flavoring agents to the slurry. Continue mixing continued until all components are homogenous and completely incorporated.

Check the pH of the slurry and, if necessary, adjust to a pH of between 7.0 and 7.2 by adding acid blends of citric acid, malic acid and or potassium hydroxide.

Pump the slurry to a two stage, three piston homogenizer set at 500 psi, second stage; 2500 psi, first stage. Move the homogenized slurry to a surge tank for UHT (ultra high temperature heat treatment) at a temperature of 143° C. for a hold time of 8 seconds. Package the pudding product in sterile pudding cups and refrigerate.

The pudding product that can be made by the method described above will have an increased amount of protein, while retaining the appearance and aroma of typical pudding products currently on the market.

### Example 11

### Preparation of a Dry Blended Pudding Composition that Contains a Quantity of Soy Whey Protein

A dry blended pudding composition was prepared using soy whey protein recovered from a soy processing stream as described hereinabove at various replacement levels. Table 5 is the list of ingredients used to prepare a 100% soy pudding comprising both 1.6 grams of soy whey protein and 10 grams of soy whey protein.

TABLE 5
Dry Blended Pudding Composition Formulation with Soy Whey
Protein

| | SWP 1.6 g | | SWP 10 g | |
|---|---|---|---|---|
| 40 g gram serving size | % | gms/batch | % | gms/batch |
| Sugar | 39.200% | 196.00 | 22.773% | 113.87 |
| SWP | 6.600% | 33.00 | 34.00% | 170.00 |
| Corn Syrup Solids, 25DE | 9.900% | 49.50 | | |
| Dextrose | 13.000% | 65.00 | 13.00% | 65.00 |
| Mocified Food Starch | 12.500% | 62.50 | 12.50% | 62.50 |
| High fat powder | 10.000% | 50.00 | 8.90% | 44.50 |
| Cocoa | 7.900% | 39.50 | 7.90% | 39.50 |
| Salt | 0.800% | 4.00 | 0.80% | 4.00 |
| Sucralose | | | 0.027% | 0.14 |
| Vanilla Flavor | 0.100% | 0.50 | 0.10% | 0.50 |
| 40 g servings/4 servings | 100.00% | 500.00 | 100.00% | 500.00 |
| per package. | | | | |

The carbohydrates and cocoa were mixed in a paddle mixer such as a Kitchen Aid or Hobart type mixer at low speed for 5 minutes. The remaining ingredients were added and all ingredients were mixed together for 10 minutes. The blend was transferred to a suitable storage container and labeled appropriately.

For reconstitution, 160 grams of the dry blend was mixed into 1½ cups (360 mls) of cold water. The mixture was mixed vigorously with a wire whisk for 1-2 minutes. The mixture was allowed to stand for 5 minutes. Approximately 4½ cup servings were yielded from the above method. Each approximate 130 gram serving was found to deliver 2.0 grams or 6.2 grams of soy protein respectively based on the level of SWP added to the formula.

Once reconstituted, the pudding product made from the dry blend as described above having the low amount of soy whey protein had a thinner consistency than pudding products made from dry blends currently on the market. The product made from the dry blend having the higher amount of soy whey protein had only a slightly thinner consistency than typical pudding products made from dry blends currently on the market but was otherwise similar in aroma and appearance.

### Example 12

### Preparation of a Gelatin Composition that Contains a Quantity of Soy Whey Protein

A gelatin dessert product was prepared using soy whey protein recovered from a soy processing stream as described hereinabove at various replacement levels. Table 6 is the list of ingredients used to prepare a 100% soy gelatin comprising both 1% soy whey protein and 10% soy whey protein.

TABLE 6
Gelatin Formulation with Soy Whey Protein

| | SWP 1% | | SWP 10% | |
|---|---|---|---|---|
| | % | gms/batch | % | gms/batch |
| Distilled water | 59.68 | 596.8 | 59.68 | 596.8 |
| SWP | 1.35 | 13.50 | 13.46 | 134.6 |
| Potassium Citrate | 0.15 | 1.5 | 0.15 | 1.5 |
| Sodium Citrate | 0.15 | 1.5 | 0.15 | 1.5 |
| Sugar | 7.20 | 72.00 | 7.20 | 72.00 |
| Corn syrup solids, 25DE | 27.1 | 271.10 | 15.00 | 150.00 |
| Canola Oil | 4.00 | 40.00 | 4.00 | 40.00 |
| Carrageenan | 0.30 | 3.00 | 0.30 | 3.00 |
| Vitamin-mineral premix | 0.06 | 0.60 | 0.06 | 0.60 |
| Vanilla Flavor | 0.100% | 0.50 | 0.10% | 0.50 |
| | 100.00% | 1000.00 | 100.00% | 1000.00 |

The gelatin samples were formed by first adding the citrates to cold tap water and mixing in a conventional paddle type mixer with a blade attachment, such as a Kitchen aid or Hobart mixer. The soy whey protein was added to the water and mixed on high speed until completely dispersed. Once the protein was completely dispersed in the water, the mixing speed was reduced to slow speed and the mixing continued for 10 minutes to complete the protein hydration. The carrageenan was blended with a small portion of sugar (1:5 ratio of carrageenan to sugar) to form a dry blend. The dry blend was added to the hydrated soy protein and mixed for 5 minutes at slow speed until completely dispersed. Canola oil was added to the mixture and mixing continued for an additional 5 minutes. The remaining sugar and corn syrup solids were added to the mixture and the mixture was heated to 77° C. while mixing continued for an additional 5 minutes.

The slurry was then homogenized using a 2 stage, single piston homogenizer set at 500 psi, second stage; 2500 psi, first stage. After homogenization, the slurry was batch pasteurized at a temperature of 85° C. with a hold time of 15 seconds. After pasteurization, the slurry was cooled to 71° C. and the gelatin mixture was collected in filled sterile cups, the cups were capped and stored refrigerated.

The gelatin product that was made by the method described above was found to have an increased amount of protein, while retaining the aroma and appearance of typical gelatin products currently on the market. Increased amounts of soy whey protein in the gelatin composition resulted in a gelatin product having a darker color and foam as compared to typical gelatin products on the market.

### Example 13

### Preparation of Whipped Topping Dessert Product that Contains a Quantity of Soy Whey Protein

A whipped topping dessert product can be prepared according to typical industry processing techniques using soy whey protein recovered from a soy processing stream as described hereinabove. Table 7 is the list of ingredients used to prepare a whipped topping dessert product having 25 grams of soy whey protein, 50 grams of soy whey protein, and 5 grams of soy whey protein.

TABLE 7
Whipped Topping Dessert Formulation with Soy Whey Protein

| | SWP 2.5% | | SWP 5% | | SWP 0.5% | |
|---|---|---|---|---|---|---|
| Ingredient | % | gms | % | gms | % | gms |
| Water | 57.5 | 575.50 | 57.55 | 575.50 | 57.55 | 575.50 |
| Coconut oil | 27.00 | 270.00 | 27.00 | 270.00 | 27.00 | 270.00 |
| Sugar | 7.00 | 70.00 | 7.00 | 70.00 | 7.00 | 70.00 |
| CSS, 25DE | 4.85 | 48.50 | 2.35 | 23.50 | 6.85 | 68.50 |
| Soy Whey | 2.50 | 25.00 | 5.00 | 50.00 | 0.5 | 5.0 |
| Protein | | | | | | |
| Distilled | 0.60 | 6.00 | 0.60 | 6.00 | 0.60 | 6.00 |
| mono-and | | | | | | |
| diglyceride | | | | | | |
| Monoglyceride | 0.30 | 3.00 | 0.30 | 3.00 | 0.30 | 3.00 |
| Polysorbate 60 | 0.10 | 1.00 | 0.10 | 1.00 | 0.10 | 1.00 |
| Flavor | 0.10 | 1.00 | 0.10 | 1.00 | 0.10 | 1.00 |
| Total | 100.00 | 1000.00 | 100.00 | 1000.00 | 100.00 | 1000.00 |

The whipped topping was prepared by first adding the soy whey protein to water that had been pre-heated to a temperature of 51.7° C. and mixing in a conventional food processing kettle such as a stainless steel jacketed kettle equipped with air operated propeller mixer using moderate shear mixing until dispersed. The protein slurry was heated to a temperature of 77° C. and mixing speed was reduced to slow but continued for an additional 5 minutes. The sugar and corn syrup solids were added to the protein slurry and mixing continued for an additional 5 minutes. The water soluble emulsifiers (monoglyceride and polysorbate 60) were added to the protein slurry and mixing continued for 2 minutes.

The coconut oil was melted at a temperature of 60° C. Distilled mono- and diglyceride was added to the melted coconut oil and mixed until dispersed. The oil mixture was added to the protein slurry and the mixture was again mixed and heated to a temperature of between 75° C. to 77° C. until it was homogenous in appearance. Flavor was added and mixing continued for an additional 2 minutes.

The mixture was then pasteurized at a temperature of 74° C. for a hold time of 10 minutes. After pasteurization, the mixture was homogenized using a piston-type, 2 stage homogenizer set with 500 psi pressure on the second stage and 1500 psi pressure on the first stage. The whipping base mixture was cooled immediately to 4° C. and aged overnight before whipping.

To prepare the whipped topping samples for evaluation, 200 g of whipping base (base weight) was added to a chilled mixing bowl such as a Hobart mixing bowl. The base was whipped in the mixer on speed 6 for 5½ minutes until a foam was formed. The foam was filled into 7 oz cups and weighed (whipped weight). The cups were turned upside down over a glass funnel and observed for 1 hour. The amount of melted foam after 1 hour was measured.

The prepared whipped topping samples (2.5% SWP, 5% SWP, and 0.5% SWP) were evaluated against whipped topping samples comprised of SUPRO® 710 BN (S710 in Table 8), Supro® 120 BN (S120 in Table 8), egg white solids, and sodium caseinate. Results of the evaluation are set forth in Table 8.

TABLE 8
Comparison of SWP Whipped Topping to Other Whipped Toppings

| | Base | Whipped | | |
|---|---|---|---|---|
| Sample | Weight | Weight | Overrun | Comments |
| 2.5% SWP | 200 | 86.9 | 130.15 | Foam not very stable. |
| | | | | Poured through funnel |
| | | | | immediately. |
| 5% SWP | 200 | 138.67 | 44.23 | Still liquid after whipping |
| | | | | for 5.5 minutes. |
| 0.5% SWP | 200 | 55 | 263.64 | Stable foam. Foam never |
| | | | | dripped after 1 hour. |
| 2.05% S710 | 200 | 73.4 | 172.48 | Fairly stable foam, but still |
| | | | | poured through funnel like |
| | | | | a liquid. |
| 2.05% S120 | 200 | 74.32 | 169.1 | Stable foam. Slow drops |
| | | | | from funnel. |
| 2.05% egg | 200 | 61.51 | 225.15 | Most stable foam. Foam |
| white solids | | | | never dripped after 1 hour. |
| 2.05% | 200 | 144.75 | 38.17 | Still liquid after whipping |
| sodium | | | | for 5.5 minutes. |
| caseinate | | | | |

The whipped topping samples that were prepared with lower levels of soy whey protein (i.e., 2.5% soy whey protein and 0.5% soy whey protein) had the same appearance and consistency of whipped toppings currently in the market (e.g., Cool-Whip®) while the whipped topping sample prepared with 5% soy whey protein did not foam. The toppings made from lower SWP (0.5%) produced more stable foam similar to the topping containing egg white solids (2.05%), as it did not flow after more than an hour in an inverted cup.

### Example 14

### Preparation of a Frozen Dessert Comprising a Quantity of Soy Whey Protein

A frozen dessert product was prepared according to typical industry processing techniques using soy whey protein recovered from a soy processing stream as described hereinabove. Table 9 is the list of ingredients used to prepare a frozen dessert product having 1% soy whey protein and 5% soy whey protein.

TABLE 9
Frozen Dessert Formulation with Soy Whey Protein

| | SWP 1% | | SWP 5% | |
|---|---|---|---|---|
| | % | gms/batch | % | gms/batch |
| Water | 66.00 | 5280.00 | 66.00 | 5280.00 |
| Sugar | 12.00 | 960.00 | 12.00 | 960.00 |
| Corn syrup solids, 36DE | 9.60 | 768.00 | 4.20 | 336.00 |
| SWP | 1.35 | 108.00 | 6.75 | 540.00 |
| Vanilla flavor | 0.40 | 32.00 | 0.40 | 32.00 |
| Cream flavor | 0.10 | 8.00 | 0.10 | 8.00 |
| Coconut oil | 10.00 | 800.00 | 10.00 | 800.00 |
| Distilled mono-and | 0.20 | 16.00 | 0.20 | 16.00 |
| diglycerides | | | | |
| Dipotassium phosphate | 0.10 | 8.00 | 0.10 | 8.00 |
| Polysorbate 60 | 0.05 | 4.00 | 0.05 | 4.00 |
| | 100.00% | 8000.00 | 100.00% | 8000.00 |

To prepare the frozen dessert product, the water and phosphate were added in a conventional food processing kettle such as a stainless steel jacketed kettle equipped with air operated propeller mixer and heated to a temperature of 37° C. The soy whey protein was then added to the kettle and was mixed for 5 minutes until completely dispersed. A dry blend of the distilled mono- and diglycerides and sugar (1:10 ratio) was prepared and added to the protein slurry. The slurry was mixed for 3 minutes until the distilled mono- and diglyceride/sugar mixture was completely dispersed.

Coconut oil was melted at a temperature of 60° C. The mono- and diglyceride and polysorbate 60 was added to the melted coconut oil and mixed until completely dispersed. The oil mixture was then added to the slurry and mixed until homogenous. A dry blend of the remaining sugar and CSS was formed and added to the slurry. Flavorings were added and mixing continued for an additional 3 minutes. The slurry then underwent UHT at a temperature of 141° C. for a hold time of 6 seconds. After the UHT process, the slurry was homogenized using a three piston, 2 stage homogenizer set with 500 psi pressure on the second stage and 2500 psi pressure on the first stage. The homogenized mixture was then cooled to a temperature of 10° C.

Samples were collected in suitable storage containers and held at 5° C. for at least 12 hours. The samples were then placed in a freezer until evaluation.

The frozen dessert product prepared with 1% soy whey protein had very good melting properties and had the texture, color and form similar to other non-dairy frozen desserts currently in the marketplace while having an increased amount of protein than other similar products. The frozen dessert product prepared with 5% soy whey protein separated following refrigeration and became too thick after freezing. The over run seen with products at both soy whey protein levels was consistent with standard 10% fat frozen dessert.

One skilled in the art would readily appreciate that the methods, compositions, and products described herein are representative of exemplary embodiments, and not intended as limitations on the scope of the invention. It will be readily apparent to one skilled in the art that varying substitutions and modifications may be made to the present disclosure disclosed herein without departing from the scope and spirit of the invention.

All patents and publications mentioned herein are herein incorporated by reference, including without limitation PCT Application No. PCT/US10/62591 as it relates to any and all teachings related to soy whey protein, to the same extent as if each individual publication was specifically and individually indicated as incorporated by reference.

The present disclosure illustratively described herein suitably may be practiced in the absence of any element or elements, limitation or limitations that are not specifically disclosed herein. Thus, for example, in each instance herein any of the terms “comprising,” “consisting essentially of,” and “consisting of” may be replaced with either of the other two terms. The terms and expressions which have been employed are used as terms of description and not of limitation, and there is no intention that in the use of such terms and expressions of excluding any equivalents of the features shown and described or portions thereof, but it is recognized that various modifications are possible within the scope of the present disclosure claimed. Thus, it should be understood that although the present disclosure has been specifically disclosed by preferred embodiments and optional features, modification and variation of the concepts herein disclosed may be resorted to by those skilled in the art, and that such modifications and variations are considered to be within the scope of this invention as defined by the appended claims.

What is claimed is:

1. A dessert composition, the composition comprising:
(a) soy whey protein having a solubility of at least about 80% in an aqueous medium across a pH range of the aqueous medium of from 2 to 10 and a temperature of 25° C.; and
(b) at least one additional ingredient, wherein the at least one additional ingredient is selected from the group consisting of protein-containing materials, carbohydrates, dietary fiber, antioxidants, stabilizers, emulsifiers, vegetable oils, animal derived fats, and combinations thereof;
wherein the soy whey protein is present in the composition in an amount ranging from 0.05% to 60% by weight.

2. The dessert composition of claim 1, wherein the composition further comprises an ingredient selected from the group consisting of a sweetening agent, a preservative, a flavoring agent, a coloring agent, and combinations thereof.

3. The dessert composition of claim 1, wherein the composition is a dessert food product.

4. The dessert composition of claim 3, wherein the dessert food product is selected from the group consisting of puddings, gelatins, whipped toppings, meringues, nougats, frozen confections, and combinations thereof.

5. A method for producing a dessert food product, the method comprising the steps of:
(a) mixing a dessert composition comprising a soy whey protein recovered from a processing stream with at least one additional ingredient to produce a protein slurry, wherein the process of recovering the soy whey protein from the processing stream comprises performing the following steps in any order:
(i) pretreating the feed stream by passing the stream through at least one separation technique to form a retentate comprised of soluble components in the aqueous phase of the stream and a permeate comprised of insoluble large molecular weight proteins, wherein the insoluble large molecular weight proteins are selected from the group consisting of pre-treated soy whey, storage proteins, and combinations thereof;
(ii) passing the pre-treated soy whey through to at least one separation technique to form a retentate comprised of various components including but not limited to storage proteins, microorganisms, silicon, and combinations thereof, and a permeate comprised of purified pre-treated soy whey;
(iii) passing the purified pre-treated soy whey permeate of (ii) through at least one separation technique to form a retentate comprised of purified pre-treated soy whey and a permeate comprised of water, some minerals, monovalent cations, and combinations thereof;
(iv) passing the purified pre-treated soy whey retentate of (iii) through at least one separation technique to form a suspension of purified pre-treated soy whey and precipitated minerals;
(v) passing the suspension of purified pre-treated soy whey and precipitated minerals of (iv) through at least one separation technique to form a retentate comprised of de-mineralized pre-treated soy whey and a permeate comprised of insoluble materials with protein mineral complexes;
(vi) passing the de-mineralized purified pre-treated soy whey retentate of (v) through at least one separation technique to form a retentate comprised of soy whey protein, BBI, KTI, storage proteins, other proteins and combinations thereof and a permeate comprised of peptides, soy oligosaccharides, minerals, and combinations thereof;
(vii) passing the proteins of (vi) through at least one separation technique to form a retentate comprised of proteins selected from the group consisting of soy whey protein, BBI, KTI, storage proteins, other proteins, and combinations thereof and a permeate comprised of peptides, water, minerals, and soy oligosaccharides, wherein the soy oligosaccharides are selected from the group consisting of sucrose, raffinose, stachyose, verbascose, monosaccharides, and combinations thereof;
(viii) passing the proteins of (vii) through at least one separation technique to form a retentate comprising peptides, soy oligosaccharides, water, minerals and a permeate comprising water and minerals;
(ix) passing the retentate of (viii) through at least one separation technique to form a retentate comprising de-mineralized soy oligosaccharides and a permeate comprising minerals, water and combinations thereof;
(x) passing the de-mineralized soy oligosaccharides (ix) through at least one separation technique to form a retentate comprising color compounds and a permeate comprising soy oligosaccharides;
(xi) passing the soy oligosaccharides of (x) through at least one separation technique to form a retentate comprising sucrose, monosaccharides, and combinations thereof and a permeate comprising raffinose, stachyose, verbascose and combinations thereof;
(xii) passing the permeate of (xi) through at least one separation technique to form a retentate comprising water and a permeate comprising soy oligosaccharides;
(xiii) passing the retentate of (vii) through at least one separation technique to form a retentate comprising soy oligosaccharides, water, and minerals and a permeate comprising peptides and other proteins;
(xiv) passing the permeate of (xiii) through at least one separation technique to form a retentate comprising water and a permeate comprising peptides and other proteins, wherein the proteins are selected from the group consisting of lunasin, lectins, dehydrins, lipoxygenase, and combinations thereof;
(xv) passing the retentate of (xiv) through at least one separation technique to form a retentate comprising storage proteins and a permeate comprising soy whey protein, BBI, KTI, and other proteins, wherein the other proteins are selected from the group consisting of lunasin, lectins, dehydrins, lipoxygenase and combinations thereof;
(xvi) passing the retentate of (xv) through at least one separation technique to form a retentate comprising water and a permeate comprising soy whey protein, BBI, KTI and other proteins; and
(xvii) heating, flash cooling and drying the permeate of (xvi) to form soy whey protein; and
(b) heating the protein slurry to form a dessert food product.

6. The method of claim 5, wherein the method further comprises pasteurizing the protein slurry to form a pasteurized dessert composition.

7. The method of claim 6, wherein the method further comprises homogenizing the pasteurized dessert composition to form a homogenized composition.

8. The method of claim 7, wherein the method further comprises cooling the homogenized composition to form a dessert food product.

9. The method of claim 5, wherein the dessert food product is selected from the group consisting of puddings, gelatins, whipped toppings, meringues, nougats, frozen confections, and combinations thereof.

10. The method of claim 5, wherein the amount of soy whey protein in the composition is 0.05% to 60%.

11. The method of claim 5, wherein the at least one additional ingredient is selected from the group consisting of protein-containing materials, carbohydrates, dietary fiber, antioxidants, antimicrobial agents, stabilizers, emulsifiers, vegetable oils, animal derived fats, and combinations thereof.

12. The method of claim 5, wherein the composition further comprises an ingredient selected from the group consisting of a thickening agent, pH-adjusting agent, dairy product, preservative, flavoring agent, sweetening agent, coloring agent, other nutrients, and combinations thereof.
